(19) United States
(12) Patent Application Publication
(10) Pub. No.: US 2026/0149493 A1
(43) Pub. Date: May 28, 2026

(54) METHOD AND APPARATUS FOR DETERMINING ACTIVATED REFERENCE SIGNAL IN WIRELESS COMMUNICATION SYSTEM

(71) Applicant: Samsung Electronics Co., Ltd., Gyeonggi-do (KR)

(72) Inventors: Youngrok JANG, Gyeonggi-do (KR); Jungmin PARK, Gyeonggi-do (KR); Seongmok LIM, Gyeonggi-do (KR); Hyoungju JI, Gyeonggi-do (KR)

(21) Appl. No.: 19/397,219

(22) Filed: Nov. 21, 2025

(30) Foreign Application Priority Data
Nov. 22, 2024 (KR) 10-2024-0168492

(51) Int. Cl. H04B 7/06

(52) U.S. Cl. CPC H04B 7/0626; H04B 7/0639

(57) ABSTRACT

The disclosure relates to 5^{th} generation (5G) or 6^{th} generation (6G) communication systems for supporting higher data transfer rates. A method performed by a terminal includes receiving, from a BS, configuration information on a plurality of CSI-RS resources for a plurality of CSI-RS ports, wherein the plurality of CSI-RS resources are aperiodic CSI-RS resources for a channel measurement and linked with a CSI-IM resource, receiving, from the BS, CSI-RSs corresponding to the plurality of CSI-RS resources in two adjacent slots, obtaining CSI based on the received CSI-RSs and the CSI-IM resource, and transmitting, to the BS, the CSI, wherein the CSI-IM resource is located in a first slot of the two adjacent slots.

### CROSS-REFERENCE TO RELATED APPLICATION(S)

This application is based on and claims priority under 35 U.S.C. § 119 to Korean Patent Application No. 10-2024-0168492, filed on Nov. 22, 2024, in the Korean Intellectual Property Office, the disclosure of which is incorporated herein by reference in its entirety.

### BACKGROUND

### 1. Field

The disclosure relates generally to operations of a user equipment (UE) and a base station (BS) in a wireless communication system, and more particularly, to a method and apparatus for determining an activated reference signal in a wireless communication system.

### 2. Description of Related Art

5th generation (5G) mobile communication technologies define broad frequency bands to enable high transmission rates and new services, and can be implemented not only in sub 6 gigahertz (GHz) bands such as 3.5 GHz, but also in above 6 GHz bands referred to as millimeter wave (mmWave) bands including 28 GHz and 39 GHz bands. In addition, it has been considered to implement 6th generation (6G) mobile communication technologies referred to as beyond 5G systems in terahertz (THz) bands (e.g., 95 GHz to 3 THz bands) to achieve transmission rates fifty times faster than 5G mobile communication technologies and ultra-low latencies one-tenth of 5G mobile communication technologies.

Since the initial stage of 5G mobile communication technologies, to support services and to satisfy performance requirements in connection with enhanced mobile broadband (eMBB), ultra reliable & low latency communications (URLLC), and massive machine-type communications (mMTC), there has been ongoing standardization regarding beamforming and massive multiple input multiple output (MIMO) for alleviating radio-wave path loss and increasing radio-wave transmission distances in mmWave, numerology (for example, operating multiple subcarrier spacings) for efficiently utilizing mmWave resources and dynamic operation of slot formats, initial access technologies for supporting multi-beam transmission and broadbands, definition and operation of bandwidth part (BWP), new channel coding methods such as a low density parity check (LDPC) code for large-capacity data transmission and a polar code for highly reliable transmission of control information, layer 2 (L2) pre-processing, and network slicing for providing a dedicated network customized to a specific service.

Currently, there are ongoing discussions regarding improvement and performance enhancement of initial 5G mobile communication technologies in view of services to be supported by 5G mobile communication technologies, and there has been physical layer standardization regarding technologies such as vehicle-to-everything (V2X) for aiding driving determination by autonomous vehicles based on information regarding positions and states of vehicles transmitted by the vehicles and for enhancing user convenience, new radio unlicensed (NR-U) aimed at system operations conforming to various regulation-related requirements in unlicensed bands, NR UE (UE) power saving, non-terrestrial network (NTN) which is UE-satellite direct communication for securing coverage in an area in which communication with terrestrial networks is unavailable, and positioning.

Moreover, there has been ongoing standardization in wireless interface architecture/protocol fields regarding technologies such as industrial Internet of things (IIoT) for supporting new services through interworking and convergence with other industries, integrated access and backhaul (IAB) for providing a node for network service area expansion by supporting a wireless backhaul link and an access link in an integrated manner, mobility enhancement including conditional handover and dual active protocol stack (DAPS) handover, and two-step random access channel (2-step RACH) for simplifying random access procedures for NR. There also has been ongoing standardization in system architecture/service fields regarding a 5G baseline architecture (for example, service based architecture or service based interface) for combining network functions virtualization (NFV) and software-defined networking (SDN) technologies, and mobile edge computing (MEC) for receiving services based on UE positions.

If such 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended reality (XR) for efficiently supporting augmented reality (AR), virtual reality (VR), mixed reality (MR), etc., 5G performance improvement and complexity reduction by utilizing artificial intelligence (AI) and machine learning (ML), AI service support, metaverse service support, and drone communication.

Such development of 5G mobile communication systems will serve as a basis for developing not only new waveforms for securing coverage in terahertz bands of 6G mobile communication technologies, full dimensional MIMO (FD-MIMO), multi-antenna transmission technologies such as array antennas and large-scale antennas, metamaterial-based lenses and antennas for improving coverage of terahertz band signals, high-dimensional space multiplexing technology using orbital angular momentum (OAM), and reconfigurable intelligent surface (RIS), but also full-duplex technology for increasing frequency efficiency of 6G mobile communication technologies and improving system networks, AI-based communication technology for implementing system optimization by utilizing satellites and AI from the design stage and internalizing end-to-end AI support functions, and next-generation distributed computing technology for implementing services at levels of complexity exceeding the limit of UE operation capability by utilizing ultra-high-performance communication and computing resources.

The above information is presented as background information only to assist with an understanding of the disclosure. No determination has been made, and no assertion is made, as to whether any of the above might be applicable as prior art with regard to the disclosure.

### SUMMARY

In accordance with an aspect of the disclosure, a method performed by a terminal in a communication system includes receiving, from a BS, configuration information on a plurality of channel state information reference signal (CSI-RS) resources for a plurality of CSI-RS ports, wherein the plurality of CSI-RS resources are aperiodic CSI-RS resources for a channel measurement and linked with a channel state information interference measurement resource (CSI-IM) resource, receiving, from the BS, CSI-RSs corresponding to the plurality of CSI-RS resources in two adjacent slots, obtaining CSI based on the received CSI-RSs and the CSI-IM resource, and transmitting, to the BS, the CSI, wherein the CSI-IM resource is located in a first slot of the two adjacent slots.

In accordance with an aspect of the disclosure, a method performed by a BS in a communication system includes transmitting, to a terminal, configuration information on a plurality of CSI-RS resources for a plurality of CSI-RS ports, wherein the plurality of CSI-RS resources are aperiodic CSI-RS resources for a channel measurement and linked with a CSI-IM resource, transmitting, to the terminal, CSI-RSs corresponding to the plurality of CSI-RS resources in two adjacent slots, and receiving, from the terminal, CSI, wherein the CSI is based on the CSI-RSs and the CSI-IM resource, and wherein the CSI-IM resource is located in a first slot of the two adjacent slots.

In accordance with an aspect of the disclosure, a terminal in a communication system includes at least one transceiver, at least one processor communicatively coupled to the at least one transceiver, and at least one memory, communicatively coupled to the at least one processor, storing instructions executable by the at least one processor individually or in any combination to cause the terminal to: receive, from a BS, configuration information on a plurality of CSI-RS resources for a plurality of CSI-RS ports, wherein the plurality of CSI-RS resources are aperiodic CSI-RS resources for a channel measurement and linked with a CSI-IM resource, receive, from the BS, CSI-RSs corresponding to the plurality of CSI-RS resources in two adjacent slots, obtain CSI based on the received CSI-RSs and the CSI-IM resource, and transmit, to the BS, the CSI, wherein the CSI-IM resource is located in a first slot of the two adjacent slots.

In accordance with an aspect of the disclosure, a BS in a communication system includes at least one transceiver, at least one processor communicatively coupled to the at least one transceiver, and at least one memory, communicatively coupled to the at least one processor, storing instructions executable by the at least one processor individually or in any combination to cause the BS to: transmit, to a terminal, configuration information on a plurality of CSI-RS resources for a plurality of CSI-RS ports, wherein the plurality of CSI-RS resources are aperiodic CSI-RS resources for a channel measurement and linked with a CSI-IM resource, transmit, to the terminal, CSI-RSs corresponding to the plurality of CSI-RS resources in two adjacent slots, and receive, from the terminal, CSI, wherein the CSI is based on the CSI-RSs and the CSI-IM resource, and wherein the CSI-IM resource is located in a first slot of the two adjacent slots.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 illustrates a basic structure of a time-frequency domain, which is a radio resource domain used to transmit data or control channels, in a 5G system according to an embodiment;

FIG. 2 illustrates a structure of a frame, a subframe, and a slot in a wireless communication system according to an embodiment;

FIG. 3 illustrates a BWP configuration in a wireless communication system according to an embodiment;

FIG. 4 illustrates a beam application time which may be considered when a unified transmission configuration indication (TCI) scheme is used in a wireless communication system according to an embodiment;

FIG. 5 illustrates a medium access control (MAC) control element (CE) structure for activation and indication of a joint TCI state or a separate DL or UL TCI state in a wireless communication system according to an embodiment;

FIG. 6 illustrates an aperiodic CSI reporting method according to an embodiment;

FIG. 7 illustrates a control resource set (CORESET) used to transmit a DL control channel in a 5G wireless communication system according to an embodiment;

FIG. 8 illustrates a basic unit of time and frequency resources constituting a DL control channel available in 5G according to an embodiment;

FIG. 9 illustrates a UE operation according to an embodiment;

FIG. 10 illustrates a BS operation according to an embodiment;

FIG. 11 illustrates an example of calculation of the number of activated CSI-RS resources or ports in a UE and a BS according to an embodiment;

FIG. 12 illustrates a UE operation for calculating the number of activated CSI-RS resources or ports according to an embodiment;

FIG. 13 illustrates a BS operation for calculating the number of activated CSI-RS resources or ports according to an embodiment;

FIG. 14 illustrates a structure of a UE in a wireless communication system according to an embodiment; and

FIG. 15 illustrates a structure of a BS in a wireless communication system according to an embodiment.

### DETAILED DESCRIPTION

Hereinafter, embodiments of the disclosure will be described in detail with reference to the accompanying drawings.

Descriptions related to technical contents well-known in the relevant art and not associated directly with the disclosure will be omitted for the sake of clarity and conciseness.

For the same reason, in the accompanying drawings, some elements may be exaggerated, omitted, or schematically illustrated. The size of each element does not completely reflect the actual size thereof. In the respective drawings, the same or corresponding elements are assigned the same reference numerals.

The advantages and features of the disclosure and ways to achieve them will be apparent by making reference to embodiments as described below in detail in conjunction with the accompanying drawings. However, the disclosure is not limited to the embodiments set forth below but may be implemented in various forms. The following embodiments are provided only to completely disclose the disclosure and inform those skilled in the art of the scope of the disclosure. Throughout the specification, the same or like reference signs indicate the same or like elements. The terms which will be described below are terms defined in consideration of the functions in the disclosure, and may be different according to users, intentions of the users, or customs. Therefore, the definitions of the terms should be made based on the contents throughout the specification.

Herein, a BS is an entity that allocates resources to terminals, and may be at least one of a gNode B, an eNode B, a Node B, a wireless access unit, a BS controller, and a node on a network. A terminal may include a UE, a mobile station (MS), a cellular phone, a smartphone, a computer, or a multimedia system capable of performing a communication function. In the disclosure, a DL refers to a radio link via which a BS transmits a signal to a terminal, and a UL refers to a radio link via which a terminal transmits a signal to a BS. Herein, LTE or LTE-A systems may be described by way of example, but the embodiments of the disclosure may also be applied to other communication systems having similar technical backgrounds or channel types, such as the 5th generation mobile communication technologies (5G, new radio, and NR) developed beyond LTE-A, and in the following description, the “5G” may be the concept that covers the exiting LTE, LTE-A, and other similar services. In addition, based on determinations by those skilled in the art, the disclosure may also be applied to other communication systems through some modifications without significantly departing from the scope of the disclosure.

A wireless communication system is advancing to a broadband wireless communication system for providing high-speed and high-quality packet data services using communication standards, such as high-speed packet access (HSPA) of third generation partnership project (3GPP), LTE or evolved universal terrestrial radio access (E-UTRA)), LTE-advanced (LTE-A), LTE-Pro, high-rate packet data (HRPD) of 3GPP2, ultra-mobile broadband (UMB), institute of electrical and electronics engineers (IEEE) 802.16e, and the like, as well as typical voice-based services.

For example, an LTE system employs an orthogonal frequency division multiplexing (OFDM) scheme in a downlink (DL) and employs a single carrier frequency division multiple access (SC-FDMA) scheme in an uplink (UL), which refers to a radio link via which a UE or an MS transmits data or control signals to a BS (or eNode B), and the DL refers to a radio link via which the BS transmits data or control signals to the UE. The above multiple access scheme may separate data or control information of respective users by allocating and operating time-frequency resources for transmitting the data or control information for each user to avoid overlapping each other, that is, to establish orthogonality.

Since a 5G communication system, which is a post-LTE communication system, must freely reflect various requirements of users, service providers, and the like, services satisfying various requirements must be supported, including the eMBB, mMTC, URLLC, and similar communications.

eMBB aims at providing a data rate higher than that supported by existing LTE, LTE-A, or LTE-Pro. For example, in the 5G communication system, eMBB must provide a peak data rate of 20 Gbps in the DL and a peak data rate of 10 Gbps in the UL for a single BS. Furthermore, the 5G communication system must provide an increased user-perceived data rate to the UE, as well as the maximum data rate. To satisfy such requirements, transmission/reception technologies including a further enhanced multi-input multi-output (MIMO) transmission technique are required to be improved. The data rate required for the 5G communication system may be obtained using a frequency bandwidth more than 20 MHz in a frequency band of 3 to 6 GHz or 6 GHz or above, instead of transmitting signals using a transmission bandwidth up to 20 MHz in a band of 2 GHz used in LTE.

In addition, mMTC is being considered to support application services such as the Internet of Things (IoT) in the 5G communication system. mMTC has requirements, such as support of connection of a large number of UEs in a cell, enhancement coverage of UEs, improved battery time, a reduction in the cost of a UE, and the like, to effectively provide the IoT. Since the IoT provides communication functions while being provided to various sensors and various devices, it must support many UEs (e.g., 1,000,000 UEs/km²) in a cell. The UEs supporting mMTC may require wider coverage than those of other services provided by the 5G communication system because the UEs are likely to be located in a shadow area, such as a basement of a building, which is not covered by the cell due to the nature of the service. The UE supporting mMTC must be configured to be inexpensive, and may require a very long battery life-time such as 10 to 15 years because it is difficult to frequently replace the battery of the UE.

URLLC is a cellular-based mission-critical wireless communication service. For example, URLLC may be used for services such as remote control for robots or machines, industrial automation, unmanned aerial vehicles, remote health care, and emergency alert. Thus, URLLC must provide communication with ultra-low latency and ultra-high reliability. For example, a service supporting URLLC must satisfy an air interface latency of less than 0.5 ms, and also requires a packet error rate of 10⁻⁵ or less. Therefore, for the services supporting URLLC, a 5G system must provide a transmit time interval (TTI) shorter than those of other services, and also may require a design for assigning a large number of resources in a frequency band to secure reliability of a communication link.

The three services in 5G, that is, eMBB, URLLC, and mMTC, may be multiplexed and transmitted in a single system. In this case, different transmission/reception techniques and transmission/reception parameters may be used between services to satisfy different requirements of the respective services. 5G is not limited to the three services described above.

There is a need in the art for a method and apparatus for improved determination of activated reference signals in wireless communication systems.

The contents of the disclosure may be applied to frequency division duplex (FDD) and time division duplex (TDD) systems. As used herein, upper signaling (or upper layer signaling) is a method for transferring signals from a BS to a UE by using a DL data channel of a physical layer, or from the UE to the BS by using a UL data channel of the physical layer, and may also be referred to as RRC, PDCP, or MAC CE signaling.

Herein, the UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific radio network temporary identifier (RNTI), or cooperative communication application is assumed in a specific range indicated by an upper layer. Hereinafter, it will be assumed for the sake of descriptive convenience that non-coherent joint transmission (NC-JT) case refers to when the UE receives a PDSCH to which cooperative communication is applied, based on conditions similar to those described above.

Hereinafter, determining priority between A and B may be variously described as, for example, selecting an entity having a higher priority according to a predetermined priority rule and performing an operation corresponding thereto, or omitting or dropping operations regarding an entity having a lower priority.

The examples herein may be described through several embodiments, but they are not independent of each other, and one or more embodiments may be applied simultaneously or in combination.

Herein, a cell, a transmission point, a panel, a beam, and/or a transmission direction which can be distinguished through an upper layer 1 (L1) parameter such as a TCI state or spatial relation information, a cell ID, a transmission and reception point (TRP) ID, or a panel ID may be described as a TRP, a beam, or a TCI state as a whole. Therefore, when actually applied, a TRP, a beam, or a TCI state may be appropriately replaced with one of the above terms.

Herein, the UE may use various methods to determine whether to apply cooperative communication, for example, PDCCH(s) that allocates a PDSCH to which cooperative communication is applied have a specific format, or PDCCH(s) that allocates a PDSCH to which cooperative communication is applied include a specific indicator indicating whether to apply cooperative communication, or PDCCH(s) that allocates a PDSCH to which cooperative communication is applied are scrambled by a specific RNTI, or cooperative communication application is assumed in a specific range indicated by an upper layer. Hereinafter, it will be assumed for the sake of descriptive convenience that NC-JT case refers to when the UE receives a PDSCH to which cooperative communication is applied, based on conditions similar to those described above.

Herein, higher layer signaling may refer to signaling corresponding to at least one signaling among the following signaling, or a combination of one or more of master information block (MIB), system information block (SIB) or SIB X (X=1, 2, . . . ), RRC, and MAC CE.

L1 signaling corresponds to at least one signaling method among signaling methods using the following physical layer channels or signaling, or a combination of one or more thereof.
Physical DL control channel (PDCCH)
DLDCI
UE-specific DCI
Group common DCI
Common DCI
Scheduling DCI (for example, DCI used for scheduling DL or UL data)
Non-scheduling DCI (for example, DCI not used for scheduling DL or UL data)
Physical uplink control channel (PUCCH)
UL control information (UCI)

Hereinafter, determining priority between A and B may be variously described as, for example, selecting an entity having a higher priority according to a predetermined priority rule and performing an operation corresponding thereto, or omitting or dropping operations regarding an entity having a lower priority.

As used herein, the term “slot” may generally refer to a specific time unit corresponding to a transmit time interval (TTI), may specifically refer to a slot used in a 5G NR system, or may refer to a slot or a subframe used in a 4G LTE system. As used herein, transmission/reception of a CSI-RS resource may be understood as transmission/reception of a CSI-RS corresponding to the CSI-RS resource.

In the following description, the term “a/b” may be understood as at least one of a and b.

### NR Time-Frequency Resources

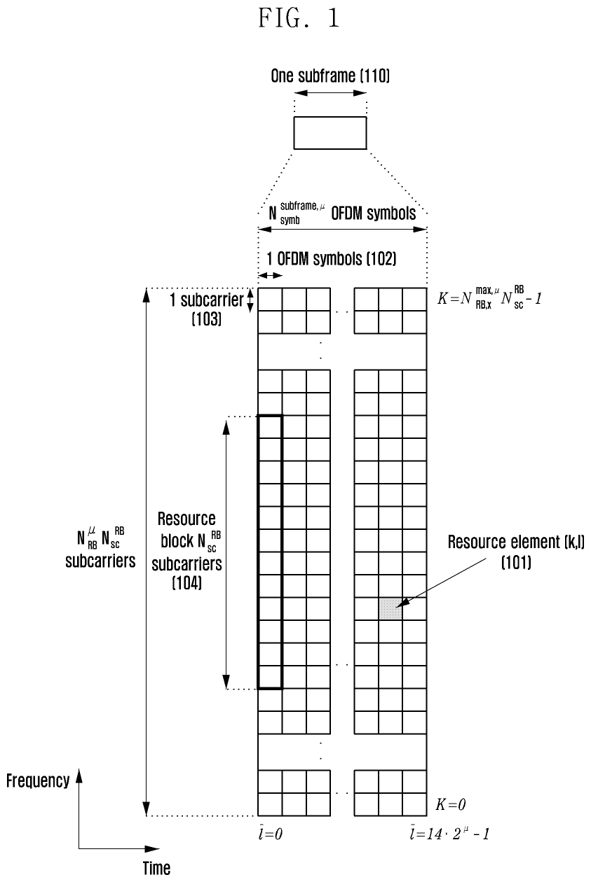

FIG. 1 illustrates a basic structure of a time-frequency domain, which is a radio resource domain used to transmit data or control channels, in a 5G system according to an embodiment.

Referring to FIG. 1, the horizontal axis denotes a time domain, and the vertical axis denotes a frequency domain. The basic unit of resources in the time-frequency domain is a resource element (RE) 101, which may be defined as one OFDM symbol 102 on the time axis and one subcarrier 103 on the frequency axis. In the frequency domain,

$${N}_{SC}^{R B}$$

(for example, 12) consecutive REs may constitute one resource block (RB) 104. One subframe (110) includes

$${N}_{s y m b}^{s u bframe , μ}$$

OFDM symbols.

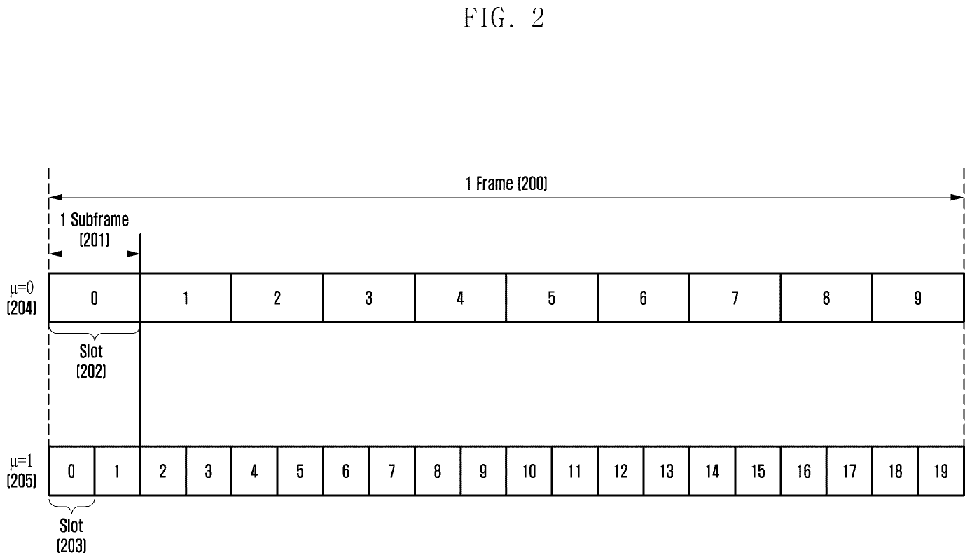

FIG. 2 illustrates a structure of a frame, a subframe, and a slot in a wireless communication system according to an embodiment.

Referring to FIG. 2, a structure of a frame 200, a subframe 201, and a slot 202 is illustrated. One frame 200 may be defined as 10 ms. One subframe 201 may be defined as 1 ms, and thus one frame 200 may include a total of ten subframes 201. One slot 202 or 203 may be defined as 14 OFDM symbols (that is, the number of symbols per one slot

$${N}_{s y m b}^{slot} = 14 ) .$$

One subframe 201 may include one or multiple slots 202 and 203, and the number of slots 202 and 203 per one subframe 201 may vary depending on configuration values u for the subcarrier spacing 204 or 205. The example in FIG. 2 illustrates when the subcarrier spacing configuration value is μ=0 (204), and when μ=1 (205). In μ=0 (204), one subframe 201 may include one slot 202, and in μ=1 (205), one subframe 201 may include two slots 203. That is, the number of slots per one subframe

$${N}_{slot}^{s u bframe , μ}$$

may differ depending on the subcarrier spacing configuration value μ, and the number of slots per one frame

$${N}_{slot}^{frame , μ}$$

may differ accordingly.

$${N}_{slot}^{s u bframe , μ} and {N}_{slot}^{f r a m e , μ}$$

may be defined according to each subcarrier spacing configuration u as in Table 1 below.

TABLE 1

| μ | ${N}_{symb}^{slot}$ | ${N}_{slot}^{frame , μ}$ | ${N}_{slot}^{subframe , μ}$ |
|---|---|---|---|
| 0 | 14 | 10 | 1 |
| 1 | 14 | 20 | 2 |
| 2 | 14 | 40 | 4 |
| 3 | 14 | 80 | 8 |
| 4 | 14 | 160 | 16 |
| 5 | 14 | 320 | 32 |

### BWP

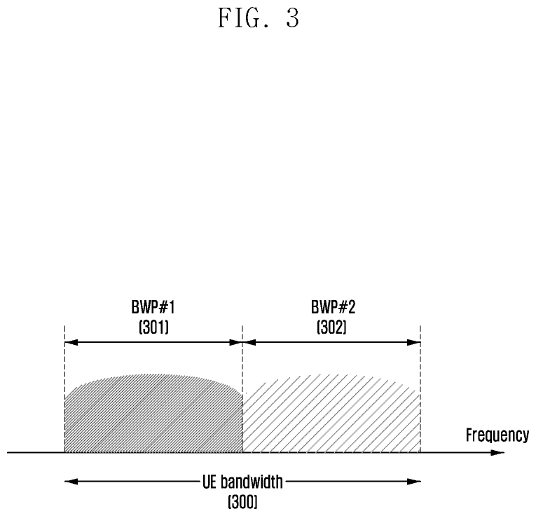

FIG. 3 illustrates a BWP configuration in a wireless communication system according to an embodiment.

Referring to FIG. 3, an example is provided in which a UE bandwidth 300 is configured to include two BWPs, that is, BWP #1 301 and BWP #2 302. A BS may configure one or multiple BWPs for a UE, and may configure the following pieces of information with regard to each BWP as given in Table 2 below.

TABLE 2

| | |
|---|---|
| BWP ::= | SEQUENCE { |
| bwp-Id | BWP-Id, |

(BWP identifier)

| | |
|---|---|
| locationAndBandwidth | INTEGER (1..65536), |

(BWP location)

| | |
|---|---|
| subcarrierSpacing | ENUMERATED {n0, n1, n2, n3, n4, n5}, |

(subcarrier spacing)

| | |
|---|---|
| cyclicPrefix (CP) | ENUMERATED { extended } |

(cyclic prefix)
}

Various parameters related to the BWP may be configured for the UE, in addition to the above configuration information. The BS may transfer the configuration information to the UE through higher layer signaling, such as radio resource control (RRC) signaling. One configured BWP or at least one BWP among multiple configured BWPs may be activated. Whether the configured BWP is activated may be transferred from the BS to the UE semi-statically through RRC signaling, or dynamically through DL control information (DCI).

Before an RRC connection, an initial BWP for initial access may be configured for the UE by the BS through an MIB. More specifically, the UE may receive configuration information regarding a CORESET and a search space which may be used to transmit a PDCCH for receiving system information (which may correspond to remaining system information (RMSI) or an SIBI necessary for initial access through the MIB in the initial access step. Each of the CORESET and the search space configured through the MIB may be considered identity (ID) 0. The BS may notify the UE of configuration information, such as frequency allocation information, time allocation information, and numerology, regarding CORESET #0 through the MIB. The BS may notify the UE of configuration information regarding the monitoring periodicity and occasion with regard to CORESET #0, that is, configuration information regarding search space #0, through the MIB. The UE may consider that a frequency domain configured by CORESET #0 acquired from the MIB is an initial BWP for initial access. The ID of the initial BWP may be considered to be 0.

The BWP-related configuration supported by 5G may be used for various purposes.

If the bandwidth supported by the UE is smaller than the system bandwidth, this may be supported through the BWP configuration. The BS may configure the frequency location (configuration information 2) of the BWP for the UE, so that the UE can transmit/receive data at a specific frequency location within the system bandwidth.

The BS may configure multiple BWPs for the UE for supporting different numerologies. For example, to support a UE's data transmission/reception using both a subcarrier spacing of 15 kHz and a subcarrier spacing of 30 kHz, two BWPs may be configured as subcarrier spacings of 15 kHz and 30 kHz, respectively. Different BWPs may be subjected to frequency division multiplexing (FDM), and if data is to be transmitted/received at a specific subcarrier spacing, the BWP configured as the corresponding subcarrier spacing may be activated.

The BS may configure BWPs having different sizes of bandwidths for the UE for reducing power consumed by the UE. For example, if the UE supports a substantially large bandwidth, for example, 100 MHz, and always transmits/receives data with the corresponding bandwidth, a substantially large amount of power consumption may occur. Particularly, it may be substantially inefficient from the viewpoint of power consumption to unnecessarily monitor the DL control channel with a large bandwidth of 100 MHz in the absence of traffic. To reduce power consumed by the UE, the BS may configure a BWP of a relatively small bandwidth, such as a BWP of 20 megahertz (MHz) for the UE. The UE may perform a monitoring operation in the 20 MHz BWP in the absence of traffic, and may transmit/receive data with the 100 MHz BWP as instructed by the BS if data has occurred.

In connection with the BWP configuring method, UEs, before being RRC-connected, may receive configuration information regarding the initial BWP through an MIB in the initial access step. To be more specific, a UE may have a CORESET configured for a DL control channel which may be used to transmit DCI for scheduling an SIB from the MIB of a physical broadcast channel (PBCH). The bandwidth of the CORESET configured by the MIB may be considered as the initial BWP, and the UE may receive, through the configured initial BWP, a physical DL shared channel (PDSCH) through which an SIB is transmitted. The initial BWP may be used not only for receiving the SIB, but also for other system information (OSI), paging, random access, or the like.

### BWP Change

If a UE has one or more BWPs configured therefor, the BS may indicate, to the UE, to change (or switch or transition) the BWPs by using a BWP indicator field inside DCI. As an example, in FIG. 3, if the currently activated BWP of the UE is BWP #1 301, the BS may indicate BWP #2 302 with a BWP indicator inside DCI, and the UE may change the BWP to BWP #2 302 indicated by the BWP indicator inside received DCI.

As described above, DCI-based BWP changing may be indicated by DCI for scheduling a PDSCH or a physical uplink shared channel (PUSCH), and thus, upon receiving a BWP change request, the UE needs to be able to receive or transmit the PDSCH or PUSCH scheduled by the corresponding DCI in the changed BWP with no issues. To this end, requirements for the delay time (T_{BWP}) required during a BWP change are specified in standards, and may be defined as given in Table 3 below.

TABLE 3

| | |
|---|---|
| NR Slot | BWP switch delay T_{BWP} (slots) |

| μ | length (ms) | Type 1^{Note 1} | Type 2^{Note 1} |
|---|---|---|---|
| 0 | 1 | 1 | 3 |
| 1 | 0.5 | 2 | 5 |
| 2 | 0.25 | 3 | 9 |
| 3 | 0.125 | 6 | 18 |

^{Note 1}:
Depends on UE capability.
Note 2:
If the BWP switch involves changing of subcarrier spacing (SCS), the BWP switch delay is determined by the larger one between the SCS before BWP switch and the SCS after BWP switch.

The requirements for the BWP change delay time support type 1 or type 2, depending on the capability of the UE. The UE may report the supportable BWP change delay time type to the BS.

If the UE has received DCI including a BWP change indicator in slot n, according to the above-described requirement regarding the BWP change delay time, the UE may complete a change to the new BWP indicated by the BWP change indicator at a timepoint not later than slot n+T_{BWP}, and may transmit/receive a data channel scheduled by the corresponding DCI in the newly changed BWP. If the BS wants to schedule a data channel by using the new BWP, the BS may determine time domain resource allocation regarding the data channel, based on the UE's BWP change delay time (T_{BWP}). That is, when scheduling a data channel by using the new BWP, the BS may schedule the corresponding data channel after the BWP change delay time, in connection with the method for determining time domain resource allocation regarding the data channel. Accordingly, the UE may not expect that the DCI that indicates a BWP change will indicate a slot offset (K0 or K2) value smaller than the BWP change delay time (T_{BWP}).

If the UE has received DCI (for example, DCI format 1_1 or 0_1) indicating a BWP change, the UE may perform no transmission or reception during a time interval from the third symbol of the slot used to receive a PDCCH including the corresponding DCI to the start point of the slot indicated by a slot offset (K0 or K2) value indicated by a time domain resource allocation indicator field in the corresponding DCI. For example, if the UE has received DCI indicating a BWP change in slot n, and if the slot offset value indicated by the corresponding DCI is K, the UE may perform no transmission or reception from the third symbol of slot n to the symbol before slot n+K, the last symbol of slot n+K−1.

### Unified TCI State

The unified TCI scheme may refer to a scheme wherein, although existing standards have used a TCI state scheme for a UE's DL reception and have used a spatial relation info scheme for UL transmission (separate transmission/reception beam management scheme), the same is managed in an integrated manner by using a TCI state. Therefore, when a UE receives an instruction from a BS based on the unified TCI scheme, the UE may perform beam management by using a TCI state with regard to UL transmission as well. If the BS has configured a TCI-State (higher layer signaling) having a tci-stateId-r17 (higher layer signaling) for the UE, the UE may perform an operation based on the unified TCI scheme by using the TCI-State. The TCI-State may exist in two types including a joint TCI state or a separate TCI state.

The first type is a joint TCI state in which all TCI states to be applied to UL transmission and DL reception may be indicated to a UE by a BS through one TCI-State. If a TCI-State based on a joint TCI state has been indicated to the UE, a parameter to be used for DL channel estimation may be indicated to the UE by using an RS corresponding to qcl-Type1 in the TCI-State based on a joint TCI state, and a parameter to be used as a DL reception beam or reception filter may be indicated to the UE by using an RS corresponding to qcl-Type2 therein. If a TCI-State based on a joint TCI state has been indicated to the UE, a parameter to be used as a UL transmission beam or transmission filter may be indicated to the UE by using an RS corresponding to qcl-Type2 therein in the TCI-State based on a joint DL/UL TCI state. If a joint TCI state is indicated to the UE, the UE may apply the same beam to UL transmission and DL reception.

According to the second type (separate TCI state), the BS may individually indicate a UL TCI state to be applied to UL transmission and a DL TCI state to be applied to DL reception to the UE. If a UL TCI state is indicated to the UE, a parameter to be used as a UL transmission beam or transmission filter may be indicated to the UE by using a reference RS or a source RS configured in the UL TCI state. If a DL TCI state is indicated to the UE, a parameter to be used in DL channel estimation may be indicated to the UE by using an RS corresponding to qcl-Type1 configured in the DL TCI state, and a parameter to be used as a DL reception beam or reception filter may be indicated thereto by using an RS corresponding to qcl-Type2.

If both a DL TCI state and a UD TCI state have been indicated to the UE, a parameter to be used as a UL transmission beam or transmission filter may be indicated to the UE by using a reference RS or source RS configured in the UL TCI state, a parameter to be used for DL channel estimation may be indicated to the UE by using an RS corresponding to qcl-Type1 configured in the DL TCI state, and a parameter to be used as a DL reception beam or reception filter may be indicated to the UE by using an RS corresponding to qcl-Type2 configured therein. If the DL TCI state indicated to the UE and the reference RS or source RS configured in the UL TCI state are different, the UE may apply individual beams to UL transmission and DL reception, respectively, based on the UL TCI state and DL TCI state indicated thereto.

A maximum of 128 joint TCI states may be configured for a particular BWP in a particular cell for the UE by the BS through higher layer signaling, a maximum of 64 or 128 DL TCI states among separate TCI states may be configured for a particular BWP in a particular cell through higher layer signaling, based on a UE capability report, and a DL TCI state among separate TCI states and a joint TCI state may use the same higher layer signaling structure. As an example, if 128 joint TCI states have been configured, and if 64 DL TCI states have been configured among separate TCI states, the 64 DL TCI states may be included in the 128 joint TCI states.

A maximum of 32 or 64 UL TCI states among separate TCI states may be configured for a particular BWP in a particular cell through higher layer signaling, based on a UE capability report, and a UL TCI state among separate TCI states and a joint TCI state may also use the same higher layer signaling structure as the relation between a DL TCI state among separate TCI states and a joint TCI state, or a UL TCI state among separate TCI states may also use a higher layer signaling structure different from that of a joint TCI state and a DL TCI state among separate TCI states.

Such use of different or identical higher layer signaling structures may be defined in specifications, or may be distinguished through different higher layer signaling configured by the BS, based on a UE capability report containing information regarding which is to be used among two schemes that the UE may support.

The UE may use one scheme, among a joint TCI state and a separate TCI state configured by the BS, thereby receiving an indication regarding transmission/reception beam according to a unified TCI scheme. The BS may configure, for the UE, whether one of the joint TCI state and the separate TCI state is to be used, through higher layer signaling.

The UE may receive an indication regarding transmission/reception beam by using a scheme selected from a joint TCI state and a separate TCI state through higher layer signaling, and the BS may indicate a transmission/reception beam in two methods (a MAC-CE-based indication method and a MAC-CE-based activation and DCI-based indication method).

If the UE receives an indication regarding transmission/reception beam by using a joint TCI state through higher layer signaling, the UE may receive a MAC-CE indicating a joint TCI state from the BS, thereby performing a transmission/reception beam application operation, and the BS may schedule reception regarding a PDSCH including the MAC-CE for the UE through a PDCCH. If the MAC-CE includes one joint TCI state set, the UE may determine a UL transmission beam or transmission filter and a DL reception beam or reception filter by using joint TCI states included in the indicated joint TCI state set 3 ms after transmission of a PUCCH including hybrid automatic repeat request acknowledgement (HARQ-ACK) information indicating whether the PDSCH is successfully received. If the MAC-CE includes two or more joint TCI state sets, the UE may identify that multiple joint TCI state sets indicated by the MAC-CE correspond to respective codepoints of the TCI state field of DCI format 1_1 or 1_2 and then activate the indicated joint TCI state sets, 3 ms after transmission of a PUCCH including HARQ-ACK information indicating whether the PDSCH is successfully received. Thereafter, the UE may receive DCI format 1_1 or 1_2 and may apply one joint TCI state indicated by the TCI state field in corresponding DCI to UL transmission and DL reception beams. DCI format 1_1 or 1_2 may include DL data channel scheduling information (with DL assignment) or may not include the same (without DL assignment).

If the UE receives an indication regarding transmission/reception beam by using a separate TCI state through higher layer signaling, the UE may receive a MAC-CE indicating a separate TCI state from the BS, thereby performing a transmission/reception beam application operation, and the BS may schedule reception regarding a PDSCH including the MAC-CE for the UE through a PDCCH. If the MAC-CE includes one separate TCI state set, the UE may determine a UL transmission beam or transmission filter and a DL reception beam or reception filter by using separate TCI states included in the indicated separate TCI state set 3 ms after transmission of a PUCCH including HARQ-ACK information indicating whether the PDSCH is successfully received.

A separate TCI state set may indicate a single or multiple separate TCI states which one codepoint of a TCI state field in DCI format 1_1 or 1_2 may have, and one separate TCI state set may include one DL TCI state, include one UL TCI state, or include one DL TCI state and one UL TCI state. If the MAC-CE includes two or more separate TCI state sets, the UE may identify that multiple separate TCI state sets indicated by the MAC-CE correspond to respective codepoints of the TCI state field of DCI format 1_1 or 1_2 and then activate the indicated separate TCI state sets, 3 ms after transmission of a PUCCH including HARQ-ACK information indicating whether the PDSCH is successfully received. Each codepoint of the TCI state field of DCI format 1_1 or 1_2 may indicate one DL TCI state, may indicate one UL TCI state, or may indicate one DL TCI state and one UL TCI state. The UE may receive DCI format 1_1 or 1_2 and may apply separate TCI state sets indicated by the TCI state field in corresponding DCI to UL transmission and DL reception beams. DCI format 1_1 or 1_2 may include DL data channel scheduling information with or without DL assignment.

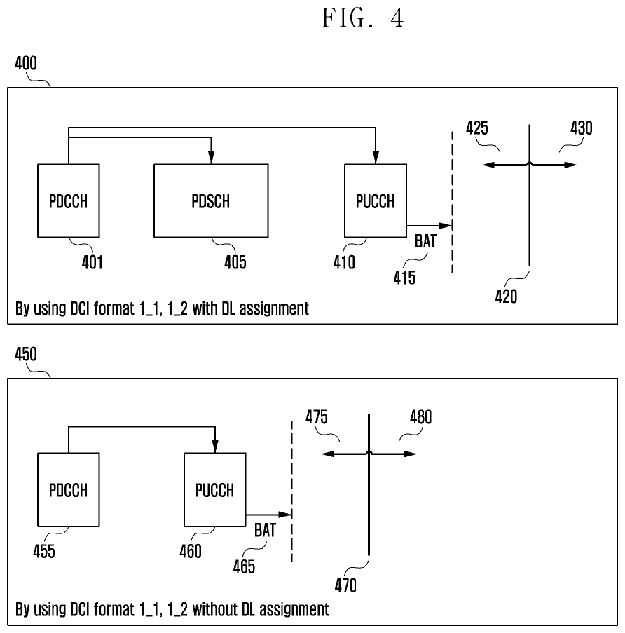

FIG. 4 illustrates a beam application time which may be considered when a unified TCI scheme is used in a wireless communication system according to an embodiment. Referring to FIG. 4, the UE may receive DCI format 1_1 or 1_2 including DL data channel scheduling information with or without DL assignment from the BS, and may apply one joint TCI state or separate TCI state set indicted by the TCI state field in corresponding DCI to UL transmission and DL reception beams.

DCI format 1_1 or 1_2 with DL assignment (400): If a UE receives, from a BS, DCI format 1_1 or 1_2 including DL data channel scheduling information (401) so that one joint TCI state or one separate TCI state set based on a unified TCI scheme is indicated, the UE may receive a PDSCH scheduled based on the received DCI (405), and transmit a PUCCH including a HARQ-ACK indicating whether reception of the DCI and the PDSCH has been successful (410). In this case, the HARQ-ACK may include whether reception has been successful, for both the DCI and the PDSCH, if the UE fails to receive at least one of the DCI and the PDSCH, the UE may transmit a NACK, and if the UE succeeds in receiving both the DCI and the PDSCH, the UE may transmit an ACK.

DCI format 1_1 or 1_2 without DL assignment (450): If a UE receives, from a BS, DCI format 1_1 or 1_2 not including DL data channel scheduling information (455) so that one joint TCI state or one separate TCI state set based on a unified TCI scheme is indicated, the UE may assume at least one combination of the following items for the DCI.

The DCI includes a CRC scrambled using a CS-RNTI.

The values of all bits assigned to all fields used as redundancy version (RV) fields are 1.

The values of all bits assigned to all fields used as modulation and coding scheme (MCS) fields are 1.

The values of all bits assigned to all fields used as new data indication (NDI) fields are 0.

In frequency domain resource allocation (FDRA) type 0, the values of all bits assigned to an FDRA field are 0, in FDRA type 1, the values of all bits assigned to an FDRA field are 1, and in an FDRA scheme being dynamicSwitch, the values of all bits assigned to an FDRA field are 0.

The UE may transmit a PUCCH including a HARQ-ACK indicating whether DCI format 1_1 or 1_2 for which the items described above are assumed has been successfully received (460).

With respect to both DCI format 1_1 or 1_2 with DL assignment (400) and without DL assignment (450), if the new TCI state indicated through DCI 401 or 455 is the same as a TCI state that has previously been indicated and thus been being applied to UL transmission and DL reception beams, the UE may maintain the previously applied TCI state. If the new TCI state is different from the previously indicated TCI state, the UE may determine, as a time point for application of the joint TCI state or separate TCI state set, which is indicated by a TCI state field included in the DCI, a time point 430 or 480 after the first slot 420 or 470 after passage of a time interval as long as a beam application time (BAT) 415 or 465 after PUCCH transmission, and may use the previously indicated TCI state at a time point 425 or 475 before the slot 420 or 470.

With regard to both DCI format 1_1 or 1_2 with DL assignment (400) and without DL assignment (450), the BAT is a particular number of OFDM symbols and may be configured through higher layer signaling, based on UE capability report information, and numerologies of the BAT and the first slot after the BAT may be determined based on the smallest numerology among all cells to which a joint TCI state or separate TCI state set indicated through DCI is applied.

A UE may apply one joint TCI state indicated through a MAC-CE or DCI to reception for CORESETs connected to all UE-specific search spaces, reception of a PDSCH scheduled by a PDCCH transmitted from the CORESETs and transmission of a PUSCH, and transmission of all PUCCH resources.

If one separate TCI state set indicated through a MAC-CE or DCI includes one DL TCI state, a UE may apply the one separate TCI state set to reception for CORESETs connected to all UE-specific search spaces and to reception of a PDSCH scheduled by a PDCCH transmitted from the CORESETs, and apply a previously indicated UL TCI state to all PUSCH and PUCCH resources.

If one separate TCI state set indicated through a MAC-CE or DCI includes one UL TCI state, a UE may apply the one separate TCI state set to all PUSCH and PUCCH resources, and apply a previously indicated DL TCI state to reception for CORESETs connected to all UE-specific search spaces and reception of a PDSCH scheduled by a PDCCH transmitted from the CORESETs.

If one separate TCI state set indicated through a MAC-CE or DCI includes one DL TCI state and one UL TCI state, a UE may apply the DL TCI state to reception for CORESETs connected to all UE-specific search spaces and reception of a PDSCH scheduled by a PDCCH transmitted from the CORESETs, and apply the UL TCI state to all PUSCH and PUCCH resources.

### Unified TCI State MAC-CE

A PDSCH including a MAC-CE described below may be scheduled to a UE by a BS, and the UE may interpret each codepoint of a TCI state field in DCI format 1_1 or 1_2, based on information in the MAC-CE received from the BS, after 3 slots from transmission of a HARQ-ACK for the PDSCH to the BS. That is, the UE may activate each entry of the MAC-CE received from the BS in each codepoint of the TCI state field in DCI format 1_1 or 1_2.

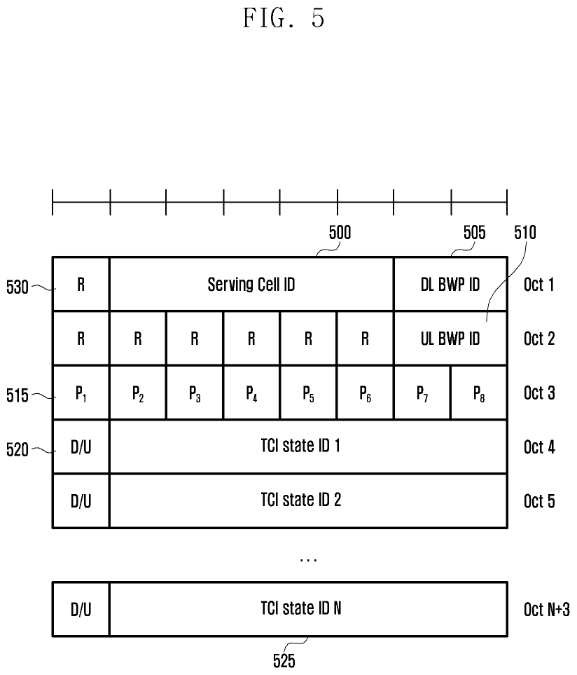

FIG. 5 illustrates a MAC-CE structure for activation and indication of a joint TCI state or a separate DL or UL TCI state in a wireless communication system according to an embodiment. Referring to FIG. 5, each field in the MAC-CE structure may have the following meaning.

Serving Cell ID 500 indicates which serving cell to which a corresponding MAC-CE is to be applied. The length of this field may be 5 bits. If a serving cell indicated by this field is included in at least one of the higher layer signaling simultaneousU-TCI-UpdateList1, simultaneousU-TCI-UpdateList2, simultaneousU-TCI-UpdateList3, or simultaneousU-TCI-UpdateList4, the MAC-CE may be applied to all serving cells included in one or more lists among simultaneousU-TCI-UpdateList1, simultaneousU-TCI-UpdateList2, simultaneousU-TCI-UpdateList3, or simultaneousU-TCI-UpdateList4, in which the serving cell indicated by the field is included.

DL BWP ID 505 indicates which DL BWP to which the MAC-CE is to be applied, and the meanings of codepoints in the field may correspond to codepoints of a BWP indicator in DCI, respectively. The length of this field may be 2 bits.

UL BWP ID 510 indicates which UL BWP to which the MAC-CE is to be applied, and the meanings of codepoints in the field may correspond to codepoints of a BWP indicator in DCI, respectively. The length of this field may be 2 bits.

Pi 515 indicates whether each codepoint of a TCI state field in DCI format 1_1 or 1_2 has multiple TCI states or one TCI state. If the value of Pi is 1, this indicates that a corresponding i-th codepoint has multiple TCI states, and may imply that the codepoint may include a separate DL TCI state and a separate UL TCI state. If the value of Pi is 0, this indicates that a corresponding i-th codepoint has a single TCI state, and may imply that the codepoint may include one type among a joint TCI state, a separate DCI TCI state, or a separate UL TCI state.

D/U 520 indicates whether a TCI state ID field in the same octet is a joint TCI state, a separate DL TCI state, or a separate UL TCI state. If the field is 1, a TCI state ID field in the same octet may be a joint TCI state or a separate DL TCI state, and if the field is 0, a TCI state ID field in the same octet may be a separate UL TCI state.

TCI state ID 525 indicates a TCI state identifiable by the higher layer signaling TCI-StateId. If the D/U field is configured to be 1, the TCI state ID field may be used to represent TCI-StateId expressible by 7 bits. If the D/U field is configured to be 0, a most significant bit (MSB) of the TCI state ID field may be considered as a reserved bit, and the remaining 6 bits may be used to represent the higher layer signaling UL-TCIState-Id. The number of maximally activatable TCI states may be 8 in joint TCI states, and may be 16 in separate DL or UL TCI states.

R indicates a reserved bit and may be configured to be 0.

As to the MAC-CE structure of FIG. 2, a UE may include, in the MAC-CE structure, a third octet including P1, P2, . . . , and P8 fields in FIG. 2 regardless of unifiedTCI-StateType-r17 in MIMOparam-r17 in the higher layer signaling ServingCellConfig being configured to be joint or separate. In this case, the UE may perform TCI state activation by using a fixed MAC-CE structure regardless of higher layer signaling configured by a BS. As another example, with respect to the above-described MAC-CE structure of FIG. 5, a UE may omit the third octet including P1, P2, . . . , and P8 fields illustrated in FIG. 5, when unifiedTCI-StateType-r17 in MIMOparam-r17 in the higher layer signaling ServingCellConfig being configured to be joint. In this case, the UE may save the payload of the MAC-CE by a maximum of 8 bits according to higher layer signaling configured by a BS. All D/U fields positioned on the first bits in octets starting from a fourth octet in FIG. 5 may be considered as R fields, and all the R fields may be configured to be 0 bits.

### CSI Resource Configuration

In NR, the BS has a CSI framework for indicating CSI measurement and reporting of the UE. The NR CSI framework may include at least two elements of a resource setting and a report setting, and the report setting may have a relationship with the resource setting by referencing at least one ID of the resource setting.

The resource setting may include information related to an RS for a UE to measure channel state information. The BS may configure at least one resource setting for the UE. The BS and the UE may exchange the signaling information as in Table 4 below to transfer information regarding a resource setting.

TABLE 4
-- ASN1START
-- TAG-CSI-RESOURCECONFIG-START

| | |
|---|---|
| CSI-ResourceConfig ::= | SEQUENCE { |
| csi-ResourceConfigId | CSI-ResourceConfigId, |
| csi-RS-ResourceSetList | CHOICE { |
| non-zero power (nzp)-CSI-RS-SSB | SEQUENCE { |
| nzp-CSI-RS-ResourceSetList | SEQUENCE (SIZE (1..maxNrofNZP-CSI-RS- |

ResourceSetsPerConfig)) OF NZP-CSI-RS-ResourceSetId
OPTIONAL, -- Need R

| | |
|---|---|
| csi-SSB-ResourceSetList | SEQUENCE (SIZE (1..maxNrofCSI-SSB- |

ResourceSetsPerConfig)) OF CSI-SSB-ResourceSetId
OPTIONAL -- Need R
},

| | |
|---|---|
| csi-IM-ResourceSetList | SEQUENCE (SIZE (1..maxNrofCSI-IM- |

ResourceSetsPerConfig)) OF CSI-IM-ResourceSetId
},

| | |
|---|---|
| bwp-Id | BWP-Id, |
| resourceType | ENUMERATED { aperiodic, semiPersistent, periodic }, |

...
}
-- TAG-CSI-RESOURCECONFIG-STOP
-- ASN1STOP

Table 4 above indicates that signaling information CSI-ResourceConfig includes information for each resource setting. According to the signaling information, each resource setting may include a resource setting index (csi-ResourceConfigId) or a BWP index (bwp-ID) or a time domain transmission configuration (resourceType) of a resource or a resource set list (csi-RS-ResourceSetList) including at least one resource set. The time domain transmission configuration of the resource may be configured as aperiodic transmission, semi-persistent transmission, or periodic transmission. The resource set list may be a set including a resource set for channel measurement or a set including a resource set for interference measurement. When the resource set list is a set including a resource set for channel measurement, each resource set may include at least one resource, which may be an index of a CSI-RS resource or a synchronization signal/physical broadcast channel block (SS/PBCH block, SSB). When the resource set list is a set including a resource set for interference measurement, each resource set may include at least one CSI-IM resource.

For example, when a resource set includes a CSI-RS, a BS and a UE may exchange signaling information as in Table 5 below to transfer information regarding the resource set.

TABLE 5
-- ASN1START
-- TAG-NZP-CSI-RS-RESOURCESET-START

| | |
|---|---|
| NZP-CSI-RS-ResourceSet ::= | SEQUENCE |
| nzp-CSI-ResourceSetId | NZP-CSI-RS-ResourceSetId, |
| nzp-CSI-RS-Resources | SEQUENCE (SIZE |

(1..maxNrofNZP-CSI-RS-ResourcesPerSet)) OF NZP-CSI-RS-ResourceId,

| | |
|---|---|
| repetition | ENUMERATED { on, off } |

OPTIONAL, -- Need S

| | |
|---|---|
| aperiodicTriggeringOffset | INTEGER(0..6) |

OPTIONAL, -- Need S

| | |
|---|---|
| trs-Info | ENUMERATED {true} |

OPTIONAL, -- Need R
...
}
-- TAG-NZP-CSI-RS-RESOURCESET-STOP
-- ASN1STOP

The signaling information NZP-CSI-RS-ResourceSet in Table 5 includes information for each resource set. According to the signaling information, each resource set includes information on at least a resource set index (nzp-CSI-ResourceSetId) or a set of indices of CSI-RSs included in the resource set, and may include information on a spatial domain transmission filter (repetition) of the included CSI-RS resources, or part of information indicating whether the included CSI-RS resources are used for tracking (trs-Info).

The CSI-RS may be a most representative reference signal included in a resource set. The BS and the UE may exchange signaling information as in Table 6 below to transfer information on a CSI-RS resource.

TABLE 6
-- ASN1START
-- TAG-NZP-CSI-RS-RESOURCE-START

| | |
|---|---|
| NZP-CSI-RS-Resource ::= | SEQUENCE { |
| nzp-CSI-RS-ResourceId | NZP-CSI-RS-ResourceId, |
| resourceMapping | CSI-RS-ResourceMapping, |
| powerControlOffset | INTEGER (−8..15), |
| powerControlOffsetSS | ENUMERATED{db−3, db0, db3, db6} |

OPTIONAL, -- Need R

| | |
|---|---|
| scramblingID | ScramblingId, |
| periodicityAndOffset | CSI-ResourcePeriodicityAndOffset |

OPTIONAL, -- Cond PeriodicOrSemiPersistent

| | |
|---|---|
| qcl-InfoPeriodicCSI-RS | TCI-StateId |

OPTIONAL, -- Cond Periodic
...
}
-- TAG-NZP-CSI-RS-RESOURCE-STOP
-- ASN1STOP

The signaling information NZP-CSI-RS-Resource in Table 6 includes information for each CSI-RS. The information included in the signaling information NZP-CSI-RS-Resource may have the following meanings.
nzp-CSI-RS-ResourceId: CSI-RS resource index
resourceMapping: resource mapping information of the CSI-RS resource
powerControlOffset: the ratio between PDSCH EPRE (Energy Per RE) and CSI-RS EPRE
powerControlOffsetSS: ratio between SS/PBCH block EPRE and CSI-RS EPRE
scramblingID: scrambling index of a CSI-RS sequence
periodicityAndOffset: transmission period and slot offset of a CSI-RS resource
qcl-InfoPeriodicCSI-RS: When the corresponding CSI-RS is a periodic CSI-RS, TCI-state information

The resourceMapping included in the signaling information NZP-CSI-RS-Resource represents resource mapping information of a CSI-RS resource, and may include information on frequency RE mapping, the number of ports, symbol mapping, code division multiplexing (CDM) type, frequency resource density, and frequency band mapping. Through this, the number of ports, the frequency resource density, CDM type, and the time-frequency domain RE mapping that can be configured may have a value specified in one of the rows in Table 7 below.

TABLE 7

| | | | cdm- | | CDM group | | |
|---|---|---|---|---|---|---|---|
| Row | Ports ^{X} | Density ^{ρ} | Type | (k̅, l̅) | index ^{j} | k′ | l′ |
| 1 | 1 | 3 | noCDM | (k₀, l₀), (k₀ + 4, l₀), | 0, 0, 0 | 0 | 0 |
| | | | | (k₀ + 8, l₀) | | | |
| 2 | 1 | 1, 0.5 | noCDM | (k₀, l₀), | 0 | 0 | 0 |
| 3 | 2 | 1, 0.5 | fd- | (k₀, l₀), | 0 | 0, 1 | 0 |
| | | | CDM2 | | | | |
| 4 | 4 | 1 | fd- | (k₀, l₀), (k₀ + 2, l₀) | 0, 1 | 0, 1 | 0 |
| | | | CDM2 | | | | |
| 5 | 4 | 1 | fd- | (k₀, l₀), (k₀, l₀ + 1) | 0, 1 | 0, 1 | 0 |
| | | | CDM2 | | | | |
| 6 | 8 | 1 | fd- | (k₀, l₀), (k₁, l₀), | 0, 1, | 0, 1 | 0 |
| | | | CDM2 | (k₂, l₀), (k₃, l₀) | 2, 3 | | |
| 7 | 8 | 1 | fd- | (k₀, l₀), (k₁, l₀), | 0, 1, | 0, 1 | 0 |
| | | | CDM2 | (k₀, l₀ + 1), (k₁, l₀ + 1) | 2, 3 | | |
| 8 | 8 | 1 | cdm4- | (k₀, l₀), (k₁, l₀) | 0, 1 | 0, 1 | 0, 1 |
| | | | FD2-TD2 | | | | |
| 9 | 12 | 1 | fd- | (k₀, l₀), (k₁, l₀), (k₂, l₀), | 0, 1, 2, | 0, 1 | 0 |
| | | | CDM2 | (k₃, l₀), (k₄, l₀), (k₅, l₀) | 3, 4, 5 | | |
| 10 | 12 | 1 | cdm4- | (k₀, l₀), (k₁, l₀), (k₂, l₀) | 0, 1, 2 | 0, 1 | 0, 1 |
| | | | FD2-TD2 | | | | |
| 11 | 16 | 1, 0.5 | fd- | (k₀, l₀), (k₁, l₀), (k₂, l₀), | 0, 1, 2, 3, | 0, 1 | 0 |
| | | | CDM2 | (k₃, l₀), (k₀, l₀ + 1), | 4, 5, 6, 7 | | |
| | | | | (k₁, l₀ + 1), (k₂, l₀ + 1), | | | |
| | | | | (k₃, l₀ + 1) | | | |
| 12 | 16 | 1, 0.5 | cdm4- | (k₀, l₀), (k₁, l₀), | 0, 1, 2, 3 | 0, 1 | 0, 1 |
| | | | FD2-TD2 | (k₂, l₀), (k₃, l₀) | | | |
| 13 | 24 | 1, 0.5 | fd- | (k₀, l₀), (k₁, l₀), (k₂, l₀), | 0, 1, 2, 3, | 0, 1 | 0 |
| | | | CDM2 | (k₀, l₀ + 1), (k₁, l₀ + 1), | 4, 5, 6, 7, | | |
| | | | | (k₂, l₀ + 1), (k₀, l₁), | 8, 9, 10, 11 | | |
| | | | | (k₁, l₁), (k₂, l₁), | | | |
| | | | | (k₀, l₁ + 1), (k₁, l₁ + 1), | | | |
| | | | | (k₂, l₁ + 1) | | | |
| 14 | 24 | 1, 0.5 | cdm4- | (k₀, l₀), (k₁, l₀), (k₂, l₀), | 0, 1, 2, | 0, 1 | 0, |
| | | | FD2-TD2 | (k₀, l₁), (k₁, l₁), (k₂, l₁) | 3, 4, 5 | | 1 |
| 15 | 24 | 1, 0.5 | cdm8- | (k₀, l₀), (k₁, l₀), (k₂, l₀) | 0, 1, 2 | 0, 1 | 0, 1, |
| | | | FD2-TD4 | | | | 2, 3 |
| 16 | 32 | 1, 0.5 | fd- | (k₀, l₀), (k₁, l₀), (k₂, l₀), | 0, 1, 2, | 0, 1 | 0 |
| | | | CDM2 | (k₃, l₀), (k₀, l₀ + 1) | 3, 4, 5, | | |
| | | | | (k₁, l₀ + 1), (k₂, l₀ + 1), | 6, 7, 8, | | |
| | | | | (k₃, l₀ + 1), (k₀, l₁), | 9, 10, 11, | | |
| | | | | (k₁, l₁), (k₂, l₁), (k₃, l₁), | 12, 13, | | |
| | | | | (k₀, l₁ + 1), (k₁, l₁ + 1), | 14, 15 | | |
| | | | | (k₂, l₁ + 1), (k₃, l₁ + 1) | | | |
| 17 | 32 | 1, 0.5 | cdm4- | (k₀, l₀), (k₁, l₀), (k₂, l₀), | 0, 1, 2, | 0, 1 | 0, 1 |
| | | | FD2-TD2 | (k₃, l₀), (k₀, l₁), (k₁, l₁), | 3, 4, 5, | | |
| | | | | (k₂, l₁), (k₃, l₁) | 6, 7 | | |
| 18 | 32 | 1, 0.5 | cdm8- | (k₀, l₀), (k₁, l₀), | 0, 1, 2, 3 | 0, 1 | 0, 1, |
| | | | FD2-TD4 | (k₂, l₀), (k₃, l₀) | | | 2, 3 |

Table 7 shows the frequency resource density configurable according to the number X of CSI-RS ports, the CDM type, the frequency axis and time axis start position (k̅,l̅) of a CSI-RS component RE pattern, and the frequency axis RE number (k′) and time axis RE number (l′) of the CSI-RS component RE pattern. The above-described CSI-RS component RE pattern may be a basic unit constituting a CSI-RS resource. The CSI-RS component RE pattern may be configured by YZ REs through Y=1+max (k′) REs in the frequency domain and Z=1+max (l′) REs in the time domain. When the number of CSI-RS ports is one, the CSI-RS RE position may be designated without limitation on subcarriers within a physical resource block (PRB), and the CSI-RS RE position may be designated by a 12-bit bitmap. When the number of CSI-RS ports is {2, 4, 8, 12, 16, 24, 32} and Y=2, the CSI-RS RE position may be designated for every two subcarriers within a PRB, and the CSI-RS RE position may be designated by a 6-bit bitmap. When the number of CSI-RS ports is four and Y=4, the CSI-RS RE position may be designated for every four subcarriers within a PRB, and the CSI-RS RE position may be designated by a 3-bit bitmap. Similarly, the time-domain RE position may be specified by a 14-bit bitmap in total.

### CSI Report Configuration

A report setting may have a relationship with at least one resource setting by referencing an ID of the resource setting, and the resource setting(s) having a relationship with the report setting may provide configuration information including information on a reference signal for channel information measurement. When a resource setting(s) having an association with a report setting is used for channel information measurement, the measured channel information may be used for channel information reporting according to a reporting method configured in the report setting having the association.

A report setting may include configuration information related to a CSI reporting method. For example, a BS and a UE may exchange signaling information as in Table 8 below to transfer information regarding a report setting.

TABLE 8
-- ASN1START
-- TAG-CSI-REPORTCONFIG-START

| CSI-ReportConfig ::= | | SEQUENCE { |
|---|---|---|
| reportConfigId | | CSI-ReportConfigId, |
| carrier | | ServCellIndex |
| OPTIONAL, | -- Need S | |
| resourcesForChannelMeasurement | | CSI-ResourceConfigId, |
| csi-IM-ResourcesForInterference | | CSI-ResourceConfigId |
| OPTIONAL, | -- Need R | |
| nzp-CSI-RS-ResourcesForInterference | | CSI-ResourceConfigId |
| OPTIONAL, | -- Need R | |
| reportConfigType | | CHOICE { |
| periodic | | SEQUENCE { |
| | reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | | |
|---|---|---|
| semiPersistentOnPUCCH | | SEQUENCE { |
| | reportSlotConfig | CSI- |

ReportPeriodicityAndOffset,

| | |
|---|---|
| pucch-CSI-ResourceList | SEQUENCE (SIZE |

(1..maxNrofBWPs)) OF PUCCH-CSI-Resource
},

| | | |
|---|---|---|
| semiPersistentOnPUSCH | | SEQUENCE { |
| | reportSlotConfig | ENUMERATED {sl5, sl10, |

sl20, sl40, sl80, sl160, sl320},

| | |
|---|---|
| reportSlotOffsetList | SEQUENCE (SIZE (1.. maxNrofUL- |

Allocations)) OF INTEGER(0..32),

| | |
|---|---|
| p0alpha | P0-PUSCH-AlphaSetId |

},

| | | |
|---|---|---|
| aperiodic | | SEQUENCE { |
| | reportSlotOffsetList | SEQUENCE (SIZE (1..maxNrofUL- |

```
Allocations)) OF INTEGER(0..32)
    }
  },
```

| | | |
|---|---|---|
| reportQuantity | | CHOICE { |
| none | | NULL, |
| cri-RI-PMI-CQI (channel quality indicator) | | NULL, |
| cri-RI-il | | NULL, |
| cri-RI-i1-CQI | | SEQUENCE { |
| | pdsch-BundleSizeForCSI | ENUMERATED {n2, n4} |

| | |
|---|---|
| OPTIONAL | -- Need S |

},

| | |
|---|---|
| cri-RI-CQI | NULL, |
| cri-RSRP (reference signal received power) | NULL, |
| ssb-Index-RSRP | NULL, |
| cri-RI-LI-PMI-CQI | NULL |

},

| reportFreqConfiguration | | SEQUENCE { | |
|---|---|---|---|
| cqi-FormatIndicator | | ENUMERATED { widebandCQI, | |
| subbandCQI } | | OPTIONAL, | -- Need R |
| pmi-FormatIndicator | | ENUMERATED { widebandPMI, | |
| subbandPMI } | | OPTIONAL, | -- Need R |
| csi-ReportingBand | | CHOICE { | |
| | subbands3 | | BIT STRING(SIZE(3)), |
| | subbands4 | | BIT STRING(SIZE(4)), |
| | subbands5 | | BIT STRING(SIZE(5)), |
| | subbands6 | | BIT STRING(SIZE(6)), |
| | subbands7 | | BIT STRING(SIZE(7)), |
| | subbands8 | | BIT STRING(SIZE(8)), |
| | subbands9 | | BIT STRING(SIZE(9)), |
| | subbands10 | | BIT STRING(SIZE(10)), |
| | subbands11 | | BIT STRING(SIZE(11)), |
| | subbands12 | | BIT STRING(SIZE(12)), |
| | subbands13 | | BIT STRING(SIZE(13)), |
| | subbands14 | | BIT STRING(SIZE(14)), |
| | subbands15 | | BIT STRING(SIZE(15)), |
| | subbands16 | | BIT STRING(SIZE(16)), |
| | subbands17 | | BIT STRING(SIZE(17)), |
| | subbands18 | | BIT STRING(SIZE(18)), |
| | ..., | | |
| | subbands19-v1530 | | BIT STRING(SIZE(19)) |

| | |
|---|---|
| } | OPTIONAL -- Need S |

}

| OPTIONAL, | -- Need R | |
|---|---|---|
| timeRestrictionForChannelMeasurements | | ENUMERATED {configured, |

notConfigured},

| | |
|---|---|
| timeRestrictionForInterferenceMeasurements | ENUMERATED {configured, |

notConfigured},

| codebookConfig | | | CodebookConfig |
|---|---|---|---|
| OPTIONAL, | -- Need R | | |
| dummy | | | ENUMERATED {n1, n2} |
| OPTIONAL, | -- Need R | | |
| groupBasedBeamReporting | | CHOICE { | |
| enabled | | | NULL, |
| disabled | | SEQUENCE { | |
| | nrofReportedRS | | ENUMERATED {n1, n2, n3, |

| | |
|---|---|
| n4} | OPTIONAL -- Need S |

```
    }
  },
```

| cqi-Table | | ENUMERATED {table1, table2, table3, spare1} |
|---|---|---|
| OPTIONAL, | -- Need R | |
| subbandSize | | ENUMERATED {value1, value2}, |
| non-PMI-PortIndication | | SEQUENCE (SIZE (1..maxNrofNZP-CSI-RS- |

```
ResourcesPerConfig)) OF PortIndexFor8Ranks OPTIONAL, -- Need R
  ...,
  [[
```

| | |
|---|---|
| semiPersistentOnPUSCH-v1530 | SEQUENCE { |
| reportSlotConfig-v1530 | ENUMERATED {sl4, sl8, sl16} |

}

| | |
|---|---|
| OPTIONAL | -- Need R |

]]
}

The signaling information CSI-ReportConfig in Table 8 includes information for each report setting. The information included in the signaling information CSI-ReportConfig may include the following information having the following meanings.
reportConfigId: index of the report setting
carrier: serving cell index
resourcesForChannelMeasurement: an index for a resource setting for channel measurement having an association with the report setting
csi-IM-ResourcesForInterference: a resource setting index having CSI-IM resources for interference measurement that has an association with the report setting
nzp-CSI-RS-ResourcesForInterference: a resource setting index having CSI-RS resources for interference measurement, which is associated with the report setting
reportConfigType: This indicates the time domain transmission configuration and transmission channel of channel reporting, and may have aperiodic transmission, semi-persistent PUCCH transmission, semi-persistent PUSCH transmission, or periodic transmission configuration.

reportQuantity: indicates a type of channel information to be reported, and may have a value of “none” (indicating no channel report) or a type of channel information in case of transmitting a channel report (“cri-RI-PMI-CQI”, “cri-RI-i1”, “cri-RI-i1-CQI”, “cri-RI-CQI”, “cri-RSRP”, “ssb-Index-RSRP”, or “cri-RI-LI-PMI-CQI”). The element included in the type of channel information may refer to a CQI, a precoding matrix indicator (PMI), a CSI-RS resource indicator (CRI), an SS/PBCH block resource indicator (SSBRI), a layer indicator (LI), a rank indicator (RI), and/or an L1-RSRP.

reportFreqConfiguration: indicates whether the channel information to be reported includes only information regarding the entire band (wideband) or information regarding each subband, and may have configuration information regarding the subband including the channel information, when the information regarding each subband is included.

timeRestrictionForChannelMeasurements: Whether there is a time domain restriction regarding the reference signal for channel measurement among the reference signals to which the reported channel information refers
timeRestrictionForInterferenceMeasurements: Whether there is a time domain restriction for the reference signal for interference measurement among the reference signals to which the reported channel information refers
codebookConfig: information on the codebook to which the reported channel information refers
groupBasedBeamReporting: whether channel reporting is beam-grouped
cqi-Table: CQI table index referenced by the reported channel information
subbandSize: an index indicating a subband size of channel information
non-PMI-PortIndication: port mapping information to be referred to when non-PMI channel information is reported

When the BS indicates channel information reporting through higher layer signaling or L1 signaling, the UE may perform channel information reporting by referring to the above-described configuration information included in the indicated report setting.

The BS may indicate CSI reporting to a UE through higher layer signaling including RRC signaling or MAC-CE signaling, or L1 signaling (e.g., common DCI, group-common DCI, or UE-specific DCI).

The BS may indicate, to the UE, an aperiodic CSI report through higher layer signaling or DCI using DCI format 0_1. The BS configures a parameter for aperiodic CSI report of the UE, or a plurality of CSI report trigger states including a parameter for a CSI report, through higher layer signaling. Parameters for a CSI report or a CSI report trigger state may include a set including a slot interval or possible slot intervals between a PDCCH including DCI and a PUSCH including a CSI report, a reference signal ID for channel state measurement, and a type of channel information to be included. When the BS indicates a part of a plurality of CSI report trigger states to the UE through DCI, the UE reports channel information according to the CSI report configuration of the report setting configured in the indicated CSI report trigger state. The channel information report may be performed through a PUSCH scheduled by DCI format 0_1. Time domain resource allocation for a PUSCH including a CSI report of the UE may be performed through a slot interval between a PDCCH for which DCI is indicated and the PUSCH, a start symbol in a slot for time domain resource allocation for the PUSCH, and an indicator for a symbol length. The position of a slot in which a PUSCH including the CSI report of the UE is transmitted may be indicated through a slot interval between a PDCCH indicated through DCI and the PUSCH, and the start symbol and symbol length in the slot may be indicated through the time domain resource assignment field of the DCI described above.

The BS may indicate a semi-persistent CSI report to be transmitted through a PUSCH to the UE through DCI using DCI format 0_1. The BS may activate or deactivate a semi-persistent CSI report transmitted through a PUSCH through DCI scrambled by an SP-CSI-RNTI. When the semi-persistent CSI report is activated, the UE may periodically report channel information according to the configured slot interval. When the semi-persistent CSI report is disabled, the UE may stop the periodic channel information report that was activated. The BS may configure, through higher layer signaling, a parameter for the semi-persistent CSI report of the UE or multiple CSI report trigger states including a parameter for a semi-persistent CSI report. Parameters for a CSI report, or a CSI report trigger state, may include a set including a slot interval or possible slot intervals between a PDCCH including DCI indicating a CSI report and a PUSCH including a CSI report, a slot interval between a slot in which higher layer signaling indicating a CSI report is activated and a PUSCH including a CSI report, a slot interval cycle of a CSI report, and a type of channel information included.

When the BS activates, for the UE, a part of multiple CSI report trigger states or a part of multiple report settings through higher layer signaling or DCI, the UE may report channel information according to a CSI report configuration configured in a report setting included in the indicated CSI report trigger state or in the activated report setting. The channel information report may be performed through a semi-persistently scheduled PUSCH by DCI format 0_1 scrambled by an SP-CSI-RNTI. Time domain resource allocation of a PUSCH including a CSI report may be performed through a slot interval period of the CSI report, a slot interval between a slot in which higher-layer signaling is activated and the PUSCH, a slot interval between a PDCCH indicated through DCI and the PUSCH, or an indication of a start symbol and symbol length within a slot for time-domain resource allocation of the PUSCH. The location of a slot in which a PUSCH including a CSI report of a UE is transmitted may be indicated through a slot interval between a PDCCH indicated through DCI and the PUSCH, and a start symbol and a symbol length within the slot may be indicated through the time domain resource assignment field of DCI format 0_1 described above.

The BS may indicate, to the UE, a semi-persistent CSI report transmitted through a PUCCH, through higher layer signaling such as a MAC-CE. The BS may activate or deactivate a semi-persistent CSI report transmitted through a PUCCH through the MAC-CE signaling. When a semi-persistent CSI report is activated, the UE may periodically report channel information according to a configured slot interval. When the semi-persistent CSI report is deactivated, the UE may stop the periodic channel information report that has been activated. The BS configures parameters for a semi-persistent CSI report of the UE through higher layer signaling. The CSI report parameter may include a PUCCH resource for transmitting the CSI report, a slot interval period of the CSI report, and a type of channel information to be included. The UE may transmit the CSI report through a PUCCH. Alternatively, when the PUCCH for CSI report overlaps with the PUSCH, the CSI report may be transmitted through the PUSCH. The location of the PUCCH transmission slot in which the CSI report is included may be indicated by a slot interval period of the CSI report configured through higher layer signaling, and a slot interval between a slot in which higher layer signaling is activated and a PUCCH including the CSI report. The start symbol and symbol length within the slot may be indicated by a start symbol and symbol length allocated to a PUCCH resource configured through higher layer signaling.

The BS may indicate a periodic CSI report to the UE through higher layer signaling. The BS may activate or deactivate a periodic CSI report through higher layer signaling including RRC signaling. When a periodic CSI report is activated, the UE may periodically report channel information according to a configured slot interval. When the periodic CSI report is disabled, the UE may stop the periodic channel information reporting that has been activated. The BS configures a report setting including parameters for a periodic CSI report of a UE through higher layer signaling. Parameters for a CSI report may include a PUCCH resource configuration for a CSI report, a slot interval between a slot in which higher layer signaling indicating a CSI report is activated and a PUCCH including a CSI report, a slot interval period of the CSI report, a reference signal ID for channel state measurement, and a type of channel information to be included. The UE may transmit the CSI report through a PUCCH. Alternatively, when the PUCCH for the CSI report overlaps with the PUSCH, the CSI report may be transmitted through the PUSCH. The position of a slot in which the PUCCH including the CSI report is transmitted may be indicated by a slot interval period of the CSI report configured through higher layer signaling, and a slot interval between a slot in which the higher layer signaling is activated and the PUCCH including the CSI report. The start symbol and symbol length within the slot may be indicated by a start symbol and symbol length allocated to a PUCCH resource configured through higher layer signaling.

With regard to the aforementioned CSI report configurations (CSI-ReportConfig), each report configuration CSI-ReportConfig may be associated with one DL BWP identified by a higher-layer parameter BWP identifier (bwp-id) given by the CSI resource configuration CSI-ResourceConfig associated with the corresponding report configuration. As a time domain reporting operation for each report configuration CSI-ReportConfig, “aperiodic”, “semi-persistent”, and “periodic” schemes may be supported, and these schemes may be configured for the UE by the BS via a reportConfigType parameter configured from a higher layer. A semi-persistent CSI report method may support a “PUCCH-based semi-persistent (semi-PersistentOnPUCCH)” method and a “PUSCH-based semi-persistent (semi-PersistentOnPUSCH)” method. In the periodic or semi-persistent CSI report method, a PUCCH or PUSCH resource in which CSI is to be transmitted may be configured for the UE by the BS via higher-layer signaling. A periodicity and a slot offset of the PUCCH or PUSCH resource in which CSI is to be transmitted may be given by a numerology of a UL BWP configured for CSI report transmission. In the aperiodic CSI report method, a PUSCH resource in which CSI is to be transmitted may be scheduled for the UE by the BS via L1 signaling (aforementioned DCI format 0_1).

With regard to the aforementioned CSI resource configurations (CSI-ResourceConfig), each CSI resource configuration CSI-ReportConfig may include S (>=1) CSI resource sets (e.g., given via a higher-layer parameter of csi-RS-ResourceSetList). A CSI resource set list may include an NZP CSI-RS resource set and an SS/PBCH block set or may include a CSI-IM resource set. Each CSI resource setting may be positioned in a DL BWP identified by higher-layer parameter bwp-id and may be connected to CSI report setting in the same DL BWP. A time domain step of a CSI-RS resource in the CSI resource configuration may be configured to be one of “aperiodic”, “periodic”, or “semi-persistent” from the higher-layer parameter resourceType. With regard to the periodic or semi-persistent CSI resource configuration, the number of CSI-RS resource sets may be limited to S=1, and the configured periodicity and slot offset may be given based on a numerology of the DL BWP identified by bwp-id. One or more CSI resource settings for channel or interference measurement may be configured for the UE by the BS via higher-layer signaling, and may include the following CSI resources.
CSI-IM resource for interference measurement
NZP CSI-RS resource for interference measurement
NZP CSI-RS resource for channel measurement

With regard to CSI-RS resource sets associated with a resource configuration in which the higher-layer parameter of resourceType is configured to be “aperiodic”, “periodic”, or “semi-persistent”, a trigger state of CSI report configuration having reportType configured to be “aperiodic”, and a resource configuration for channel or interference measurement on one or multiple component cells (CCs) may be configured via the higher-layer parameter of CSI-AperiodicTriggerStateList.

Aperiodic CSI reporting of the UE may be performed using a PUSCH, periodic CSI reporting may be performed using a PUCCH, and semi-persistent CSI reporting may be performed using a PUSCH when triggered or activated via DCI, and may be performed using a PUCCH after activated via a MAC CE. As described above, CSI resource configurations may also be configured to be aperiodic, periodic, or semi-persistent. A combination of CSI reporting setting and CSI resource configuration may be supported based on Table 9 below.

TABLE 9

| CSI-RS | Periodic CSI | Semi-Persistent CSI | Aperiodic CSI |
|---|---|---|---|
| Configuration | Reporting | Reporting | Reporting |
| Periodic CSI- | No dynamic | For reporting on | Triggered by DCI; |
| RS | triggering/ | PUCCH, the UE | additionally, |
| | activation | receives an activation | activation command |
| | | command [10, TS | [10, TS 38.321] |
| | | 38.321]; for reporting on | possible as defined |
| | | PUSCH, the UE receives | in Subclause |
| | | triggering on DCI | 5.2.1.5.1. |
| Semi- | Not Supported | For reporting on | Triggered by DCI; |
| Persistent CSI- | | PUCCH, the UE | additionally, |
| RS | | receives an activation | activation command |
| | | command [10, TS | [10, TS 38.321] |
| | | 38.321]; for reporting on | possible as defined |
| | | PUSCH, the UE receives | in Subclause |
| | | triggering on DCI | 5.2.1.5.1. |
| Aperiodic CSI- | Not Supported | Not Supported | Triggered by DCI; |
| | | | additionally, |
| RS | | | activation command |
| | | | [10, TS 38.321] |
| | | | possible as defined |
| | | | in Subclause |
| | | | 5.2.1.5.1. |

Aperiodic CSI reporting may be triggered by a “CSI request” field in DCI format 0_1 described above, which corresponds to scheduling DCI for a PUSCH. The UE may monitor a PDCCH, may acquire DCI format 0_1, and may acquire scheduling information of a PUSCH and a CSI request indicator. The CSI request indicator may be configured to have NTS (=0, 1, 2, 3, 4, 5, or 6) bits, and may be determined by higher-layer signaling (reportTriggerSize). One trigger state among one or multiple aperiodic CSI report trigger states which may be configured via higher-layer signaling (CSI-AperiodicTriggerStateList) may be triggered by the CSI request indicator.

If all bits in the CSI request field are 0, this may indicate that CSI reporting is not requested.

If the number M of configured CSI trigger states in CSI-AperiodicTriggerStateList is greater than 2NTs−1, M CSI trigger states may be mapped to 2NTs−1 trigger states according to a predefined mapping relation, and one trigger state among the 2NTs−1 trigger states may be indicated by the CSI request field.

If the number M of configured CSI trigger states in CSI-AperiodicTriggerStateLite is less than or equal to 2NTs−1, one of the M CSI trigger states may be indicated by the CSI request field.

Table 10 below shows a relationship between a CSI request indicator and a CSI trigger state that may be indicated by a corresponding indicator.

TABLE 10

| CSI request | CSI trigger | CSI- | CSI- |
|---|---|---|---|
| field | state | ReportConfigId | ResourceConfigId |
| 00 | no CSI request | N/A | N/A |
| 01 | | CSI report#1 | CSI resource#1, |
| | CSI trigger | CSI report#2 | CSI resource#2 |
| | state#1 | | |
| 10 | CSI trigger | CSI report#3 | CSI resource#3 |
| | state#2 | | |
| 11 | CSI trigger | CSI report#4 | CSI resource#4 |
| | state#3 | | |

The UE may measure a CSI resource in a CSI trigger state triggered via the CSI request field, and then generate CSI (including, for example, at least one of the CQI, PMI, CRI, SSBRI, LI, RI, or L1-RSRP described above) based on the measurement. The UE may transmit the acquired CSI by using the PUSCH scheduled via corresponding DCI format 0_1. If one bit corresponding to a UL data indicator (UL-SCH indicator) in DCI format 0_1 indicates “1”, the UE may multiplex UL data (UL-SCH) and the acquired CSI on the PUSCH resource scheduled by DCI format 0_1 to transmit the same. If one bit corresponding to the UL data indicator (UL-SCH indicator) in DCI format 0_1 indicates “0”, the UE may map only CSI, without uplink data (UL-SCH), to the PUSCH resource scheduled by DCI format 0_1 to transmit the same.

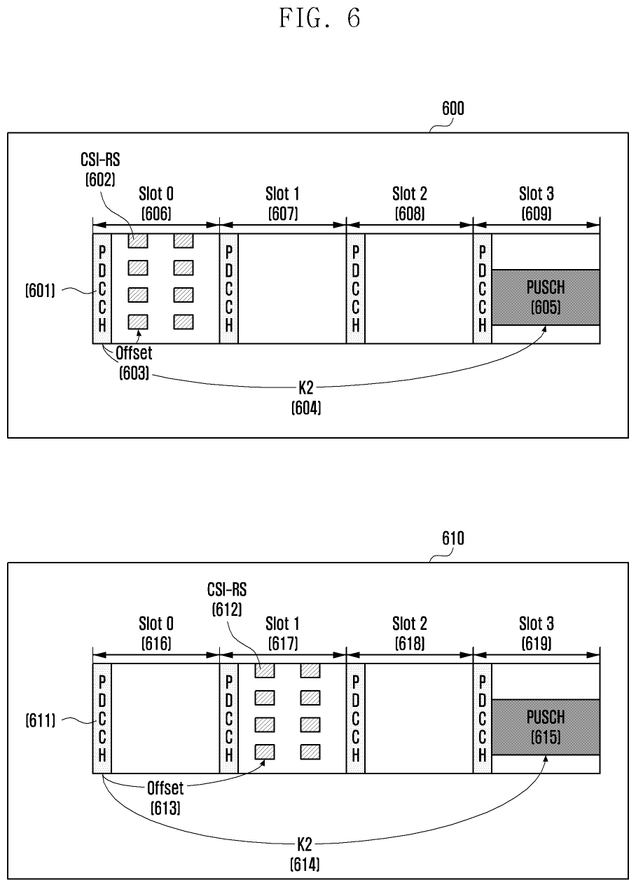

FIG. 6 illustrates an aperiodic CSI reporting method according to an embodiment.

Referring to FIG. 6, in example 600, a UE may acquire DCI format 0_1 by monitoring a PDCCH 601, and may acquire scheduling information and CSI request information for a PUSCH 605 therefrom. The UE may acquire resource information of a CSI-RS 602 to be measured, from a received CSI request indicator. The UE may determine a time point at which the UE needs to measure a resource of the CSI-RS 602, based on a time point at which DCI format 0_1 is received, and a parameter for an offset (e.g., aforementioned aperiodicTriggeringOffset) in a CSI resource set configuration (e.g., an NZP CSI-RS resource set configuration (NZP-CSI-RS-ResourceSet)). More specifically, the UE may be configured with an offset value X of the parameter, aperiodicTriggeringOffset, in the NZP-CSI-RS resource set configuration from a BS via higher-layer signaling, and the configured offset value X may refer to an offset between a slot in which DCI triggering aperiodic CSI reporting is received, and a slot in which the CSI-RS resource is transmitted. For example, aperiodicTriggeringOffset parameter values and offset values X may have mapping relationships as shown in Table 11 below.

TABLE 11

| aperiodicTriggeringOffset | Offset X | |
|---|---|---|
| 0 | 0 | slot |
| 1 | 1 | slot |
| 2 | 2 | slots |
| 3 | 3 | slots |
| 4 | 4 | slots |
| 5 | 16 | slots |
| 6 | 24 | slots |

Example 600 of FIG. illustrates when the offset value X is configured to be 0 (X=0). In this case, the UE may receive the CSI-RS 602 in a slot (corresponding to slot 0 606 of FIG. 6) in which DCI format 0_1 triggering aperiodic CSI reporting is received, and may report CSI information, which is measured based on the received CSI-RS, to the BS via the PUSCH 605. The UE may acquire, from DCI format 0_1, scheduling information (information corresponding to each field of DCI format 0_1 described above) on the PUSCH 605 for CSI reporting. For example, in DCI format 0_1, the UE may acquire information on a slot in which the PUSCH 605 is to be transmitted, from time domain resource allocation information for the PUSCH 605 described above. In example 600 of FIG. 6, the UE acquires 3 as a K2 value corresponding to a slot offset value for PDCCH-to-PUSCH, and accordingly, the PUSCH 605 may be transmitted in slot 3 609, which is spaced 3 slots apart from slot 0 606, i.e., a time point at which the PDCCH 601 has been received.

In example 610 of FIG. 6, the UE may acquire DCI format 0_1 by monitoring a PDCCH 611, and may acquire scheduling information and CSI request information for a PUSCH 615 therefrom. The UE may acquire resource information of a CSI-RS 612 to be measured, from a received CSI request indicator. Example 610 of FIG. 6 shows an example in which the offset value X for CSI-RS described above is configured to be 1 (X=1). In this case, the UE may receive the CSI-RS 612 in a slot (corresponding to slot 0 616 of FIG. 6) in which DCI format 0_1 triggering aperiodic CSI reporting is received, and may report CSI information, which is measured based on the received CSI-RS, to the BS via the PUSCH 615.

The aperiodic CSI report may include at least one of or both CSI part 1 and CSI part 2, and if the aperiodic CSI report is transmitted via the PUSCH, the aperiodic CSI report may be multiplexed on a transport block. After a CRC is inserted into an input bit of aperiodic CSI for multiplexing, encoding and rate matching may be performed, and then transmission may be performed by mapping to resource elements within the PUSCH in a specific pattern. The CRC insertion may be omitted depending on a coding method or a length of the input bit. The number of modulation symbols, which is calculated for rate matching during multiplexing of CSI part 1 or CSI part 2 included in the aperiodic CSI report, may be calculated as shown in Table 12 below.

TABLE 12
For CSI part 1 transmission on PUSCH not using repetition type B with UL-SCH,
the number of coded modulation symbols per layer for CSI part 1 transmission,
denoted as ${Q}_{CSI - part 1}^{′} ,$
is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH - 1}} {K}_{r}} ⌉ , ⌈ α \cdot$
${\sum }_{l = 0}^{{N}_{symb , all}^{PUSCH} - 1} {M}_{sc}^{UCI} ( l ) ⌉ - {Q}_{ACK / CG - UCI}^{′} \}$
. . .
For CSI part 1 transmission on an actual repetition of a PUSCH with repetition
Type B with UL-SCH, the number of coded modulation symbols per layer for CSI
part 1 transmission, denoted as ${Q}_{CSI - part 1}^{′} ,$
is determined as follows:
${Q}_{CSI - 1}^{′} = min \{ ⌈ \frac{( {O}_{CSI - 1} + {L}_{CSI - 1} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α$
${\cdot {\sum }_{l = 0}}^{{N}_{symb , nominal}^{PUSCH} - 1} {M}_{sc , nominal}^{UCI} ( l ) ⌉ - {Q}_{ACK / CG - UCI}^{′} ,$
${{\sum }_{l = 0}}^{{N}_{symb , actual}^{PUSCH} - 1} {M}_{sc , actual}^{UCI} ( l ) - {Q}_{ACK / CG - UCI}^{′} \}$
. . .
For CSI part 1 transmission on PUSCH without UL-SCH, the number of coded
modulation symbols per layer for CSI part 1 transmission, denoted as ${Q}_{CSI - part 1}^{′} ,$
is determined as follows:
if there is CSI part 2 to be transmitted on the PUSCH,
${Q}_{CSI - 1}^{′} = min \{ ⌈ \frac{( {O}_{CSI - 1} + {L}_{CSI - 1} ) \cdot {β}_{offset}^{PUSCH}}{R \cdot {Q}_{m}} ⌉ , {\sum }_{l = 0}^{{N}_{symb , all}^{PUSCH} - 1} {M}_{sc}^{UCI} ( l ) - {Q}_{ACK}^{′} \}$
else
${Q}_{CSI - 1}^{′} = {\sum }_{l = 0}^{{N}_{symb , all}^{PUSCH} - 1} {M}_{s c}^{UCI} ( l ) - {Q}_{ACK}^{′}$
end if
. . .
For CSI part 2 transmission on PUSCH not using repetition type B with UL-SCH,
the number of coded modulation symbols per layer for CSI part 2 transmission,
denoted as ${Q}_{CSI - part 1}^{′} ,$
is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , all}^{PUSCH} - 1} {M}_{sc}^{UCI} ( l )}{{\sum }_{r = 0}^{{C}_{UL - SCH} - 1} {K}_{r}} ⌉ , ⌈ α \cdot$
${\sum }_{l = 0}^{{N}_{symb , all}^{PUSCH} - 1} {M}_{sc}^{UCI} ( l ) ⌉ - {Q}_{ACK / CG - UCI}^{′} - {Q}_{CSI - 1}^{′} \}$
For CSI part 2 transmission on an actual repetition of a PUSCH with repetition
Type B with UL-SCH, the number of coded modulation symbols per layer for CSI
part 2 transmission, denoted as ${Q}_{CSI - part 2}^{′} ,$
is determined as follows:
${Q}_{CSI - 2}^{′} = min \{ ⌈ \frac{( {O}_{CSI - 2} + {L}_{CSI - 2} ) \cdot {β}_{offset}^{PUSCH} \cdot {\sum }_{l = 0}^{{N}_{symb , nominal}^{PUSCH} - 1} {M}_{sc , nominal}^{UCI} ( l )}{{\sum }_{r = 0}^{{C}_{UL - SCH} - 1} {K}_{r}} ⌉ , ⌈ α$
$\cdot {\sum }_{l = 0}^{{N}_{symb , nominal}^{PUSCH} - 1} {M}_{s c , nominal}^{UCI} ( l ) ⌉ - {Q}_{ACK / CG - UCI}^{′} - {Q}_{CSI - 1}^{′} ,$
${{\sum }_{l = 0}}^{{N}_{symb , actual}^{PUSCH} - 1} {M}_{sc , actual}^{UCI} ( l ) - {Q}_{ACK / CG - UCI}^{′} - {Q}_{CSI - 1}^{′} \}$
. . .
For CSI part 2 transmission on PUSCH without UL-SCH, the number of coded
modulation symbols per layer for CSI part 2 transmission, denoted as ${Q}_{CSI - part 2}^{′} ,$
is determined as follows:
${Q}_{CSI - 2}^{′} = {\sum }_{l = 0}^{{N}_{symb , all}^{PUSCH} - 1} {M}_{s c}^{UCI} ( l ) - {Q}_{ACK}^{′} - {Q}_{CSI - 1}^{′}$

For PUSCH repetition type A and B transmissions, the UE may multiplex the aperiodic CSI report only on the first repetition transmission among repetition PUSCH transmissions. This is because aperiodic CSI report information to be multiplexed is encoded in a polar code scheme, and in this case, each PUSCH repetition needs to have the same frequency and time resource allocation to multiplex the aperiodic CSI report information on multiple PUSCH repetitions. Particularly, in PUSCH repetition type B transmission, since each actual repetition may have different OFDM symbol durations, the aperiodic CSI report may be multiplexed only on the first repetition and then transmitted.

For PUSCH repetition type B transmission, when the UE receives DCI for activation of semi-persistent CSI reporting or scheduling of aperiodic CSI reporting without scheduling for a transport block, the UE may assume that a value of nominal repetition is 1 even if the number of PUSCH repetition transmissions, which is configured via higher-layer signaling, is greater than 1. If the aperiodic or semi-persistent CSI reporting is scheduled or activated without scheduling for a transport block, based on PUSCH repetition type B transmission, the UE may expect that a first nominal repetition is identical to the first actual repetition. With regard to the PUSCH transmitted while including semi-persistent CSI, based on repeated PUSCH transmission scheme B, without scheduling for DCI after the semi-persistent CSI reporting has been activated via the DCI, if the first nominal repetition is different from the first actual repetition, transmission for the first nominal repetition may be disregarded.

### CSI Computation Time

When the BS indicates aperiodic CSI report or semi-persistent CSI report to the UE through DCI, the UE may identify whether it is possible to perform a valid channel report through the indicated CSI report, by considering the CSI computation time necessary for the CSI report. With regard to an aperiodic CSI report or a semi-persistent CSI report indicated through DCI, the UE may perform a valid CSI report from a UL symbol after Z symbols after the last symbol included in a PDCCH including DCI indicating a CSI report, and the above-described Z symbol may vary according to a numerology of a DL BWP corresponding to a PDCCH including DCI indicating a CSI report, a numerology of a UL BWP corresponding to a PUSCH for transmitting a CSI report, the type or characteristics (report quantity, frequency domain granularity, port number of a reference signal, codebook type, etc.) of channel information reported in the CSI report. In other words, to be determined as a valid CSI report for the corresponding CSI report to be a valid CSI report, the UL transmission of the corresponding CSI report should not be performed before the Z_{ref} symbol, including timing advance.

In this case, the Z_{ref} symbol is a UL symbol in which a CP is started after a time T_{proc,CSI}=(Z)(2048+144)·κ2^{-μ}·T_{C} from the moment when the last symbol of the triggering PDCCH is completed. The detailed value of Z follows the description below, T_{c}=1/(Δfₘₐₓ·N_{f}), Δfₘₐₓ=480·10³ Hz, N_{f}=4096, κ=64, and μ is a numerology. The value of μ may be agreed to be used as one that causes the highest T_{proc,CSI} value among (μ_{PDCCH}, μ_{CSI-RS}, μ_{UL}), and μ_{PDCCH} may indicate a subcarrier spacing used for PDCCH transmission, μ_{CSI-RS} may indicate a subcarrier spacing used for CSI-RS transmission, and μ_{UL} may indicate a subcarrier spacing of a UL channel used for UCI transmission for CSI reporting. In another example, μ may be agreed to be used as one that causes the highest T_{proc,CSI} value among (μ_{PDCCH}, μ_{UL}). The definitions of μ_{PDCCH} and μ_{UL} are given in the above description. For the sake of convenience in the following description, the above condition is referred to as satisfying CSI reporting condition 1.

In addition, when the reference signal for channel measurement for the aperiodic CSI report indicated for the UE through DCI is an aperiodic reference signal, a valid CSI report may be performed from the UL symbol after Z′ symbol after the last symbol including the reference signal. The Z′ symbol described above may vary depending on the numerology of the DL BWP corresponding to the PDCCH including DCI for indicating the CSI report, the numerology of the bandwidth corresponding to the reference signal for channel measurement for the CSI report, the numerology of the UL BWP corresponding to the PUSCH for transmitting the CSI report, and the type or characteristics (report quantity, frequency band granularity, port number of the reference signal, codebook type, and the like) of the channel information reported in the CSI report. In other words, in order for a CSI report to be determined to be a valid CSI report (in order for the CSI report to be a valid CSI report), the UL transmission of the CSI report should not be performed before the Z_{ref}′ symbol, including a timing advance. In this case, the Z_{ref}′ symbol is a UL symbol in which a CP starts after a time

$${T}_{p r o c , CSI}^{′} = ( {Z}^{′} ) ( 2048 + 144 ) \cdot {κ2}^{- μ} \cdot {T}_{C}$$

has elapsed from a moment at which the last symbol of the aperiodic CSI-RS or aperiodic CSI-IM triggered by the triggering PDCCH ends. The detailed value of Z′ follows the description below, T_{c}=1/(Δfₘₐₓ·N_{f}), Δfₘₐₓ=480·10³ Hz, N_{f}=4096, κ=64, and μ denotes a numerology. At this time, μ may be agreed to be used as one that causes the highest T_{proc,CSI} value among (μ_{PDCCH}, μ_{CSI-RS}, μ_{UL}), where μ_{PDCCH} may denote a subcarrier spacing used for triggering PDCCH transmission, μ_{CSI-RS} may denote a subcarrier spacing used for CSI-RS transmission, and Hot may denote a subcarrier spacing of a UL channel used UCI transmission for CSI reporting. As another example, μ may be agreed to be used an one that causes the highest T_{proc,CSI} value among (μ_{PDCCH},μ_{UL}). In this case, the definitions of μ_{PDCCH} and μ_{UL} are as described above. For conciseness, a situation in which the above condition is satisfied is referred to as satisfying CSI reporting condition 2.

When the BS indicates, through DCI, an aperiodic CSI report for an aperiodic reference signal to the UE, the UE may perform a valid CSI report, starting from the first uplink symbol which satisfies both a time point after Z symbols after the end of the last symbol of the PDCCH including DCI indicating the CSI report and a time point after Z′ symbols after the end of the last symbol including the reference signal. That is, in aperiodic CSI reporting based on an aperiodic reference signal, a CSI report is determined to be valid only when both CSI reporting validity conditions 1 and 2 are satisfied.

When the CSI report timing indicated by the BS does not satisfy the CSI computation time requirement, the UE may determine that the corresponding CSI report is invalid and may not consider updating the channel information state for the CSI report.

The Z and Z′ symbols for calculating the CSI computation time described above follow Table 13 and Table 14 below. For example, if the channel information reported in a CSI report includes only wideband information, the number of ports of a reference signal is 4 or less, the reference signal resource is one, and the codebook type is “typeI-SinglePanel” or the type (report quantity) of the reported channel information is “cri-RI-CQI”, Z and Z′ symbols follow the values of

$${Z}_{1} , {Z}_{1}^{′}$$

in Table 14 below, which is referred to as delay requirement 2.

When a PUSCH including a CSI report does not include a TB or HARQ-ACK and CPU occupation of a UE is 0, Z and Z′ symbols follow the values of

$${Z}_{1} , {Z}_{1}^{′}$$

in Table 13, and this will be referred to as delay requirement 1. The above description regarding CPU occupation is described in more detail below. In addition, when the report quantity is “cri-RSRP” or “ssb-Index-RSRP”, the Z, Z′ symbols follow the values of

$${Z}_{3} , {Z}_{3}^{′}$$

in Table 14. X1, X2, X3, and X4 in Table 14 refer to the UE capability regarding beam reporting time, and KB1 and KB2 in Table 14 refer to the UE capability regarding beam change time. When the Z and Z′ symbols do not correspond to the type or characteristic of channel information reported in the above-described CSI report, the Z and Z′ symbols follow the values of

$$Z \text{?} , Z \text{?}$$

$$\text{?} \text{indicates text missing or illegible when filed}$$

in Table 14 below.

TABLE 13

| | Z₁ [symbols] | |
|---|---|---|
| μ | Z₁ | ${Z}_{1}^{′}$ |
| 0 | 10 | 8 |
| 1 | 13 | 11 |
| 2 | 25 | 21 |
| 3 | 43 | 36 |

TABLE 14

| | Z₁ [symbols] | | Z₂ [symbols] | | Z₃ [symbols] | |
|---|---|---|---|---|---|---|
| μ | Z₁ | ${Z}_{1}^{′}$ | Z₂ | ${Z}_{2}^{′}$ | Z₃ | Z₃′ |
| 0 | 22 | 16 | 40 | 37 | 22 | X₁ |
| 1 | 33 | 30 | 72 | 69 | 33 | X₂ |
| 2 | 44 | 42 | 141 | 140 | min (44, X₃ + KB₁) | X₃ |
| 3 | 97 | 85 | 152 | 140 | min (97, X₄ + KB₂) | X₄ |

### CSI Reference Resource

When the BS indicates aperiodic/semi-persistent/periodic CSI report to the UE, a CSI reference resource may be configured to determine a reference time and frequency for the channel to be reported in the CSI report. The frequency of the CSI reference resource may correspond to carrier and subband information for measuring CSI as indicated in a CSI report configuration, and may respectively correspond to carrier and reportFreqConfiguration within higher-layer signaling, i.e., within CSI-ReportConfig. The time of the CSI reference resource may be defined with reference to the time at which a CSI report is transmitted. For example, when CSI report #X is indicated to be transmitted in the UL slot n′ of the carrier and BWP in which a CSI report is to be transmitted, the time of a CSI reference resource of CSI report #X may be defined as the DL slot n-nCSI-ref of the carrier and BWP in which CSI is to be measured. When the numerology of the carrier and BWP for measuring CSI is named μDL, and the numerology of the carrier and BWP for transmitting CSI report #X is named μUL, DL slot n is calculated as n=└n′·2^{μ}^{_{DL}}/2^{μ}^{_{UL}}┘.

When CSI report #X transmitted in UL slot n′ is a semi-persistent or periodic CSI report, the slot interval nCSI-ref between DL slot n and the CSI reference signal follows μ_{CSI-ref}=4·2^{μ}^{_{UL}} if a single CSI-RS/SSB resource is associated with the corresponding CSI report, and follows n_{CSI-ref}=5·2^{μ}^{_{DL}} if a multiple CSI-RS/SSB resources are associated with the corresponding CSI report, according to the number of CSI-RS/SSB resources for channel measurement. When CSI report #X transmitted in UL slot n′ is an aperiodic CSI report, this report is calculated as

$${n}_{CSI - ref} = ⌊ {Z}^{′} / {N}_{symb}^{slot} ⌋$$

by considering CSI computation time Z′ for channel measurement. The above-described

$$N \text{?}$$

$$\text{?} \text{indicates text missing or illegible when filed}$$

is the number or symbols included in one slot, and in NR,

$$N \text{?} = 14$$

$$\text{?} \text{indicates text missing or illegible when filed}$$

is assumed.

When the BS indicates, through higher layer signaling or DCI, to the UE to transmit a certain CSI report in UL slot n′, the UE may perform channel measurement or interference measurement with regard to a CSI-RS resource, a CSI-IM resource, or an SSB resource that is associated with the corresponding CSI report and that is transmitted no later than the CSI reference resource slot of the CSI report transmitted in UL slot n′, and may then report the CSI. The CSI-RS resource, CSI-IM resource, or SSB resource associated with the corresponding CSI report may refer to a CSI-RS resource, a CSI-IM resource, or an SSB resource included in a resource set configured in a resource setting referenced by a report setting for the CSI report of the UE configured through higher layer signaling, or to a CSI-RS resource, a CSI-IM resource, or SSB resource referenced by a CSI report trigger state including parameters for the CSI report, or indicated by an ID of an RS set.

Herein, a CSI-RS/CSI-IM/SSB occasion refers to a transmission time of CSI-RS/CSI-IM/SSB resources determined by higher layer configuration or a combination of higher layer configuration and DCI triggering. For example, in semi-persistent or periodic CSI-RS resources, a slot in which the resources are transmitted is determined according to a slot period and a slot offset configured by higher layer signaling, and the transmission symbol (or symbols) within the slot are determined according to resource mapping information (resourceMapping). As another example, in aperiodic CSI-RS resources, a slot in which the resources are transmitted is determined according to a slot offset with respect to a PDCCH including DCI that indicates a channel report configured by higher layer signaling, and a transmission symbol (or symbols) within the slot are determined according to the resource mapping information (resourceMapping).

The above-described CSI-RS occasion may be determined by independently considering the transmission time point of each CSI-RS resource, or by comprehensively considering the transmission time points of one or more CSI-RS resources included in a resource set, and thus, two interpretations of the CSI-RS occasion according to each resource set configuration may be possible as follows.

Interpretation 1-1: The time interval from the start time of the earliest symbol in which a particular resource among one or more CSI-RS resources included in the resource set(s) configured in the resource setting reference by the report setting configured for the CSI report refers is transmitted, to the end time of the latest symbol

Interpretation 1-2: The time interval from the start time of the earliest symbol in which the earliest-transmitted CSI-RS resource among all CSI-RS resources included in the resource set(s) configured for the resource setting reference by the report setting configured for the CSI report is transmitted, to the end time of the latest symbol in which the latest-transmitted CSI-RS resource is transmitted

Herein, both interpretations regarding the CSI-RS occasion may be applied separately. Although it is possible to consider both of two interpretations with regard to the CSI-IM occasion and the SSB occasion as in the CSI-RS occasion, the principle is similar to the above description, and thus a repeated description will be omitted herein.

A “CSI-RS/CSI-IM/SSB occasion for CSI report #X transmitted in UL slot n” refers to a set of CSI-RS occasions, CSI-IM occasions, and SSB occasions corresponding to CSI-RS resources, CSI-IM resources, and SSB resources included in a resource set configured in a resource setting referenced by a report setting configured for CSI report #X, and transmitted no later than the CSI reference resource of the CSI report #X transmitted in the UL slot n′.

The “latest CSI-RS/CSI-IM/SSB occasion among the CSI-RS/CSI-IM/SSB occasions for CSI report #X for transmission in UL slot n” may be interpreted in two different manners as follows.

Interpretation 2-1: A set of occasions including the latest CSI-RS occasion among CSI-RS occasions for CSI report #X to be transmitted in UL slot n′, the latest CSI-IM occasion among CSI-IM occasions for CSI report #X to be transmitted in UL slot n′, and the latest SSB occasion among SSB occasions for CSI report #0 to be transmitted in UL slot n′

Interpretation 2-2: The latest occasion among the CSI-RS occasion, CSI-IM occasion, and SSB occasion for CSI report #X transmitted in UL slot n′

Both interpretations for the “latest CSI-RS/CSI-IM/SSB occasion among CSI-RS/CSI-IM/SSB occasions for CSI report #X to be transmitted in the UL slot n” may be considered and applied separately. In addition, when the two interpretations (interpretation 1- and interpretation 1-2) mentioned above are considered for the CSI-RS occasion, the CSI-IM occasion, and the SSB occasion, the “latest CSI-RS/CSI-IM/SSB occasion among the CSI-RS/CSI-IM/SSB occasions for CSI report #X transmitted in UL slot n” may be individually applied while considering all of four different interpretations (interpretation 1-1 and interpretation 2-1 are applied, interpretation 1-1 and interpretation 2-2 are applied, interpretation 1-2 and interpretation 2-1 are applied, and interpretation 1-2 and interpretation 2-2 are applied).

The BS may indicate a CSI report in consideration of the amount of channel information that the UE can calculate at the same time for the CSI report, that is, the number of CSI processing units (CPUs) of the UE. When the number of channel information calculation units that can be simultaneously calculated by the UE is referred to as N_{CPU}, the UE may not expect a CSI report indication from the BS requiring more channel information calculation than N_{CPU}, or may not consider the update of channel information requiring more channel information calculation than N_{CPU}. The N_{CPU} may be reported to the BS by the UE through higher layer signaling, or may be configured for the UE by the BS through higher layer signaling.

It is assumed that the CSI report indicated by the BS to the UE occupies a part or all of the CPU for channel information calculation, among the total number N_{CPU} of channel information that the UE can calculate simultaneously. For each CSI report, the number of channel information calculation units required for a CSI report a (n=0.1, . . . , N−1) may be referred to as

$${O}_{CPU}^{( n )} .$$

Thus, the total number of channel information calculation units required for a total of N CSI reports may be referred to as

$${\sum }_{n = 0}^{N - 1} {O}_{CPU}^{( n )} .$$

The channel information calculation unit required for each reportQuantity configured in a CSI report may be configured as in Table 15 below.

TABLE 15
$- {O}_{CPU}^{( n )} = 0 : When the reportQuantity configured for the CSI report is set to ‘ none ’ ,$
and trs-Info is configured in the CSI-RS resource set associated with the CSI report.
${O}_{CPU}^{( n )} = 1 : When the reportQuantity configured for the CSI report is set to ‘ none ’ ,$
‘cri-RSRP’, or ‘ssb-Index-RSRP’, and trs-Info is not configured in the CSI-RS resource
set associated with the CSI report.
When the reportQuantity configured for the CSI report is set to ‘cri-RI-PMI-CQI’, ‘cri-
RI-i1’, ‘cri-RI-i1-CQI’, ‘cri-RI-CQI’, or ‘cri-RI-LI-PMI-CQI’
$≫ {O}_{CPU}^{( n )} = {N}_{CPU} : When an aperiodic CSI report is triggered and the corresponding$
CSI report is not multiplexed with either or both of a TB and HARQ-ACK. The
corresponding CSI report is a wideband CSI report, corresponds to up to four CSI-RS
ports, and corresponds to a single resource without a CRI report. In this case, the
codebookType corresponds to ‘typeI-SinglePanel’ or the reportQuantity corresponds to
‘cri-RI-CQI’.
(This case corresponds to the latency requirement condition 1 described above, in
which the UE may report CSI quickly by utilizing all available CPU resources.)
$≫ {O}_{CPU}^{( n )} = {K}_{s} : In all other cases except for the above , {K}_{s} represents the number of$
CSI-RS resources within the CSI-RS resource set for channel measurement.

When, at a particular time, the number of channel information calculations required for multiple CSI reports exceeds the number N_{CPU} of channel information calculation units that the UE can simultaneously calculate, the UE may not consider the channel information update for some CSI reports. Among multiple indicated CSI reports, a CSI report for which channel information update is not considered may be determined at least based on the time during which the channel information calculation required for the CSI report occupies the CPU and the priority of the channel information to be reported. The UE may not consider updating channel information for the CSI report whose channel information calculation starts at the latest time among the CSI reports, and may preferentially not consider updating channel information for a CSI report having a lower priority of channel information.

The priority of the channel information may be determined with reference to Table 16 below.

TABLE 16
CSI Priority Value Pri_{CSI}(y, k, c, s) = 2 · N_{cells} · Mₛ · y + N_{cells} · Mₛ . k +
Mₛ · c + s,
y = 0: When the CSI report is an aperiodic CSI report transmitted through PUSCH,
y = 1: When the CSI report is a semi-persistent CSI report transmitted through
PUSCH, y = 2: When the CSI report is a semi-persistent CSI report transmitted
through PUCCH, y = 3: When the CSI report is a periodic CSI report transmitted
through PUCCH;
k = 0: When the CSI report includes L1-RSRP, k = 1: When the CSI report does not
include L1-RSRP;
c: Serving cell index, N₍cells₎: Maximum number of serving cells configured by
higher-layer signaling (maxNrofServingCells);
s: CSI report configuration index (reportConfigID), Mₛ: Maximum number of CSI
report configurations configured by higher-layer signaling (maxNrofCSI-
ReportConfigurations).

The CSI priority for a CSI report is determined through the priority value Pri_{iCSI}(y,k,c,s) in Table 16. Referring to Table 16 above, the CSI priority value is determined through a type of channel information included in a CSI report, a time domain reporting characteristic (aperiodic, semi-persistent, periodic) of the CSI report, a channel (PUSCH, PUCCH) to which the CSI report is transmitted, a serving cell index, and a CSI report configuration index. The CSI priority for a CSI report is determined by comparing CSI priority values Pri_{iCSI} (y, k, c, s), and a CSI report having a smaller CSI priority value is considered to have a higher CSI priority.

When the time required for the BS to calculate the channel information for a CSI report indicated to the UE is referred to as a CPU occupation time, the CPU occupation time may be determined by considering a type (report quantity) of channel information included in the CSI report, a time domain characteristic (aperiodic, semi-persistent, or periodic) of the CSI report, a slot or symbol occupied by higher layer signaling or DCI for indicating the CSI report, and at least a part or the entirety of a slot or symbol occupied by a reference signal for channel state measurement.

### PDCCH: Regarding DCI

In a 5G system, scheduling information regarding PUSCH or PDSCH) is included in DCI and transferred from a BS to a UE through the DCI. The UE may monitor, with regard to the PUSCH or PDSCH, a fallback DCI format and a non-fallback DCI format. The fallback DCI format may include a fixed field predefined between the BS and the UE, and the non-fallback DCI format may include a configurable field.

The DCI may be subjected to channel coding and modulation processes and then transmitted through a PDCCH after a channel coding and modulation process. A cyclic redundancy check (CRC) may be attached to the payload of a DCI message, and the CRC may be scrambled by a radio network temporary identifier (RNTI) corresponding to the identity of the UE. Different RNTIs may be used according to the purpose of the DCI message, for example, UE-specific data transmission, power control command, or random access response. That is, the RNTI may not be explicitly transmitted, but may be transmitted while being included in a CRC calculation process. Upon receiving a DCI message transmitted through the PDCCH, the UE may identify the CRC by using the allocated RNTI, and if the CRC identification result is right, the UE may know that the corresponding message has been transmitted to the UE.

For example, DCI for scheduling a PDSCH regarding system information (SI) may be scrambled by an SI-RNTI. DCI for scheduling a PDSCH regarding a random access response (RAR) message may be scrambled by an RA-RNTI. DCI for scheduling a PDSCH regarding a paging message may be scrambled by a P-RNTI. DCI for notifying of a slot format indicator (SFI) may be scrambled by an SFI-RNTI. DCI for notifying of transmit power control (TPC) may be scrambled by a TPC-RNTI. DCI for scheduling a UE-specific PDSCH or PUSCH may be scrambled by a cell RNTI (C-RNTI).

DCI format 0_0 may be used as fallback DCI for scheduling a PUSCH. In this case, the CRC may be scrambled by a C-RNTI. DCI format 0_0 in which the CRC is scrambled by a C-RNTI may include the following pieces of information given in Table 17 below.

```
TABLE 17
  Identifier for DCI formats - [1] bit
  $- Frequency domain resource assignment - [ ⌈ {log}_{2} ( {N}_{RB}^{UL , BWP} ( {N}_{RB}^{UL , BWP} +$
1)/2)]┐ ] bits
  Time domain resource assignment - X bits
  Frequency hopping flag - 1 bit.
  Modulation and coding scheme - 5 bits
  New data indicator - 1 bit
  Redundancy version - 2 bits
  HARQ process number - 4 bits
  Transmit power control (TPC) command for scheduled PUSCH - [2]
  bits
  Uplink/supplementary uplink (UL/SUL) indicator - 0 or 1 bit
```

DCI format 0_1 may be used as non-fallback DCI for scheduling a PUSCH, and in this case, the CRC may be scrambled by a C-RNTI. DCI format 0_1 in which the CRC is scrambled by a C-RNTI may include the following pieces of information given in Table 18 below.

```
TABLE 18
Carrier indicator - 0 or 3 bits
UL/SUL indicator - 0 or 1 bit
Identifier for DCI formats - [1] bits
BWP indicator - 0, 1 or 2 bits
Frequency domain resource assignment
$∘ For resource allocation type 0 , ⌈ {N}_{RB}^{UL , BWP} / P ⌉ bits$
$∘ For resource allocation type 1 , ⌈ {log}_{2} ( {N}_{RB}^{UL , BWP} ( {N}_{RB}^{UL , BWP} + 1 ) / 2 ⌉$
    bits
  Time domain resource assignment -1, 2, 3, or 4 bits
  Virtual resource block (VRB)-to- PRB mapping - 0 or 1 bit, only for
resource allocation type 1.
    0 bit if only resource allocation type 0 is configured;
    1 bit otherwise.
  Frequency hopping flag - 0 or 1 bit, only for resource allocation type 1.
    0 bit if only resource allocation type 0 is configured;
    1 bit otherwise.
  Modulation and coding scheme - 5 bits
  New data indicator - 1 bit
  Redundancy version - 2 bits
  HARQ process number - 4 bits
  1st DL assignment index- 1 or 2 bits
    1 bit for semi-static HARQ-ACK codebook;
    2 bits for dynamic HARQ-ACK codebook with single HARQ-ACK
    codebook.
  2nd DL assignment index - 0 or 2 bits
    2 bits for dynamic HARQ-ACK codebook with two HARQ-ACK sub-
    codebooks;
    0 bit otherwise.
  TPC command for scheduled PUSCH - 2 bits
    $- SRS resource indicator - ⌈ {log}_{2} ( {\sum }_{k = 1}^{{L}_{m ax} \sum } ( \begin{matrix}{N}_{SRS} \\ k\end{matrix} ) ) ⌉ or ⌈ {log}_{2} ( {N}_{SRS} ) ⌉ bits$
    $∘ ⌈ {log}_{2} ( {\sum }_{k = 1}^{{L}_{m ax} \sum } ( \begin{matrix}{N}_{SRS} \\ k\end{matrix} ) ) ⌉ bits for non - codebook based PUSCH$
    transmission;
    ┌log₂(N_{SRS})┐ bits for codebook based PUSCH transmission.
  Precoding information and number of layers - up to 6 bits
  Antenna ports - up to 5 bits
  SRS request - 2 bits
  CSI request - 0, 1, 2, 3, 4, 5, or 6 bits
  Code block group (CBG) transmission information - 0, 2, 4, 6, or 8 bits
  Phase tracking reference signal (PTRS)-demodulation reference signal
(DDMRS) association - 0 or 2 bits.
  beta offset indicator - 0 or 2 bits
  DMRS sequence initialization - 0 or 1 bit
```

DCI format 1_0 may be used as fallback DCI for scheduling a PDSCH, and in this case, the CRC may be scrambled by a C-RNTI. DCI format 1_0 in which the CRC is scrambled by a C-RNTI may include the following pieces of information given in Table 19 below.

```
TABLE 19
  Identifier for DCI formats - [1] bit
$- Frequency domain resource assignment - [ ⌈ {log}_{2} ( {N}_{RB}^{DL , BWP} ( {N}_{RB}^{DL , BWP} +$
1)/2)┐ ] bits
  Time domain resource assignment - X bits
  VRB-to-PRB mapping - 1 bit.
  Modulation and coding scheme - 5 bits
  New data indicator - 1 bit
  Redundancy version - 2 bits
  HARQ process number - 4 bits
  DL assignment index - 2 bits
  TPC command for scheduled PUCCH - [2] bits
  PUCCH resource indicator - 3 bits
  PDSCH-to-HARQ feedback timing indicator - [3] bits
```

DCI format 1_1 may be used as non-fallback DCI for scheduling a PDSCH, and in this case, the CRC may be scrambled by a C-RNTI. DCI format 1_1 in which the CRC is scrambled by a C-RNTI may include the following pieces of information given in Table 20 below.

```
TABLE 20
  Carrier indicator - 0 or 3 bits
  Identifier for DCI formats - [1] bits
  BWP indicator - 0, 1 or 2 bits
  Frequency domain resource assignment
    $∘ For resource allocation type 0 , ⌈ {N}_{RB}^{DL , BWP} / P ⌉ bits$
    $∘ For resource allocation type 1 , ⌈ {log}_{2} ( {N}_{RB}^{DL , BWP} ( {N}_{RB}^{DL , BWP} + 1 ) / 2 ⌉$
    bits
  Time domain resource assignment -1, 2, 3, or 4 bits
  VRB-to-PRB mapping - 0 or 1 bit, only for resource allocation type 1.
    0 bit if only resource allocation type 0 is configured;
    1 bit otherwise.
  PRB bundling size indicator - 0 or 1 bit
  Rate matching indicator - 0, 1, or 2 bits
  Zero power (ZP) CSI- RS trigger - 0, 1, or 2 bits
For transport block 1:
  Modulation and coding scheme - 5 bits
  New data indicator - 1 bit
  Redundancy version - 2 bits
For transport block 2:
  Modulation and coding scheme - 5 bits
  New data indicator - 1 bit
  Redundancy version - 2 bits
  HARQ process number - 4 bits
  DL assignment index - 0 or 2 or 4 bits
  TPC command for scheduled PUCCH - 2 bits
  PUCCH resource indicator - 3 bits
  PDSCH-to-HARQ_feedback timing indicator - 3 bits
  Antenna ports - 4, 5 or 6 bits
  Transmission configuration indication - 0 or 3 bits
  SRS request - 2 bits
  CBG transmission information - 0, 2, 4, 6, or 8 bits
  CBG flushing out information - 0 or 1 bit
  DMRS sequence initialization - 1 bit
```

### PDCCH: CORESET, Resource Element Group (REG), Control Channel Element (CCE), and Search Space

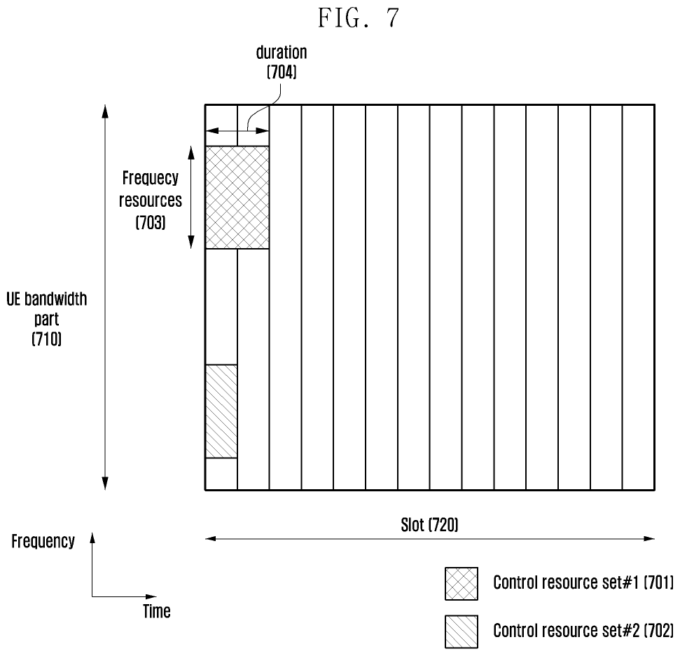

FIG. 7 illustrates a CORESET used to transmit a DL control channel in a 5G wireless communication system according to an embodiment.

Referring to FIG. 7, an example ius provided in which a UE BWP 710 is configured along the frequency axis, and two CORESETs (CORESET #1 720 and CORESET #2 701) are configured within one slot 702 along the time axis. The CORESETs 701 and 702 may be configured in a specific frequency resource 703 within the entire UE BWP 710 along the frequency axis. The CORESETs 701 and 702 may be each configured as one or multiple OFDM symbols along the time domain, and the number of the OFDM symbols may be defined as a CORESET duration 704. In FIG. 7, CORESET #1 701 is configured to have a CORESET duration corresponding to two symbols, and CORESET #2 702 is configured to have a CORESET duration corresponding to one symbol.

A CORESET in the 5G system described above may be configured for a UE by a BS through upper layer signaling (e.g., SIB, MIB, or RRC signaling). The description that a CORESET is configured for a UE means that information such as a CORESET identity, the CORESET's frequency location, and the CORESET's symbol duration is provided. This information may include the following pieces of information given in Table 21 below.

TABLE 21

| | |
|---|---|
| ControlResourceSet ::= | SEQUENCE { |

-- Corresponds to L1 parameter ‘CORESET-ID’

| | |
|---|---|
| controlResourceSetId | ControlResourceSetId, |

(CORESET identity)

| | |
|---|---|
| frequencyDomainResources | BIT STRING (SIZE (45)), |

(frequency domain resource assignment information)

| | |
|---|---|
| duration | INTEGER (1..maxCoReSetDuration), |

(time domain resource assignment information)

| | |
|---|---|
| cce-REG-MappingType | CHOICE { |

(CCE-to-REG mapping type)

| | |
|---|---|
| interleaved | SEQUENCE { |
| reg-BundleSize | ENUMERATED {n2, n3, n6}, |

(REG bundle size)

| | |
|---|---|
| precoderGranularity | ENUMERATED {sameAsREG- |

bundle, allContiguousRBs},

| | |
|---|---|
| interleaverSize | ENUMERATED {n2, n3, n6} |

```
                (interleaver size)
                shiftIndex
    INTEGER(0..maxNrofPhysicalResourceBlocks-1)
    OPTIONAL
            (interleaver shift)
            },
```

| | |
|---|---|
| nonInterleaved | NULL |

},

| | |
|---|---|
| tci-StatesPDCCH | SEQUENCE(SIZE (1..maxNrofTCI- |
| StatesPDCCH)) OF TCI-StateId | OPTIONAL, |

(QCL configuration information)

| | |
|---|---|
| tci-PresentInDCI | ENUMERATED {enabled} |
| | OPTIONAL, ... Need S |

}

In Table 21, tci-StatesPDCCH (simply referred to as TCI state) configuration information may include information of one or multiple SS/PBCH block indexes or CSI-RS indexes, which are quasi-co-located (QCLed) with a DMRS transmitted in a corresponding CORESET.

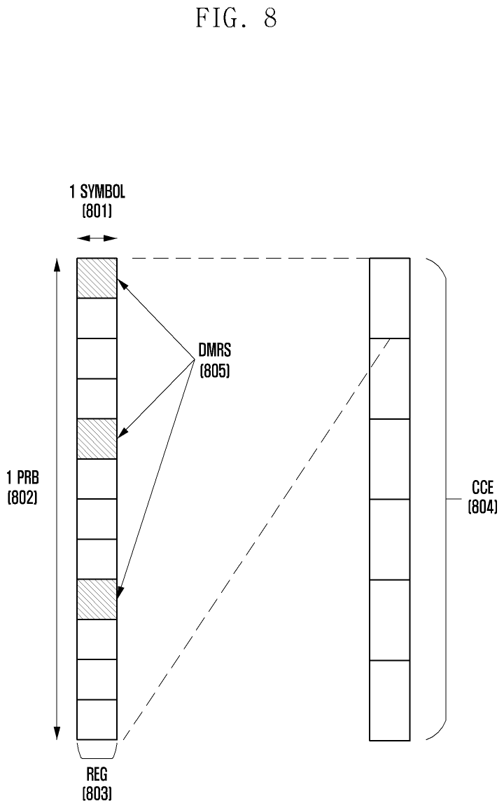

FIG. 8 illustrates a basic unit of time and frequency resources constituting a DL control channel available in a 5G system according to an embodiment. Referring to FIG. 8, the basic unit of time and frequency resources constituting a control channel may be referred to as an REG 803, and the REG 803 may be defined by one OFDM symbol 801 along the time axis and one PRB 802, that is, 12 subcarriers, along the frequency axis. The BS may constitute a DL control channel allocation unit by connecting REGs 803.

Provided that the basic unit of DL control channel allocation in 5G is a control channel element 804 as illustrated in FIG. 8, one CCE 804 may include multiple REGs 803. To describe the REG 803 illustrated in FIG. 8, the REG 803 may include 12 REs, and if one CCE 804 includes six REGs 803, one CCE 804 may then include 72 REs. A DL CORESET, once configured, may include multiple CCEs 804, and a specific DL control channel may be mapped to one or multiple CCEs 804 and then transmitted according to the aggregation level (AL) in the CORESET. The CCEs 804 in the CORESET are distinguished by numbers, and the numbers of CCEs 804 may be allocated according to a logical mapping scheme.

The basic unit of the DL control channel illustrated in FIG. 8, that is, the REG 803, may include both REs to which DCI is mapped, and an area to which a demodulation reference signal (DMRS) 805 for decoding the same is mapped. As in FIG. 8, three DRMSs 805 may be transmitted inside one REG 803. The number of CCEs necessary to transmit a PDCCH may be 1, 2, 4, 8, or 16 according to the aggregation level (AL), and different number of CCEs may be used to implement link adaption of the DL control channel. For example, in AL=L, one DL control channel may be transmitted through L CCEs. The UE needs to detect a signal while being no information regarding the DL control channel, and thus a search space indicating a set of CCEs has been defined for blind decoding. The search space is a set of DL control channel candidates including CCEs which the UE needs to attempt to decode at a given AL, and since 1, 2, 4, 8, or 16 CCEs may constitute a bundle at various ALs, the UE may have multiple search spaces. A search space set may be defined as a set of search spaces at all configured aggregation levels.

Search spaces may be classified into common search spaces and UE-specific search spaces. A group of UEs or all UEs may search a common search space of the PDCCH to receive cell-common control information such as dynamic scheduling regarding system information or a paging message. For example, PDSCH scheduling allocation information for transmitting an SIB including a cell operator information may be received by searching the common search space of the PDCCH. In a common search space, a group of UEs or all UEs need to receive the PDCCH, and the common search space may thus be defined as a predetermined set of CCEs. Scheduling allocation information regarding a UE-specific PDSCH or PUSCH may be received by searching the UE-specific search space of the PDCCH. The UE-specific search space may be defined UE-specifically as a function of various system parameters and the identity of the UE.

In 5G, parameters for a search space regarding a PDCCH may be configured for the UE by the BS through upper layer signaling (for example, SIB, MIB, or RRC signaling). The BS may provide the UE with configurations such as the number of PDCCH candidates at each aggregation level L, the monitoring cycle regarding the search space, the monitoring occasion with regard to each symbol in a slot regarding the search space, the search space type (common search space or UE-specific search space), a combination of an RNTI and a DCI format to be monitored in the corresponding search space, a CORESET index for monitoring the search space, and the like. This information may include the following pieces of information: given in Table 22 below.

TABLE 22

| | |
|---|---|
| SearchSpace ::= | SEQUENCE { |

-- Identity of the search space. SearchSpaceId = 0 identifies the SearchSpace configured via
PBCH (MIB) or ServingCellConfigCommon.

| | |
|---|---|
| searchSpaceId | SearchSpaceId, |

(search space identity)

| | |
|---|---|
| controlResourceSetId | ControlResourceSetId, |

(CORESET identity)

| | |
|---|---|
| monitoringSlotPeriodicityAndOffset | CHOICE { |

(monitoring slot level periodicity)

| | |
|---|---|
| sl1 | NULL, |
| sl2 | INTEGER (0..1), |
| sl4 | INTEGER (0..3), |
| sl5 | INTEGER (0..4), |
| sl8 | INTEGER (0..7), |
| sl10 | INTEGER (0..9), |
| sl16 | INTEGER (0..15), |
| sl20 | INTEGER (0..19) |

```
    }
          OPTIONAL,
```

| | |
|---|---|
| duration (monitoring duration) | INTEGER (2..2559) |
| monitoringSymbolsWithinSlot | BIT STRING (SIZE (14)) |

```
          OPTIONAL,
  (monitoring symbols within slot)
```

| | |
|---|---|
| nrofCandidates | SEQUENCE { |

(number of PDCCH candidates for each aggregation level)

| | |
|---|---|
| aggregationLevel1 | ENUMERATED {n0, n1, n2, n3, n4, n5, n6, n8}, |
| aggregationLevel2 | ENUMERATED {n0, n1, n2, n3, n4, n5, n6, n8}, |
| aggregationLevel4 | ENUMERATED {n0, n1, n2, n3, n4, n5, n6, n8}, |
| aggregationLevel8 | ENUMERATED {n0, n1, n2, n3, n4, n5, n6, n8}, |
| aggregationLevel16 | ENUMERATED {n0, n1, n2, n3, n4, n5, n6, n8} |

},

| | |
|---|---|
| searchSpaceType | CHOICE { |

```
    (search space type)
      -- Configures this search space as common search space (CSS) and DCI formats to monitor.
```

| | |
|---|---|
| common | SEQUENCE { |

```
    (common search space)
      }
```

| | |
|---|---|
| ue-Specific | SEQUENCE { |

```
    (UE-specific search space)
        -- Indicates whether the UE monitors in this USS for DCI formats 0-0 and 1-0 or for
formats 0-1 and 1-1.
```

| | |
|---|---|
| formats | ENUMERATED {formats0-0-And-1-0, |

formats0-1-And-1-1},
...
}

According to configuration information, the BS may configure one or multiple search space sets for the UE. The BS may configure search space set 1 and search space set 2 for the UE, may configure DCI format A scrambled by an X-RNTI to be monitored in a common search space in search space set 1, and may configure DCI format B scrambled by a Y-RNTI to be monitored in a UE-specific search space in search space set 2.

According to configuration information, one or multiple search space sets may exist in a common search space or a UE-specific search space. For example, search space set #1 and search space set #2 may be configured as a common search space, and search space set #3 and search space set #4 may be configured as a UE-specific search space.

Combinations of DCI formats and RNTIs given below may be monitored in a common search space. The examples given below are not limiting.
DCI format 0_0/1_0 with CRC scrambled by C-RNTI, CS-RNTI, SP-CSI-RNTI, RA-RNTI, TC-RNTI, P-RNTI, SI-RNTI
DCI format 2_0 with CRC scrambled by SFI-RNTI
DCI format 2_1 with CRC scrambled by INT-RNTI
DCI format 2_2 with CRC scrambled by TPC-PUSCH-RNTI, TPC-PUCCH-RNTI
DCI format 2_3 with CRC scrambled by TPC-SRS-RNTI

Combinations of DCI formats and RNTIs given below may be monitored in a UE-specific search space. The examples given below are not limiting.

DCI format 0_0/1_0 with CRC scrambled by C-RNTI, CS-RNTI, TC-RNTI
DCI format 1_0/1_1 with CRC scrambled by C-RNTI, CS-RNTI, TC-RNTI
Enumerated RNTIs may follow the definition and usage given below.
Cell RNTI (C-RNTI): used to schedule a UE-specific PDSCH
Temporary cell RNTI (TC-RNTI): used to schedule a UE-specific PDSCH
Configured scheduling RNTI (CS-RNTI): used to schedule a semi-statically configured UE-specific PDSCH
Random access RNTI (RA-RNTI): used to schedule a PDSCH in a random access step
Paging RNTI (P-RNTI): used to schedule a PDSCH in which paging is transmitted
System information RNTI (SI-RNTI): used to schedule a PDSCH in which system information is transmitted
Interruption RNTI (INT-RNTI): used to indicate whether a PDSCH is punctured
Transmit power control for PUSCH RNTI (TPC-PUSCH-RNTI): used to indicate a power control command regarding a PUSCH
Transmit power control for PUCCH RNTI (TPC-PUCCH-RNTI): used to indicate a power control command regarding a PUCCH
Transmit power control for SRS RNTI (TPC-SRS-RNTI): used to indicate a power control command regarding an SRS

The DCI formats enumerated above may follow the definitions given in Table 23 below.

TABLE 23

| DCI format | Usage |
|---|---|
| 0_0 | Scheduling of PUSCH in one cell |
| 0_1 | Scheduling of PUSCH in one cell |
| 1_0 | Scheduling of PDSCH in one cell |
| 1_1 | Scheduling of PDSCH in one cell |
| 2_0 | Notifying a group of UEs of the slot format |
| 2_1 | Notifying a group of UEs of the PRB(s) and OFDM |
| | symbol(s) where UE may assume no transmission is |
| | intended for the UE |
| 2_2 | Transmission of TPC commands for PUCCH and PUSCH |
| 2_3 | Transmission of a group of TPC commands for SRS |
| | transmissions by one or more UEs |

In the 5G system, the search space at aggregation level L in connection with CORESET p and search space set s may be expressed by Equation (1) below.

$$\cdot \{ ( {Y}_{p , {n}_{s , f}^{µ}} + ⌊ \frac{{m}_{s , {n}_{CI}} \cdot {N}_{CCE , p}}{L \cdot {M}_{s , max}^{( L )}} ⌋ + {n}_{CI} ) mod ⌊ \frac{{N}_{CCE , p}}{L} ⌋ \} + i \qquad ( 1 )$$

In Equation (1):
L: aggregation level
   n_{CI}: carrier index
      N_{CCE,p}: total number of CCEs existing in CORESET p

$${n}_{s , f}^{µ} :$$

slot index

$${M}_{s , max}^{( L )} :$$

number of PDOCH candidates at aggregation level L
m_{s,n}_{_{CI}}=0, . . . ,

$${M}_{s , max}^{( L )} - 1 :$$

PDCCH canidnate index at aggregation level L
i=0, . . . , L−1

$${Y}_{p , {n}_{s , f}^{µ}} = ( {A}_{p} \cdot {Y}_{p , {n}_{s , f}^{µ} - 1} ) mod D ,$$

Y_{p,-1}=n_{RNTI}≠0, Aₚ=39827 for pmod3=0, Aₚ=39829 for pmod3=1, Aₚ=39839 for pmod3=2, D=65537
n_{RNTI}: UE identity

The

$${Y}_{p , {n}_{s , f}^{µ}}$$

value may correspond to 0 a common search space.

The

$${Y}_{p , {n}_{s , f}^{µ}}$$

value may correspond to a value changed by the UE's identity (C-RNTI or ID configured for the UE by the BS and the time index in a UE-specific search space.

In 5G, multiple search space sets may be configured by different parameters (for example, parameters in Table 22), and the group of search space sets monitored by the UE at each time point may differ accordingly. For example, if search space set #1 is configured at X-slot periodicity, if search space set #2 is configured at Y-slot periodicity, and if X and Y are different, the UE may monitor search space set #1 and search space set #2 both in a specific slot, and may monitor one of search space set #1 and search space set #2 both in another specific slot.

### UE Capability Report

In LTE and NR, a UE may perform a procedure in which, while being connected to a serving BS, the UE may report capability supported by the UE to the corresponding BS. Herein, the above-described procedure will be referred to as a UE capability report.

The BS may transfer a UE capability enquiry message to a UE in a connected state to request a capability report. The message may include a UE capability request with regard to each radio access technology (RAT) type of the BS. The RAT type-specific request may include supported frequency band combination information and the like. In addition, in the UE capability enquiry message, UE capability with regard to multiple RAT types may be requested through one RRC message container transmitted by the BS, or the BS may transfer a UE capability enquiry message including multiple UE capability requests with regard to respective RAT types. That is, a capability enquiry may be repeated multiple times in one message, and the UE may configure a UE capability information message corresponding thereto and report the same multiple times. In next-generation mobile communication systems, a UE capability request may be made regarding multi-RAT dual connectivity (MR-DC), such as NR, LTE, E-UTRA-NR dual connectivity (EN-DC). The UE capability enquiry message may be transmitted initially after the UE is connected to the BS, in general, but may be requested in any condition if needed by the BS.

Upon receiving the UE capability report request from the BS in the above step, the UE configures UE capability according to band information and RAT type requested by the BS. The method in which the UE configures UE capability in an NR system is summarized below.

1. If the UE receives a list regarding LTE and/or NR bands from the BS at a UE capability request, the UE constructs band combinations (BCs) regarding EN-DC and NR standalone (SA). That is, the UE configures a candidate list of BCs regarding EN-DC and NR SA, based on bands received from the BS at a request through FreqBandList. Bands have priority in the order described in FreqBandList.

2. If the BS sets “eutra-nr-only” flag or “eutra” flag and requests a UE capability report, the UE removes everything related to NR SA BCs from the configured BC candidate list. Such an operation may occur only if an LTE BS (eNB) requests “eutra” capability.

3. The UE then removes fallback BCs from the BC candidate list configured in the above step. As used herein, a fallback BC refers to a BC that can be obtained by removing a band corresponding to at least one SCell from a specific BC, and since a BC before removal of the band corresponding to at least one SCell can already cover a fallback BC, the same may be omitted. This step is applied in MR-DC as well, that is, LTE bands are also applied. BCs remaining after the above step constitute the final “candidate BC list”.

4. The UE selects BCs appropriate for the requested RAT type from the final “candidate BC list” and configures BCs to report. In this step, the UE configures supportedBandCombinationList in a determined order. That is, the UE configures BCs and UE capability to report according to a preconfigured rat-Type order. (nr->eutra-nr->eutra). The UE configures featureSetCombination regarding the configured supportedBandCombinationList and configures a list of “candidate feature set combinations” from a candidate BC list from which a list regarding fallback BCs (including capability of the same or lower step) is removed. The “candidate feature set combinations” may include all feature set combinations regarding NR and EUTRA-NR BCs, and may be acquired from feature set combinations of containers of UE-NR-Capabilities and UE-MRDC-Capabilities.

5. If the requested RAT type is eutra-nr and has an influence, featureSetCombinations is included on both containers of UE-MRDC-Capabilities and UE-NR-Capabilities. However, the feature set of NR is included only in UE-NR-Capabilities.

After the UE capability is configured, the UE transfers a UE capability information message including the UE capability to the BS. The BS performs scheduling and transmission/reception management appropriate for the UE, based on the UE capability received from the UE

### First Embodiment: CSI-RS Supporting Scheme Configured with a Number of CSI-RS Ports Greater than 32

Based on Table 7, a maximum of 32 CSI-RS ports may be defined in one CSI-RS resource. When the BS is able to use more than 32 antenna ports (e.g., 48, 64, or 128 antenna ports), and if more than 32 CSI-RS ports which are required to estimate the DL channel between the BS and the UE are defined, the BS and the UE may consider two major methods as follows.

Method 1-1 Support scheme based on a single CSI-RS resource

The UE and the BS may define more than 32 CSI-RS ports, based on a single CSI-RS resource. The BS and the UE may include more than 32 CSI-RS ports, such as 48, 64, 128, or 256, in a single CSI-RS resource, and CSI-RS-ResourceMapping, which is higher layer signaling including an RE mapping scheme, a CDM type, and a resource amount density in the time and frequency resources to support this, may be defined.

When a single CSI-RS resource includes more than 32 CSI-RS ports, fd-CDM2, cdm4-FD2-TD2, or cdm8-FD2-TD4 defined for a 32-port CSI-RS may be used as a CDM type, or in addition to these, cdm16-FD4-TD or cdm32-FD8-TD4, cdm32-FD4-TD8, etc. may be used.

When a single CSI-RS resource includes more than 32 CSI-RS ports, the resource amount density on the frequency resource may be 1 or 0.5, or in addition, 0.25, 0.125, or the like may be used. Values of the resource amount density on the frequency resources of 1, 0.5, 0.25, and 0.125 may respectively indicate that CSI-RS RE mapping is performed for every RB, every two RBs, every four RBs, or every eight RBs.

In a single CSI-RS resource including more than 32 CSI-RS ports, for example, in 256 CSI-RS ports, the number of REs in one RB is 168, so that full RE mapping may be impossible.

### Method 1-2 Support Scheme Based on Multiple CSI-RS Resources

The UE and the BS may support more than 32 CSI-RS ports, based on multiple CSI-RS resources. When the number of CSI-RS ports to be expressed through multiple CSI-RS resources is Pₜₒₜ, the number of CSI-RS ports to be expressed through the i-th CSI-RS resource is Pᵢ, and the number of CSI-RS resources is N, then P₁+ . . . +P_{N}=Pₜₒₜ may be established. In this case, all i-th CSI-RS resources may have the same number of CSI-RS ports. The minimum value of Pᵢ may be 1, 2, 4, 8, 12, 16, 24, or 32. In this case, N, which is the number of CSI-RS resources, may be 2, 3, or 4.

For example, if the UE calculates CSI, based on a total of Pₜₒₜ=48 CSI-RS ports,

The UE may receive configuration of four CSI-RS resources (N=4), each CSI-RS resource having 12 CSI-RS ports (Pᵢ=12), and may calculate CSI by receiving a total of 48 CSI-RS ports. In this case, among the four CSI-RS resources, the CSI-RS resource having the lowest ID may use CSI-RS ports 3000 to 3011 among the 48 ports, the CSI-RS resource having the second lowest ID may use CSI-RS ports 3012 to 3023 among the 48 ports, the CSI-RS resource having the third lowest ID may use CSI-RS ports 3024 to 3035 among the 48 ports, and the CSI-RS resource having the fourth lowest ID may use CSI-RS ports 3036 to 3047 among the 48 ports.

Alternatively, the UE may receive configuration of three CSI-RS resources (N=3), each CSI-RS resource having 16 CSI-RS ports (Pᵢ=16)), and may calculate CSI by receiving a total of 48 CSI-RS ports. In this case, among the three CSI-RS resources, the CSI-RS resource having the lowest CSI-RS resource ID (hereafter, lowest ID) may use CSI-RS ports 3000 to 3015 among 48 ports, the CSI-RS resource having the second lowest ID may use CSI-RS ports 3016 to 3031 among the 48 ports, and the CSI-RS resource having the third lowest ID may use CSI-RS ports 3032 to 3047 among the 48 ports.

Alternatively, the UE may receive configuration of two CSI-RS resources (N=2), each CSI-RS resource having 24 CSI-RS ports (Pᵢ=24), and may calculate CSI by receiving a total of 48 CSI-RS ports. In this case, among the two CSI-RS resources, a CSI-RS resource having a lower ID may use CSI-RS ports 3000 to 3023 among 48 ports, and a CSI-RS resource having a next lower ID may use CSI-RS ports 3024 to 3047 among 48 ports.

In another example, when the UE calculates CSI, based on a total of Pₜₒₜ=64 CSI-RS ports,

The UE may receive configuration of four CSI-RS resources (N=4), each CSI-RS resource having 16 CSI-RS ports (Pᵢ=16), and may calculate CSI by receiving a total of 64 CSI-RS ports. In this case, among the four CSI-RS resources, the CSI-RS resource having the lowest ID may use CSI-RS ports 3000 to 3015 among the 64 ports, the CSI-RS resource having the second lowest ID may use CSI-RS ports 3016 to 3031 among the 64 ports, the CSI-RS resource having the third lowest ID may use CSI-RS ports 3032 to 3047 among the 64 ports, and the CSI-RS resource having the fourth lowest ID may use CSI-RS ports 3048 to 3063 among the 64 ports.

Alternatively, the UE may receive configuration of two CSI-RS resources (N=2), each having 32 CSI-RS ports (Pi=32), and may calculate CSI by receiving a total of 64 CSI-RS ports. In this case, among the two CSI-RS resources, the CSI-RS resource having the lowest ID may use CSI-RS ports 3000 to 3031 among 64 ports, and the CSI-RS resource having the next lowest ID may use CSI-RS ports 3032 to 3063 among 64 ports.

As another example, when a UE calculates CSI, based on a total of Pₜₒₜ=128 CSI-RS ports, the UE may receive configuration of four CSI-RS resources (N=4), each having 32 CSI-RS ports (Pᵢ=32), and may calculate CSI by receiving a total of 128 CSI-RS ports. In this case, among the four CSI-RS resources, the CSI-RS resource having the lowest ID may use CSI-RS ports 3000 to 3031 among 128 ports, the CSI-RS resource having the second lowest ID may use CSI-RS ports 3032 to 3063 among 128 ports, the CSI-RS resource having the third lowest ID may use CSI-RS ports 3064 to 3095 among 128 ports, and the CSI-RS resource having the fourth lowest ID may use CSI-RS ports 3096 to 3127 among 128 ports.

The multiple CSI-RS resources may all be included in the same CSI-RS resource set, or a part of the multiple CSI-RS resources may be included in each of multiple CSI-RS resource sets.

When the UE supports more than 32 Pₜₒₜ CSI-RS ports by using multiple CSI-RS resources, the UE may receive, from the BS, multiple CSI-RS resources configured by higher layer signaling, and the UE may receive, from the BS, the same or different values for some or all of the higher-layer signaling that includes the multiple CSI-RS resources. The UE may receive, from the BS, higher layer signaling for each CSI-RS resource configured within an NZP-CSI-RS-Resource parameter. For each of the higher layer signaling parameters that can be configured within the NZP-CSI-RS-Resource parameter that can be identified in Table 6, the same or different information may be configured for each of the plurality of CSI-RS resources.

nzp-CSI-RS-Resourceld: The UE may expect that different IDs are configured for each of multiple CSI-RS resources.

powerControlOffset: The UE may expect that the same powerControlOffset value is applied to each of multiple CSI-RS resources, and this may indicate that the same RE power ratio is applied between the corresponding multiple CSI-RS resources and a PDSCH.

powerControlOffsetSS: the UE may expect that the same powerControlOffsetSS value is applied to multiple CSI-RS resources, which may mean that the same RE power ratio is applied between the corresponding multiple CSI-RS resources and an SSB.

scramblingId: The UE may expect that the same scramblingId value is used for multiple CSI-RS resources, which may indicate that multiple CSI-RS resources are configured to have the same scrambling ID.

periodicityAndOffset: The UE may expect that multiple CSI-RS resources have the same periodicityAndOffset value, which indicates that, in a periodic CSI-RS or a semi-persistent CSI-RS, all have the same period and slot offset, and may also mean that Pₜₒₜ CSI-RS ports supported through multiple CSI-RS resources are all transmitted in the same slot. In another scheme, the UE may expect the same value of periodicity, and the same or different value of slot offset, in periodicityAndOffset values for respective multiple CSI-RS resources. This indicates that, in periodic CSI-RS or semi-persistent CSI-RS, the periodicity is the same for all, but the positions of the slots in which CSI-RS ports included in respective CSI-RS In another scheme, the UE may expect that the resources are transmitted are different. periodicityAndOffset values are not limited with regard to each of the multiple CSI-RS resources. This indicates that, in periodic or semi-persistent CSI-RS, there is no restriction on whether the period and slot offset values are the same or different. This also indicates that, when the UE measures CSI-RS ports included in each CSI-RS resource, the UE may update information for some of the CSI-RS ports among the Pₜₒₜ CSI-RS ports, and may not necessarily need to update information for all CSI-RS ports at the same or a similar time.

qcl-InfoPeriodicCSI-RS: The UE may expect that respective CSI-RS resources have the same or different qcl-InfoPeriodicCSI-RS values. The parameter may be defined only for a periodic CSI-RS, and the parameter may have a value corresponding to a TCI-Stateld.

The TCI state ID may indicate a specific TCI-State or a specific dl-Or-Joint-TCI-State. When the UE has the same qcl-InfoPeriodicCSI-RS value for multiple CSI-RS resources, this may imply that the UE has received Pₜₒₜ CSI-RS ports transmitted from a similar location. That is, this indicates that all the Pₜₒₜ CSI-RS ports are transmitted from a TRP, a radio unit (RU), or a massive MIMO unit (MMU) that are located in the same or similar positions. Alternatively, if the UE has different qcl-InfoPeriodicCSI-RS values for multiple CSI-RS resources, this indicates that the CSI-RS ports included in each CSI-RS resource are transmitted from a TRP, an RU, or an MMU that are located at different positions.

Additionally, the UE and the BS may define the higher layer signaling CSI-RS-ResourceMapping in Table 6 in the form of Table 24 below, which includes detailed parameters, and the UE may receive configuration information of each parameter from the BS based on the higher layer signaling.

TABLE 24
CSI-RS-ResourceMapping ::= SEQUENCE {
frequencyDomainAllocation CHOICE
row1 BIT STRING (SIZE (4)),
row2 BIT STRING (SIZE (12)),
row4 BIT STRING (SIZE (3)),
other BIT STRING (SIZE (6))
},
nrofPorts ENUMERATED {p1,p2,p4,p8,p12,p16,p24,p32},
firstOFDMSymbolInTimeDomain INTEGER (0..13),
firstOFDMSymbolInTimeDomain2 INTEGER (2..12) OPTIONAL, -- Need R
cdm-Type ENUMERATED {noCDM, fd-CDM2, cdm4-FD2-TD2, cdm8-FD2-
TD4},
density CHOICE {
dot5 ENUMERATED {evenPRBs, oddPRBs},
one NULL,
three NULL,
spare NULL
},
freqBand CSI-FrequencyOccupation,
...
}
CSI-FrequencyOccupation ::= SEQUENCE {
startingRB INTEGER (0..maxNrofPhysicalResourceBlocks-1),
nrofRBs INTEGER (24..maxNrofPhysicalResourceBlocksPlus1),
...
}

With regard to each higher layer signaling in Table 24, the UE may receive configuration of information that is the same or different between multiple CSI-RS resources, and a criterion and a definition thereof may be determined according to at least one of the following items.

The UE may expect that at least nrofPorts, cdm-Type, density, and nrofRBs in CSI-FrequencyOccupation, among the higher layer signaling in Table 24, are the same among multiple CSI-RS resources.

The UE may expect that at least frequencyDomainAllocation, firstOFDMSymbolInTimeDomain, firstOFDMSymbolInTimeDomain2, and startingRB among the higher layer signaling in Table 24 are the same or different among multiple CSI-RS resources.

When the UE supports a total of Pₜₒₜ CSI-RS ports based on the above multiple CSI-RS resources, a specific CSI-RS resource may include all of the parameters shown in Table 6 and Table 24. In contrast, for the remaining CSI-RS resources among the multiple CSI-RS resources, parameters having the same values as those of the specific CSI-RS resource described above among the parameters shown in Table 6 and Table 24 may be omitted from the configuration. Exclusion of a parameter from the configuration may indicate that the parameter has the same value as that of the corresponding parameter of the specific CSI-RS resource described above.

In another method, when the UE supports a total of Pₜₒₜ CSI-RS ports, based on the above multiple CSI-RS resources, a specific CSI-RS resource may include all of the parameters in Table 6 and Table 24, whereas no parameter may be configured for the remaining CSI-RS resources among the multiple CSI-RS resources. In the remaining CSI-RS resources, a time and frequency RE offset from the above-described specific CSI-RS resource may be configured, and REs that map remaining CSI-RS ports other than the CSI-RS port expressed by the above-described specific CSI-RS resource among Pₜₒₜ CSI-RS ports may be expressed. The RE offset may be a symbol or slot offset, and the frequency resource may be an RE or RB offset.

The UE may report, to the BS, UE capability having a meaning of supporting Method 1-1 and Method 1-2] above. The BS may configure, for the UE, higher layer signaling corresponding to the UE capability, or may support more than 32 CSI-RS ports, based on a single or multiple CSI-RS resources, as described above, without specific higher layer signaling configuration.

### Second Embodiment: Method of Combining Multiple CSI-RS Resources for Implementation of a 128-Port CSI-RS

The UE and the BS may support 48, 64, or 128 CSI-RS ports that are more than 32, based on multiple CSI-RS resources as in Method 1-2 in the first embodiment. In this case, the UE supporting 48, 64, or 128 CSI-RS ports (which is more than 32) means that the UE may receive, from the BS, configuration of multiple CSI-RS resources through higher layer signaling, and may receive 48, 64, or 128 CSI-RS ports through the same, calculate CSI corresponding to the same, and report the same to the BS. That is, a UE may receive, from a BS, configuration of higher layer signaling (for example, CSI-ReportConfig) for CSI reporting, and may receive configuration of multiple CSI-RS resources as a channel measurement resource or reference signal associated therewith. The UE may receive each of the multiple CSI-RS resources individually, and may not estimate the channel for each of the multiple CSI-RS resources. Instead, the UE may measure a channel for a total number of CSI-RS ports obtained by combining the multiple CSI-RS resources, and calculate CSI therefor to report the same to the BS.

To calculate CSI for more than 32 CSI-RS ports, the UE may receive, within codebookConfig within CSI-ReportConfig which is higher layer signaling, a configuration in which the number of antennas N1 in the horizontal direction and the number of antennas N2 are configured to correspond to Pₜₒₜ. The corresponding N1 and N2 values are different from the number of CSI-RS ports configured within the CSI-RS resource within the current CSI-RS resource set, but since one CSI should be calculated based on multiple CSI-RS resources, the N1 and N2 values may be configured regardless of the number of ports in each CSI-RS resource. In this case, the codebook type may be a Type-I codebook or a Type-II codebook.

For example, when the UE supports a total of 48 CSI-RS ports through multiple CSI-RS resources, the UE may support one of (N1, N2)=(8, 3) or (6, 4) as the values of N1 and N2, according to a UE capability report, and may receive higher layer signaling therefor from the BS. The UE may receive a configuration for a combination of N1 and N2 in CSI-ReportConfig or codebookConfig which is higher layer signaling.

In another example, when the UE supports a total of 64 CSI-RS ports through multiple CSI-RS resources, the UE may support one of (N1, N2)=(16, 2) or (8, 4) as the values of N1 and N2, according to the UE capability report, and may receive higher layer signaling therefor from the BS. The UE may receive a configuration for a combination of N1 and N2 in CSI-ReportConfig or codebookConfig, which is higher layer signaling.

As another example, when the UE supports a total of 128 CSI-RS ports through multiple CSI-RS resources, the UE may support one of (N1, N2)=(16, 4) or (8, 8) as the values of N1 and N2, according to the UE capability report, and may receive higher layer signaling therefor from the BS. The UE may receive a configuration of a combination of N1 and N2 in CSI-ReportConfig or codebookConfig which is higher layer signaling.

In this case, when the UE receives, from the BS, a configuration of the multiple CSI-RS resources by higher layer signaling, at least one combination of the following methods may be considered.

### Method 2-1

The UE may receive higher layer signaling from the BS to configure multiple CSI-RS resources to be included in the same CSI-RS resource set. The UE may receive one CSI-ResourceConfig, which is a set of channel measurement reference signals (channel measurement resources or reference signals) associated with CSI-ReportConfig which is higher layer signaling. When there are multiple CSI-RS resources that are periodic or semi-persistent (i.e., if resourceType within CSI-ResourceConfig is configured as periodic or semi-persistent), the UE may receive one CSI-RS resource set within CSI-ResourceConfig. When multiple CSI-RS resources are aperiodic CSI-RS (i.e., if the resourceType within CSI-ResourceConfig is configured as aperiodic), the UE may receive a configuration of one or more CSI-RS resource sets within CSI-ResourceConfig, and may receive a configuration of one of the one or more CSI-RS resource sets through resourceSet within CSI-AssociatedReportConfigInfo.

When the UE receives a configuration of the codebook type for channel state information reporting, which is configured through codebookConfig in CSI-ReportConfig which is higher layer signaling, is one of type-I-single-panel-r19, Type-I-multi-panel-r19, Type-II-r19, eType-II-r19, FeType-II-r19, eType-II-Dopper-r19, and FeType-II-Doppler-r19, and/or when the UE receives a configuration of (N1, N2) values corresponding to 48, 64, or 128 CSI-RS ports described above, the UE may expect that the total number of CSI-RS ports obtained by combining all CSI-RS resources within a CSI-RS resource set is equal to a value obtained by multiplying the configured N1 and N2 values and further multiplying the result by 2. In this case, the UE may expect that density, nrofPorts, and cdm-type, which are higher layer signaling, for all CSI-RS resources in the CSI-RS resource set are the same, may expect that the number of RBs in the frequency domain for all CSI-RS resources is the same, and may expect that the start RB positions of all CSI-RS resources are all the same or may be different from each other.

For example, consider when the BS notifies the UE to perform CSI reporting for 128 CSI-RS ports by combining four CSI-RS resources, each of which is composed of 32 CSI-RS ports. When the BS wants to transmit and receive four CSI-RS resources within one slot to minimize the reception time interval between four CSI-RS resources and thereby increase the channel estimation accuracy in the UE, the BS cannot transmit four CSI-RS resources within one slot, since if all CSI-RS resources have the same starting RB location, one CSI-RS resource having 32 CSI-RS ports occupies four OFDM symbols and eight subcarriers. Therefore, the BS may configure the start RB position between multiple CSI-RS resources to be different and may configure the density to be 0.5, so that, for example, when four CSI-RS resources, each having 32 CSI-RS ports, are combined to support 128 CSI-RS ports, the UE may receive two CSI-RS resources as the start RB from the Nth RB, and may receive the other two CSI-RS resources as the start RB from the (N+1)th RB. In this case, if the UE receives a configuration of a density of 0.5 for the four CSI-RS resources, the UE is able to receive all 128 CSI-RS ports within one slot. t. Alternatively, the UE may receive multiple CSI-RS resources multiplexed in the frequency domain in one slot by having the same starting RB value configured for all of the multiple CSI-RS resources and having a different RB offset or RE offset configured for each CSI-RS resource. Although the above example describes when four CSI-RS resources are included in a single CSI-RS resource set, the obvious changes of the described method may be applied.

### Method 2-2

The UE may receive, from the BS, higher layer signaling to configure multiple CSI-RS resources to be included in the same CSI-RS resource set. The UE may have one or more CSI-RS resource groups configured in the corresponding CSI-RS resource set, and one or more CSI-RS resources may be included in each group. Although the concept of a CSI-RS resource group is introduced between a UE and a BS, when multiple CSI-RS resources are combined, all CSI-RS resources in all CSI-RS resource groups may be considered. The UE may be configured to have one CSI-ResourceConfig, which is a set of channel measurement reference signals (channel measurement resource or reference signal) associated with CSI-ReportConfig which is higher layer signaling. When multiple CSI-RS resources are periodic or semi-persistent CSI-RS (i.e., resourceType in CSI-ResourceConfig is configured as periodic or semiPersistent), the UE may be configured to have one CSI-RS resource set within CSI-ResourceConfig. When multiple CSI-RS resources are aperiodic CSI-RSs (i.e., when resource Type within CSI-ResourceConfig is configured as aperiodic), the UE may receive a configuration of one or more CSI-RS resource sets within CSI-ResourceConfig, and may receive a configuration of one of the one or more CSI-RS resource sets via resourceSet within CSI-AssociatedReportConfigInfo.

When a type of codebook for channel state information reporting configured through codebookConfig in CSI-ReportConfig which is higher layer signaling is one of type-I-single-panel-r19, Type-I-multi-panel-r19, Type-II-r19, eType-II-r19, FeType-II-r19, eType-II-Dopper-r19, and FeType-II-Doppler-r19, and/or if (N1, N2) values corresponding to the above 48, 64, or 128 CSI-RS ports are configured for the UE, the UE may expect that the total CSI-RS ports obtained by combining all CSI-RS resources in the CSI-RS resource set is equal to a value obtained by multiplying the above configured N1 and N2 values and further multiplying the result by 2. The UE may expect that there exists a restriction in the higher layer signaling of multiple CSI-RS resources included in each CSI-RS resource group configurable in a CSI-RS resource set. The UE may expect that the higher layer signaling of density, nrofPorts, and cdm-type for multiple CSI-RS resources included in the CSI-RS resource group are the same, and that the number of RBs and the starting RB position of all CSI-RS resources in the frequency domain are also the same. However, the UE may expect that CSI-RS resources included in different CSI-RS resource groups have the same density, nrofPorts, cdm-type, and the number of RBs in the frequency domain, and may expect that the starting RB position is the same or different.

For example, consider when the BS notifies to the UE to perform CSI reporting for 128 CSI-RS ports by combining four CSI-RS resources, each of which is composed of 32 CSI-RS ports. To increase the channel estimation accuracy in the UE, when the BS wants to transmit and receive four CSI-RS resources within one slot to minimize the reception time interval between the four CSI-RS resources, if all of the four CSI-RS resources have the same starting RB position, one CSI-RS resource having 32 CSI-RS ports occupies four OFDM symbols and eight subcarriers, so that the BS is unable to transmit the four CSI-RS resources within one slot. Therefore, the UE may divide multiple CSI-RS resources within a CSI-RS resource set into one or more CSI-RS resource groups, and may be configured to have the same starting RB position within a CSI-RS resource group, different starting RB positions between CSI-RS resources included in different CSI-RS resource groups, and a density of 0.5, thereby enabling the UE to receive 128 CSI-RS ports within one slot.

For example, when four CSI-RS resources, each having 32 CSI-RS ports, are combined to support 128 CSI-RS ports, two of the CSI-RS resources may be included in a first CSI-RS resource group, and the other two CSI-RS resources may be included in a second CSI-RS resource group. In this case, the UE may receive two CSI-RS resources included in the first CSI-RS resource group, starting from the Nth RB as a starting RB, and may receive two CSI-RS resources included in the second CSI-RS resource group, starting from the (N+1)th RB as a starting RB. As such, if the density of four CSI-RS resources is configured to be 0.5, the UE may receive all 128 CSI-RS ports within one slot. As another method for this, the UE may receive multiple CSI-RS resources that are multiplexed on the frequency resource in one slot by having the same starting RB value for all CSI-RS resources in the CSI-RS resource set, and by having different RB offsets or RE offsets for each CSI-RS resource group. The number of CSI-RS resource groups is considered to be two, but this is only an example, and a larger number of CSI-RS resource groups than two may be possible. The number of CSI-RS resources included in a CSI-RS resource group has been considered as two, but this is only an example, and it will be understood that obvious variations are possible in which a different number of CSI-RS resources are included in the CSI-RS resource group.

### Method 2-3

The UE may receive higher layer signaling from the BS to configure multiple CSI-RS resources to be included in different CSI-RS resource sets. The UE may combine multiple CSI-RS resources through a combination of the multiple CSI-RS resource sets. The UE may be configured to have one CSI-ResourceConfig, which is a set of channel measurement reference signals (channel measurement resource or reference signal) associated with CSI-ReportConfig which is higher layer signaling. When multiple CSI-RS resources are periodic or semi-persistent CSI-RS (i.e., resourceType in CSI-ResourceConfig is configured as periodic or semiPersistent), the UE may have one or more (e.g., two or more) CSI-RS resource sets configured in CSI-ResourceConfig. When multiple CSI-RS resources are an aperiodic CSI-RS (i.e., if resourceType in CSI-ResourceConfig is configured as aperiodic), the UE may be configured to have one or more CSI-RS resource sets in CSI-ResourceConfig, and may be configured to have a plurality (e.g., two or more) of the one or more CSI-RS resource sets through resourceSet in CSI-AssociatedReportConfigInfo and/or additional higher layer signaling (e.g., resourceSet2-r19 or resourceSetList-r19).

When the type of the codebook for channel state information reporting configured through codebookConfig in CSI-ReportConfig which is higher layer signaling is, for example, one of Type-I-single-panel-r19, Type-I-multi-panel-r19, Type-II-r19, eType-II-r19, FeType-II-r19, eType-II-Dopper-r19, and FeType-II-Doppler-r19, and/or if (N1, N2) values corresponding to the above 48, 64, or 128 CSI-RS ports are configured for the UE, the UE may expect that the total CSI-RS ports obtained by combining all CSI-RS resources in the CSI-RS resource set is equal to a value obtained by multiplying the above configured N1 and N2 values and further multiplying the result by 2. The UE may expect that there is a constraint in higher layer signaling of multiple CSI-RS resources included in a plurality of CSI-RS resource sets at this time. The UE may expect that the higher layer signaling density, nrofPorts, and cdm-type for the multiple CSI-RS resources included in each CSI-RS resource set are the same, and may also expect that the number of RBs and the starting RB position in the frequency domain for all CSI-RS resources are the same. However, the UE may expect that CSI-RS resources included in different CSI-RS resource sets have the same density, nrofPorts, cdm-type, and number of RBs in the frequency domain, and may expect that the starting RB position is the same or different.

For example, consider when the BS notifies the UE to perform CSI reporting for 128 CSI-RS ports by combining four CSI-RS resources, each of which is composed of 32 CSI-RS ports. When the BS wants to transmit and receive four CSI-RS resources within one slot to minimize the reception time interval between four CSI-RS resources and thereby increase the channel estimation accuracy in the UE, the BS cannot transmit four CSI-RS resources within one slot, since if all CSI-RS resources have the same starting RB location, one CSI-RS resource having 32 CSI-RS ports occupies four OFDM symbols and eight subcarriers. Therefore, when two CSI-RS resource set structures are used and the UE receives higher layer signaling related to resource allocation for multiple CSI-RS resources included in two CSI-RS resource sets, the UE may be configured to have the same start RB position in each CSI-RS resource set (i.e., the CSI-RS resources included in each CSI-RS resource set), but different start RB positions between the CSI-RS resources included in different CSI-RS resource sets, and the density may be configured to 0.5, thereby enabling the UE to receive 128 CSI-RS ports in one slot. For example, if four CSI-RS resources, each having 32 CSI-RS ports, are combined to support 128 CSI-RS ports, two CSI-RS resources may be included in a first CSI-RS resource set, and the other two CSI-RS resources may be included in a second CSI-RS resource set. In this case, the UE may receive two CSI-RS resources included in the first CSI-RS resource group, starting from the Nth RB as a starting RB, and may receive two CSI-RS resources included in the second CSI-RS resource group, starting from the (N+1)th RB as a starting RB. As such, if the density of four CSI-RS resources is configured to be 0.5, the UE may receive all 128 CSI-RS ports within one slot. Alternatively, the UE may receive multiple CSI-RS resources that are multiplexed on the frequency resource in one slot by having the same starting RB value for all CSI-RS resources in the CSI-RS resource set, and by having different RB offsets or RE offsets for each CSI-RS resource group. The number of CSI-RS resource groups is considered to be two, but this is only an example, and a larger number of CSI-RS resource groups than two may be possible. The number of CSI-RS resources included in a CSI-RS resource group has been considered as two, but this is only an example, and it will be understood that obvious variations are possible in which a different number of CSI-RS resources are included in the CSI-RS resource group.

Through at least one combination of the above Method 2-1 to Method 2-3, the UE may receive multiple CSI-RS resources all within one slot, or may receive the multiple CSI-RS resources over two consecutive slots. In this case, the UE may expect that all of the multiple CSI-RS resources received from the BS are periodic CSI-RS resources, semi-persistent CSI-RS resources, or aperiodic CSI-RS resources.

The UE may be expected to receive notification from the BS through a combination of at least one of higher layer signaling, MAC-CE signaling, and L1 signaling, or to have the combination of at least one of Method 2-1 and Method 2-3 fixedly defined in the specification. In addition, if the UE is notified of a combination of one or more specific methods from the BS through at least one of higher layer signaling, MAC-CE signaling, and L1 signaling, it indicates that the UE is not able to support other combinations of one or more specific methods. The UE may expect that Method 2-3 is fixedly defined in a standard. As another example, the UE may be notified from the BS through at least one combination of higher layer signaling, MAC-CE signaling, and L1 signaling regarding Method 2-2, and in this case, the UE may regard that the BS has notified that Method 2-3 is unsupported.

The UE may report, to the BS, whether at least one combination of the above Method 2-1 and Method 2-3 is supported as UE capability. In this case, if the UE has reported to the BS, as a UE capability, that a combination of one or more specific methods is supportable, it may be considered that the UE has reported that support for a combination of one or more other specific methods is not available. The UE may report to the BS whether the UE is able to support Method 2-1 or Method 2-2. In another example, the UE may report to the BS that it is able to support the Method 2-3, and this UE capability report may indicate that the UE is not able to support Method 2-1. The UE capability report may be per UE, per cell, per band, per FS (feature set), or per FSPC (feature set per component carrier), and may report whether each method is supported through an individual UE capability, or may report whether at least one of combinations of a plurality of methods is supported through one UE capability.

### Third Embodiment: Method for Determining a Slot Offset when Multiple CSI-RS Resources are Combined for Reception of Up to 128-Port CSI-RS

When the UE receives more than 32 CSI-RS ports and performs channel estimation thereon to generate one CSI, the UE may be expected to receive all CSI-RSs within one slot or over two consecutive slots, while considering a problem that the channel information between the BS and the UE becomes inaccurate over time and also considering the processing capability of a different UE.

When the UE receives more than 32 CSI-RS ports through multiple CSI-RS resources, if all the multiple CSI-RS resources are periodic or semi-persistent CSI-RS resources, the UE may need to receive different slot offsets for all the CSI-RS resources, even though the UE may receive the same period for all the CSI-RS resources. For example, if the UE receives a configuration of four CSI-RS resources, each of which has 32 CSI-RS ports, to receive a configuration of 128 CSI-RS ports, and all of the CSI-RS resources are periodic or semi-persistent CSI-RS, the UE may receive a slot offset configured as N for two of the CSI-RS resources, and a slot offset configured as (N+1) for the remaining two CSI-RS resources. In this case, the UE may expect that the same density, nrofPorts, cdm-type, number of RBs in the frequency domain, and starting RB position are applied to all CSI-RS resources configured for the UE.

However, when four CSI-RS resources, each having 32 CSI-RS ports, are configured for the UE to receive a configuration of 128 CSI-RS ports, when all CSI-RS resources are aperiodic CSI-RS resources is considered. In this case, the UE may receive a slot offset value for the CSI-RS resource set configuration information including multiple CSI-RS resources through higher layer signaling, and this value may be commonly applied to all CSI-RS resources included in the corresponding CSI-RS resource set. In this case, the slot offset configured for the CSI-RS resource set may be a slot offset from the slot in which the UE has received DCI for triggering aperiodic CSI-RS to the slot in which the aperiodic CSI-RS is to be received. In this case, all CSI-RS resources in the corresponding CSI-RS resource set should be transmitted in one slot. However, considering the constraints in the CSI-RS resource set and the time and frequency resources, it may be impossible for the UE to receive all four CSI-RS resources within one slot when a total of 128 CSI-RS ports are considered, as described above.

As described above, when the UE combines multiple CSI-RS resources for transmission and reception of up to 128 CSI-RS ports to receive all aperiodic CSI-RS resources over a plurality of consecutive slots (e.g., two or more slots), at least one combination of the following items may be considered.

### Method 3-1

The UE may receive, for each of a plurality of aperiodic CSI-RS resources, slot offsets configured individually for the respective aperiodic CSI-RS resources. In this case, if a slot offset value is configured within CSI-RS resource set configuration information including a plurality of aperiodic CSI-RS resources, the UE may ignore the same, and receive the aperiodic CSI-RS by using the slot offset configured for each of the plurality of CSI-RS resources as described above. In this case, slot offset information may be included in each CSI-RS resource configuration information. When a slot offset for a CSI-RS resource is not configured, the slot offset may be considered as 0 or a slot offset configured within CSI-RS resource set configuration information may be applied. In this case, the slot offset may be an offset from a slot in which the UE has been triggered to receive aperiodic CSI-RS through DCI, to a slot in which the aperiodic CSI-RS resource is received. In receiving a slot offset configured for each CSI-RS resource in this manner, the UE may receive the four CSI-RS resources in two consecutive slots by receiving the same or different slot offsets for four CSI-RS resources each including 32 CSI-RS ports, for example.

The UE may have a slot offset configured as N for the first CSI-RS resource and the second CSI-RS resource, and may have a slot offset configured as (N+1) for the third CSI-RS resource and the fourth CSI-RS resource. In this case, the UE may receive the first CSI-RS resource and the second CSI-RS resource in a slot separated by N slots from the DCI for triggering aperiodic CSI-RS, and receive the third CSI-RS resource and the fourth CSI-RS resource in a slot separated by N slots from the DCI, to perform channel estimation for 128 CSI-RS ports in total, and calculate CSI corresponding thereto to report the same to the BS. The above technical features may be given as examples, and obvious modifications are possible.

### Method 3-2

The UE may receive, for each of a plurality of aperiodic CSI-RS resources, slot offsets configured individually for the respective aperiodic CSI-RS resources. In this case, the UE may receive the aperiodic CSI-RS by using, in addition to the slot offset value configured in the CSI-RS resource set configuration information including a plurality of aperiodic CSI-RS resources, a slot offset configured for each of the plurality of CSI-RS resources. In this case, slot offset information may be included in each CSI-RS resource configuration information. The UE may identify the slot offset value of the CSI-RS resource by adding a slot offset value configured for a CSI-RS resource set to a slot offset value configured for each CSI-RS resource. When the slot offset for a CSI-RS resource is not configured, the value of the slot offset for the CSI-RS resource may be considered as 0 or a predetermined value.

For example, consider when the UE receives a configuration of a slot offset of N within CSI-RS resource set configuration information, is not configured with a CSI-RS resource-specific slot offset for the first CSI-RS resource and the second CSI-RS resource, or is configured with a CSI-RS resource-specific slot offset of 0 for the first CSI-RS resource and the second CSI-RS resource, and is configured with a CSI-RS resource-specific slot offset of 1 for the third CSI-RS resource and the fourth CSI-RS resource. In this case, the UE may receive the first CSI-RS resource and the second CSI-RS resource in the Nth slot, which is counted from the slot in which DCI is received, in consideration of N, which is the slot offset configured in the CSI-RS resource set, and may receive the third CSI-RS resource and the fourth CSI-RS resource in the (N+1)th slot, which is counted from the slot in which DCI is received, in consideration of N, which is the slot offset configured in the CSI-RS resource set, and 1, which is the slot offset configured for each CSI-RS resource. The UE may perform channel estimation for a total of 128 CSI-RS ports received in this manner, calculate CSI corresponding thereto, and report the same to the BS. The above technology is only an example, and obvious modifications are possible.

### Method 3-3

The UE may expect that, for a CSI-RS resource set including multiple aperiodic CSI-RS resources, multiple slot offset values are configured for the CSI-RS resource set. In this case, the UE may individually apply the multiple slot offsets configured for the CSI-RS resource set to different CSI-RS resources within the CSI-RS resource set.

The UE may receive, through additional configuration information within each CSI-RS resource, information indicating which slot offset within a CSI-RS resource set to apply. For example, it is considered that two slot offsets are configured for a CSI-RS resource set that includes four CSI-RS resources, each including 32 CSI-RS ports, to support a total of 128 CSI-RS ports, wherein the first slot offset is configured to be applied for the first and second CSI-RS resources, and the second slot offset is configured to be applied for the third and fourth CSI-RS resources. In this case, the UE may receive the first CSI-RS resource and the second CSI-RS resource in a slot that is separated from the slot in which DCI for triggering an aperiodic CSI-RS is received by a first slot offset, and may receive the third CSI-RS resource and the fourth CSI-RS resource in a slot that is separated from the slot in which DCI for triggering aperiodic CSI-RS is received by a second slot offset. In this case, the UE may receive a configuration of one or more higher layer signaling parameters corresponding to different slot offsets in the higher layer signaling that configures the information of the CSI-RS resource set (in the above example, the first slot offset and the second slot offset may be configured in the higher layer signaling within the CSI-RS resource set). Whether a specific slot offset is applied to a specific CSI-RS resource may be configured in the higher layer signaling that configures the information of each CSI-RS resource, and one value among one or more slot offsets configured in the higher layer signaling within the CSI-RS resource set including the corresponding CSI-RS resource may be configured in the higher layer signaling. When one of the one or more slot offset values is not configured within a specific CSI-RS resource, the UE may consider the slot offset for the corresponding CSI-RS resource to be 0.

In another example, the UE may expect that a number of slot offsets equal to the number of CSI-RS resources in the CSI-RS resource set is configured, and may apply the slot offset configured in the CSI-RS resource set to each CSI-RS resource in the order of CSI-RS resource IDs, or vice versa. For example, when four CSI-RS resources are configured in the CSI-RS resource set, and accordingly, four slot offsets are configured, the UE may apply the first slot offset to the first CSI-RS resource, and apply the second slot offset to the second CSI-RS resource, to associate the slot offsets with CSI-RS resources in order and determine the slot offset for receiving a CSI-RS resource. The above technology is an example only, and obvious modification is possible.

The above example has been described when two slot offsets are configured in a CSI-RS resource set, but the above example is not limited thereto, and a case where more than two slot offsets are configured may not be excluded.

### Method 3-4

The UE may expect that, for a CSI-RS resource set including multiple aperiodic CSI-RS resources, multiple slot offset values are configured for the CSI-RS resource set. In this case, the first slot offset parameter that may be configured for the CSI-RS resource set may be applied to all CSI-RS resources in the corresponding CSI-RS resource set, and one value among additionally configured slot offset values may be additionally applied to a part of the CSI-RS resources as a slot offset value based on the first slot offset parameter. In this case, the first slot offset parameter may be, for example, aperiodic TriggeringOffset, aperiodicTriggeringOffset-r16, aperiodicTriggeringOffset-r17, or aperiodic TriggeringOffsetL2-r17.

The UE may receive, through additional configuration information in each CSI-RS resource configuration information, information regarding which value among slot offsets other than the first slot offset in the CSI-RS resource set to apply. When additional configuration information is not configured for the CSI-RS resource, the UE may consider that no additional slot offset is applied for the CSI-RS resource, and may receive the CSI-RS resource in the corresponding slot by applying only the first slot offset. For example, to support a total of 128 CSI-RS ports, a CSI-RS resource set including four CSI-RS resources each including 32 CSI-RS ports is considered. When, in addition to the first slot offset, two slot offsets are configured, the first slot offset is N, and there is no configured information to apply an additional slot offset to the first CSI-RS resource and the second CSI-RS resource, and the second slot offset of is configured to be applied to the third CSI-RS resource and the fourth CSI-RS resource, the UE may receive the first CSI-RS resource and the second CSI-RS resource in a slot separated by the first slot offset configured as N from the slot in which DCI for triggering aperiodic CSI-RS is received, and may receive the third CSI-RS resource and the fourth CSI-RS resource in a slot separated by (N+1) slots, in which the second slot offset value is additionally applied to the first slot offset value, from the slot in which DCI for triggering aperiodic CSI-RS is received.

In another example, the UE may be expected to receive a number of additional slot offsets equal to the number of CSI-RS resources in the CSI-RS resource set, and the UE may apply the slot offset configured in the CSI-RS resource set in order of the CSI-RS resource IDs, or vice versa. For example, when four CSI-RS resources are configured within CSI-RS resource set configuration information, and accordingly, in addition to the first slot offset, four slot offsets are configured, the UE may apply, in addition to the first slot offset, a first slot offset with regard to the first CSI-RS resource and apply, in addition to the first slot offset, a second slot offset with regard to the second CSI-RS resource, and may thus determine a slot offset for receiving a CSI-RS resource by associating the slot offset and the CSI-RS resource in sequence. When no additional slot offset is configured for a CSI-RS resource, the UE may determine a reception slot position by considering only the first slot offset.

### Method 3-5

When the UE operates according to Method 2-2, that is, if two or more CSI-RS resource groups are configured for the UE in the CSI-RS resource set, the UE may be configured to receive, in addition to one slot offset value that can be configured within CSI-RS resource set configuration information, an additional number of slot offsets that is one less than the number of CSI-RS resource groups (For example, when two CSI-RS resource groups exist, the UE may be configured to receive one additional slot offset, which is one less than the number of CSI-RS resource groups. That is, the number of slot offset values may be configured to be equal to the total number of CSI-RS resource groups). That is, the UE may receive a slot offset as many as the number of CSI-RS resource groups in a CSI-RS resource set, and may commonly apply each of the slot offsets to all CSI-RS resources in the corresponding CSI-RS resource group.

For example, it is assumed that for a CSI-RS resource set including four CSI-RS resources, each of which includes 32 CSI-RS ports to support a total of 128 CSI-RS ports, two CSI-RS resource groups are configured, and each CSI-RS resource group includes two CSI-RS resources. In this case, when two slot offsets are configured for the CSI-RS resource set, the UE may apply the first slot offset to the two CSI-RS resources in the first CSI-RS resource group, and may apply the second slot offset to the two CSI-RS resources in the second CSI-RS resource group, thereby receiving CSI-RS resources. The above example has been described for when two CSI-RS resource groups exist in the CSI-RS resource set and two slot offsets are configured, but the disclosure is not limited thereto, and may not exclude when more than two CSI-RS resource groups and slot offsets are configured. The above technology is only an example, and obvious modifications are possible.

### Method 3-6

When the UE is operated by Method 2-2, that is, if two or more CSI-RS resource groups are configured in a CSI-RS resource set, the UE may receive configuration of a slot offset in addition to the first slot offset value that can be configured in the CSI-RS resource set, the slot offset being equal to the number of CSI-RS resource groups. In this case, the first slot offset parameter may be, for example, aperiodicTriggeringOffset, aperiodicTriggeringOffset-r16, aperiodicTriggeringOffset-r17, or aperiodicTriggeringOffsetL2-r17, and may be commonly applied to all CSI-RS resources across all CSI-RS resource groups within the CSI-RS resource set. The slot offset additionally configured equal to the number of CSI-RS resource groups may correspond to each CSI-RS resource group (for example, an additional first slot offset is applied to the first CSI-RS resource group), and the additional slot offset may be applied to the first slot offset value applied to all CSI-RS resources within each CSI-RS resource group.

For example, it is considered that two CSI-RS resource groups are configured for a CSI-RS resource set including four CSI-RS resources each including 32 CSI-RS ports to support a total of 128 CSI-RS ports, and two CSI-RS resources are included in each CSI-RS resource group. In this case, when two additional slot offsets, which are equal in number to the number of CSI-RS resource groups (i.e., 2) are configured in the CSI-RS resource set, the UE may apply the first slot offset and an additional slot offset corresponding to the first CSI-RS resource group to two CSI-RS resources within the first CSI-RS resource group, and may apply the first slot offset and an additional slot offset corresponding to the second CSI-RS resource group to two CSI-RS resources within the second CSI-RS resource group, thereby receiving CSI-RS resources. Although the above example is written for when two CSI-RS resource groups exist in the CSI-RS resource set and thus two additional slot offsets are configured, the disclosure is not limited thereto, and may not exclude when more than two CSI-RS resource groups and slot offsets are configured. The above technology is only an example, and obvious modifications are possible.

The UE may be expected to be notified, by the BS, of a combination of one or more of Method 3-1 to Method 3-6 through a combination of one or more of higher layer signaling, MAC-CE signaling, and L1 signaling, or to have at least one of Method 3-1 and Method 3-4 fixedly defined in the standard. Additionally, when the UE is notified, through at least one combination of higher layer signaling, MAC-CE signaling, and L1 signaling, of a combination of one or more specific methods, this indicates that the UE is unable to support other combinations of one or more specific methods. The UE may expect that Method 3-1 regarding the above-described channel state information reporting method and process initiated by the UE is fixedly defined in the specification. As another example, the UE may receive a notification from the BS through a combination of at least one of higher layer signaling, MAC-CE signaling, and L1 signaling with regard to Method 3-4. In this case, the UE may regard that it has been notified by the BS that Method 3-3 is unsupported.

The UE may report to the BS, as a UE capability, whether it is possible to support at least one combination of Method 3-1 to Method 3-6. In this case, when the UE has reported to the BS, as a UE capability, that a combination of one or more specific methods is supported, the UE may be deemed to have reported that the support for a combination of one or more other specific methods is not possible. The UE may report to the BS whether the UE is able to support Method 3-1 or Method 3-2. In another example, the UE may report to the BS that it is capable of supporting Method 3-1, and the UE capability report may indicate that the UE does not support Method 3-2. The UE capability report may be per UE, per cell, per band, per FS, or per FSPC, and the UE may report whether the respective methods are supported through individual UE capabilities, or report whether at least one combination of multiple methods is supported through one UE capability.

At least one combination of Method 3-1 to Method 3-6 described above may be applied to the following situations.

When a UE performs channel estimation for more than 32 CSI-RS ports (for example, 48, 64, or 128 CSI-RS ports) by combining multiple CSI-RS resources, and reports CSI regarding the same to a BS, if the UE has been configured with the corresponding multiple CSI-RS resources as aperiodic CSI-RS resources, at least one combination of Method 3-1 to Method 3-6 may be applied. In addition, when multiple CSI-RS resources are combined to perform channel estimation for more than 32 CSI-RS ports (for example, 48, 64, or 128 CSI-RS ports), the UE may expect that, instead of a one-to-one association between a conventional CSI-RS resource and a CSI-IM resource, one or multiple CSI-IM resources are configured to be associated with the multiple CSI-RS resources that are subject to combination.

In this case, the UE may expect that one CSI-IM resource associated with all of the multiple CSI-RS resources is configured when the multiple CSI-RS resources are all received in the same slot, and may expect that the corresponding CSI-IM resource is received in the same slot as the multiple CSI-RS resources.

In addition, when multiple CSI-RS resources are received in different slots, the UE may expect that a CSI-IM resource is configured as many as the number of different slots in which multiple CSI-RS resources are received. For example, when four CSI-RS resources are received in two slots with two CSI-RS resources received in each slot, the UE may expect that two CSI-IM resources are configured. The UE may expect that two CSI-RS resources are received in the first slot and that CSI-IM resources associated with the two CSI-RS resources exist in the same slot. The UE may also expect that two CSI-RS resources are received in the second slot and that CSI-IM resources associated with the two CSI-RS resources exist in the same slot. The above details have been considered for the case in which multiple CSI-RS resources are received in two slots and two CSI-IM resources are configured, but this is only an example and not limited thereto. The above-described CSI-IM resource-related details may also be applied to a CSI-RS resource for interference management. The above technology is only an example, and obvious modifications are possible.

In addition, when multiple CSI-RS resources are received in different slots, the UE may expect that the CSI-IM resource exists in the first slot among the different slots in which the plurality of CSI-RS resources are received, and the number of the CSI-IM resources may be expected to be configured to be 1. In addition, such an operation may also be applied to a CSI-RS resource for interference management.

The UE may receive a configuration of two CSI-RS resource groups in a CSI-RS resource set, which is higher layer signaling that indicates a set of channel state information measurement reference signals that may be configured for non-coherent joint transmission (NCJT)-based CSI reporting. In this case, each CSI-RS resource group may be interpreted as a set of CSI-RS resources transmitted from each TRP. The UE may receive a configuration of a CSI-RS resource pair for two CSI-RS resources by selecting one CSI-RS resource in each CSI-RS resource group from the BS. Such a pair of CSI-RS resources may be configured up to a maximum of two, and may be configured through pair1OfNZP-CSI-RS-rland pair2OfNZP-CSI-RS-r17, which are higher layer signaling. In this situation, when the CSI-RS resource is configured for the UE as an aperiodic CSI-RS resource, at least one combination of Method 3-1 to Method 3-6 may be applied. In this case, if a CSI-RS resource set having or CSI-RS resource pairs configured is configured for the UE, and CSI-RS resource groups are configured for the UE, the CSI-RS resources in the CSI-RS resource pair may be received in one slot or in two consecutive slots, and the UE may not expect uplink and DL switching between the two CSI-RS resource reception timings. The above technology is only an example and obvious modifications are possible.

The UE may receive more than one and up to four CSI-RS resources configured within a higher-layer signaling CSI-RS resource set in a CSI-RS resource set, which is higher layer signaling that indicates a set of channel state information measurement reference signals that may be configured for coherent joint transmission (CJT)-based CSI reporting (for example, a CSI-ReportConfig in which a higher-layer signaling parameter codebookType is configured as “typeII-CJT-r18” or “typeII-CJT-PortSelection-r18”). In this case, all CSI-RS resources may be received within one slot, or may be received in two consecutive slots, and the UE may not expect uplink and DL switching between reception time points of the two CSI-RS resources. In this situation, if the CSI-RS resource is configured for the UE as an aperiodic CSI-RS resource, at least one combinations of Method 2-1 to Method 2-3 and/or Method 3-1 to Method 3-6 may be applied. In particular, when the UE has received a configuration of four CSI-RS resources within CSI-RS resource set, which is higher layer signaling indicating a set of channel state information measurement reference signals that may be configured for coherent joint transmission (CJT)-based CSI reporting, and when each CSI-RS resource has been configured with 32 CSI-RS ports, the UE may not be able to receive the four CSI-RS resources in a single slot. Accordingly, at least one of Method 3-1 to Method 3-6 may be applied. The above-described technology is merely an example, and obvious modifications are possible.

The UE may receive a configuration of one CSI-RS resource set including a periodic CSI-RS resource and one CSI-RS resource set including an aperiodic CSI-RS resource for a CSI-RS for tracking (e.g., when trs-info in a CSI-RS resource set is configured as true). In this case, the periodic CSI-RS resource and the aperiodic CSI-RS resource may have the same bandwidth, the same RB location, and the same QCL-TypeA and QCL-TypeD values. The UE may expect that the number of CSI-RS resources included in a CSI-RS resource set containing periodic CSI-RS resources is the same as the number of CSI-RS resources included in a CSI-RS resource set containing aperiodic CSI-RS resources, and may also expect that the number of CSI-RS resources included in each slot is the same. For example, if the UE has been configured with four CSI-RS resources in a CSI-RS resource set including a periodic CSI-RS resource, and four CSI-RS resources are received across the first CSI-RS resource and the second CSI-RS resource are received in the first slot, and the third CSI-RS resource and the fourth CSI-RS resource are received in the second slot, the UE may expect that the number of CSI-RS resources in a CSI-RS resource set including an aperiodic CSI-RS resource is also configured as four, that the four aperiodic CSI-RS resources are also received across two slots, and that the number of CSI-RS resources in each slot is two. In this case, to support transmission of multiple aperiodic CSI-RS resources in different slots, the UE may apply at least one combination of Method 3-1 to Method 3-6. The above technology is only an example, and obvious modification is possible.

When the UE has not been configured with the higher layer signaling of minimumSchedulingOffsetKO for any DL BWP, has not been configured with the higher layer signaling of minimumSchedulingOffsetK2 for any uplink BWP, and qcl-Type of all trigger states that trigger aperiodic CSI-RS resources does not include typeD, the slot offset of aperiodic CSI-RS resources may be fixed to 0. In such a case, to support multiple aperiodic CSI-RS resources to be transmitted in other slots having a slot offset other than 0, the UE may apply at least one combination of Method 3-1 to Method 3-6.

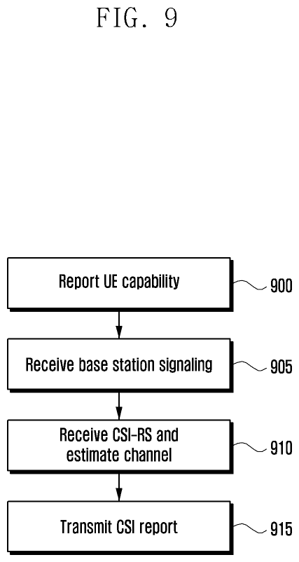

FIG. 9 illustrates a UE operation according to an embodiment. Referring to FIG. 9, in step 900, the UE may report UE capability to the BS. In this case, the UE capability that may be reported to the BS by the UE may include the maximum number of CSI-RS resources and the maximum number of CSI-RS ports per cell or per BWP, a codebook type (e.g., Type-I or Type-II) supported by the UE, and matters related to Method 1-1, Method 1-2, Method 2-1 to Method 2-3, and Method 3-1 to Method 3-6. Step 900 may be omitted.

In step 905, the UE may receive BS signaling from the BS. The BS signaling may refer to a combination of at least one of higher layer signaling, MAC-CE signaling, and L1 signaling of the BS, and the higher layer signaling, MAC-CE signaling, and L1 signaling may relate to CSI report-related information (e.g., CSI-ReportConfig and parameters, such as reportQuantity and codebookConfig within the CSI-ReportConfig), and Method 1-1, Method 1-2, Method 2-1 to Method 2-3, and Method 3-1 to Method 3-6.

In step 910, the UE may receive one or more CSI-RS resources transmitted from the BS and perform channel estimation therefor. In this case, the UE may receive, from the BS, the BS signaling related to one or more CSI-RS resources for channel estimation and CSI calculation for more than 32 CSI-RS ports, considering at least one combination of Method 1-1, Method 1-2, Method 2-1 to Method 2-3, and Method 3-1 to Method 3-6. The UE may then identify reception timings of the one or more CSI-RS resources and receive the one or more CSI-RS resources.

In step 915 the UE calculate CSI, based on the estimated channel, and transmit a CSI report to the BS. In this case, the UE may estimate a channel by considering a CSI-RS resource reception scheme considering above-described Method 1-1, Method 1-2, Method 2-1 to Method 2-3, and Method 3-1 to Method 3-6, and transmit a CSI report to the BS, based on the same. The calculated CSI may be based on a Type-I or Type-II codebook.

The above flowchart illustrates a method that may be implemented according to the principles of the disclosure, and various changes may be made. For example, although illustrated as a series of operations, various operations of the respective drawings may overlap, may occur in parallel, may occur in a different order, or may occur multiple times. In another example, the operation may be omitted or replaced with another operation.

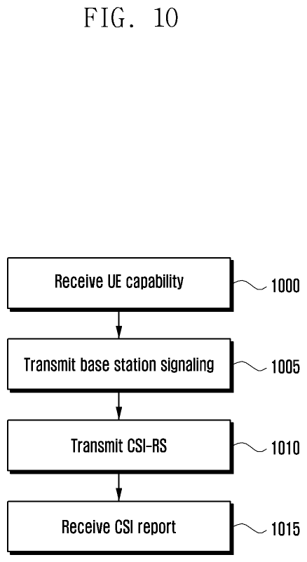

FIG. 10 illustrates a BS operation according to an embodiment.

Referring to FIG. 10, in step 1000, the BS may receive a UE capability from the UE. In this case, the UE capability that may be received by the BS from the UE may include the maximum number of CSI-RS resources and the maximum number of CSI-RS ports per cell or per BWP, a codebook type (e.g., Type-I or Type-II) supported by the UE, and matters related to Method 1-1, Method 1-2, Method 2-1 to Method 2-3, and Method 3-1 to Method 3-6. Step 1000 may be omitted.

In step 1005, the BS may transmit BS signaling to the UE. The BS signaling may refer to at least one combination of higher layer signaling, MAC-CE signaling, and L1 signaling of the BS, and the higher layer signaling, MAC-CE signaling, and L1 signaling may relate to CSI report-related information (e.g., CSI-ReportConfig and parameters such as reportQuantity and codebookConfig within the CSI-ReportConfig) and Method 1-1, Method 1-2, Method 2-1 to Method 2-3, and Method 3-1 to Method 3-6. The BS may determine configuration information of one or more CSI-RS resources, and may transfer single or multiple pieces of CSI-RS resource-related configuration information to the UE by considering at least one combination of Method 1-1, Method 1-2, Method 2-1 to Method 2-3, and Method 3-1 to Method 3-6.

In step 1010, the BS may transmit one or more CSI-RS resources related to BS signaling to the UE. The BS may assume that the one or more CSI-RS resources are received by the UE and that the UE is to perform channel estimation with regard to the one or more CSI-RS resources.

In step 1015, the BS may receive, through a CSI report, CSI calculated by the UE based on an estimated channel. The BS may assume that the UE estimates the channel by considering a CSI-RS resource reception scheme based on at least one of Method 1-1, Method 1-2, Method 2-1 to Method 2-3, and Method 3-1 to Method 3-6, and may assume that the CSI report is transmitted to the BS based thereon. The calculated CSI may be based on a Type-I or Type-II codebook.

Various changes may be made to the method illustrated in the flowchart in the disclosure. For example, although illustrated as a series of operations, the various operations in each of the drawings may overlap, occur in parallel, occur in a different order, or occur multiple times. In another example, the operation may be omitted or replaced with another operation.

### Embodiment 4: Method for Determining an Activated Channel State Information Reference Signal Resource and a Port

The UE may transmit, to the BS through a UE capability report, a constraint on the number of CSI-RS resources that may be activated simultaneously for each cell and a constraint on the number of CSI-RS ports that may be activated simultaneously for each cell. The UE may report, to the BS, a natural number from 1 to 32 as the number of CSI-RS resources that can be simultaneously activated in each cell. The UE may report, to the BS, a multiple of eight from 8 to 128 as the number of CSI-RS ports that can be simultaneously activated in each cell. Whether the UE receives multiple aperiodic CSI-RS resources in one slot or one aperiodic CSI-RS resource per slot, the UE may receive aperiodic CSI-RS resources triggered by the PDCCH from the BS under the constraints of the number of CSI-RS resources and the number of CSI-RS ports.

The activation of a specific CSI-RS resource may be differently defined for each time domain behavior, as follows, and the number of ports configured for the activated CSI-RS resource may be assumed to be activated.

With regard to aperiodic CSI-RS resources, the UE may define that the aperiodic CSI-RS resources are activated from a time point at which the last symbol of a PDCCH including trigger information for the corresponding CSI-RS resource ends to a time point at which the last symbol of a PUSCH transmission including an aperiodic CSI report based on the corresponding CSI-RS resource ends.

For a semi-persistent CSI-RS resource, the UE may define that the corresponding CSI-RS resource is activated from the time point when the activation command for the corresponding CSI-RS resource is applied to the time point when the deactivation command for the corresponding CSI-RS resource is applied. The UE may receive the activation and deactivation commands for the corresponding semi-persistent CSI-RS resource through a MAC-CE. Therefore, the UE may assume that the corresponding activation and deactivation commands are applied from 3 ms after a PUCCH transmission including HARQ-ACK information regarding a MAC-CE reception including an activation or deactivation command.

With regard to the periodic CSI-RS resource, the UE may define that the corresponding CSI-RS resource is activated from the time point when the corresponding CSI-RS resource is configured by higher layer signaling until the moment when the higher layer signaling is released.

When a specific CSI-RS resource is used a total of N times (where N may be a natural number) in one or more CSI report configurations, the UE may multiply, by N, the number of the corresponding CSI-RS resources and the number of ports thereof when calculating the number of activated CSI-RS resources and the number of activated CSI-RS ports.

The UE may receive a configuration of a CSI-RS resource set including N resource pairs, in which two resource groups exist. The CSI-RS resource set may be configured by the BS through higher layer signaling for calculating NCJT CSI. When a specific CSI-RS resource configured within the corresponding CSI-RS resource set is included in one resource group among the two resource groups in the corresponding CSI-RS resource set and is included in one and/or two resource pairs, the UE may calculate the number of activated CSI-RS resources and the number of activated CSI-RS ports by multiplying them by the total number of inclusions of the corresponding CSI-RS resource. For example, when a specific CSI-RS resource is included in one resource group and two resource pairs, the UE may calculate the number of activated CSI-RS resources and the number of activated CSI-RS ports for the CSI-RS resource by multiplying them by three.

The UE may receive L sub-configurations in CSI-ReportConfig, which is higher layer signaling, from the BS. In this case, when calculating the number of activated CSI-RS resources, the UE may perform the calculation as follows.

When the UE has received a total of L sub-configurations configured in a specific CSI-ReportConfig, and N sub-configurations among them are triggered by the BS, if one aperiodic CSI-RS resource is associated with and referred by M sub-configurations among the triggered N sub-configurations, the UE may calculate the number of activated CSI-RS resources by multiplying the corresponding aperiodic CSI-RS resource by M.

When UE has received a total of L sub-configurations in a specific CSI-ReportConfig, if one periodic or semi-persistent CSI-RS is associated with and referenced by M sub-configurations among the L sub-configurations, the UE may calculate the number of activated CSI-RS resources by multiplying the corresponding periodic or semi-persistent CSI-RS resource by M.

The UE may receive L sub-configuration in CSI-ReportConfig, which is higher layer signaling, from the BS. In this case, when calculating the number of activated CSI-RS ports, the UE may perform the calculation as follows.

When the UE has received a configuration of a total of L sub-configurations in a specific CSI-ReportConfig, and N sub-configurations among them are triggered by the BS, and if one aperiodic CSI-RS resource is associated with and referenced by M sub-configurations among the triggered N sub-configurations, the UE may calculate the number of activated CSI-RS ports as max

$$( \sum \text{?} ) ,$$

$$\text{?} \text{indicates text missing or illegible when filed}$$

where Pₛ is the number of CSI-RS ports corresponding to the s-th sub-configuration among the M sub-configurations with which the aperiodic CSI-RS is associated, and P is the number of ports configured by nrofPorts which is higher layer signaling for the aperiodic CSI-RS resource.
When a total of L sub-configurations are configured for the UE in a specific CSI-ReportConfig, and one periodic or semi-persistent CSI-RS is associated with and referenced by M sub-configurations among the L sub-configurations, the UE may calculate the number of activated CSI-RS ports as

$$max ( \sum \text{?} ) ,$$

$$\text{?} \text{indicates text missing or illegible when filed}$$

where Pₛ may be the number of CSI-RS ports corresponding to the s-th sub-configuration among the M sub-configurations with which the periodic or semi-persistent CSI-RS is associated, and P may be the number of ports configured by the higher layer signaling nrofPorts for the corresponding periodic or semi-persistent CSI-RS resource.

The UE may receive a configuration of a value of codebook Type in CSI-ReportConfig which is higher layer signaling from the BS as “typeII-Doppler-r18” or “typeII-Doppler-PortSelection-r18”, and the UE may receive a configuration that the corresponding CSI-ReportConfig is associated with a non-periodic or semi-persistent CSI-RS resource set from the BS. In this case, the UE may calculate the number of activated CSI-RS resources and the number of activated CSI-RS ports for the corresponding periodic or semi-persistent CSI-RS resource by multiplying them by Kᵥ, where Kᵥ may be reported as a value of one of 1, 2, or 4 as a UE capability.

The UE may receive a value of codebook Type in CSI-ReportConfig which is higher layer signaling from the BS as “typeI-SP-extended-r19”, “typeI-MP-extended-r19”, or “typeII-extended-r19”, and the codebookType may indicate a Type-I single panel, a Type-I multi-panel, or a Type-II codebook, which are schemes extended to support 48, 64, or 128 CSI-RS ports. The name of the codebook Type described above is only an example, and may have another name meaning that the Type-I single panel, the Type-I multi-panel, and the Type-II codebook are extended schemes corresponding to an increased number of CSI-RS ports. The above-described CSI-ReportConfig may be associated with a CSI-RS resource set, the corresponding CSI-RS resource set may include multiple CSI-RS resources, and the UE may calculate a PMI corresponding to the total number of CSI-RS ports expressed by the included CSI-RS resources.

### CSI-RS Combination Scheme 48-1

The UE may receive a configuration of a CSI-RS resource set including two CSI-RS resources each having 24 CSI-RS ports, and may receive higher layer signaling from the BS such that the CSI-RS resource sets are associated with the CSI-ReportConfig described above. The UE may calculate CSI corresponding to a total of 48 CSI-RS ports through the corresponding CSI-RS resources.

### CSI-RS Combination Scheme 48-2

The UE may receive a configuration of a CSI-RS resource set including three CSI-RS resources each having 16 CSI-RS ports, and may receive a configuration of higher layer signaling from the BS such that the CSI-RS resource sets are associated with the CSI-ReportConfig described above. The UE may calculate CSI corresponding to a total of 48 CSI-RS ports through the corresponding CSI-RS resources.

### CSI-RS Combination Scheme 64-1

The UE may receive a configuration of a CSI-RS resource set including two CSI-RS resources each having 32 CSI-RS ports, and may receive higher layer signaling from the BS such that the CSI-RS resource sets are associated with the above-described CSI-ReportConfig. The UE may calculate CSI corresponding to a total of 64 CSI-RS ports through the corresponding CSI-RS resources.

### CSI-RS Combination Scheme 64-2

The UE may receive a configuration of a CSI-RS resource set including four CSI-RS resources each having 16 CSI-RS ports, and may receive higher layer signaling from the BS such that the CSI-RS resource sets are associated with the above-described CSI-ReportConfig. The UE may calculate CSI corresponding to a total of 6CSI-RS ports through the corresponding CSI-RS resources.

### CSI-RS Combination Scheme 128-1

The UE may receive a CSI-RS resource set including four CSI-RS resources each having 32 CSI-RS ports, and may receive higher layer signaling from the BS such that the CSI-RS resource sets are associated with the above-described CSI-ReportConfig. The UE may calculate CSI corresponding to a total of 128 CSI-RS ports through the corresponding CSI-RS resources.

Therefore, when the UE calculates and reports CSI corresponding to 48, 64, and 128 total CSI-RS ports as described above, the UE may perform CSI calculation by regarding multiple CSI-RS resources as a single CSI-RS resource. In this case, the UE may consider the multiple CSI-RS resources as a single CSI-RS resource, and may calculate the number of activated CSI-RS resources and the number of ports. For example, as described above, the UE may receive a configuration of a CSI-RS resource set including four CSI-RS resources each having 32 CSI-RS ports, and receive higher layer signaling from the BS such that the CSI-RS resources are associated with the CSI-ReportConfig described above. When the UE calculates CSI corresponding to a total of 128 CSI-RS ports through the corresponding CSI-RS resources, the UE may count the number of activated CSI-RS resources as one, and may count the number of activated CSI-RS ports as 32. That is, the UE may consider multiple CSI-RS resources as a single CSI-RS resource to calculate CSI, and since the plurality of CSI-RS resources are constrained to include the same number of CSI-RS ports, when the number of activated CSI-RS resources is regarded as 1, the number of activated CSI-RS ports may also be regarded as 32, which is the number of CSI-RS ports included in one CSI-RS resource.

The UE may receive a configuration of a reportQuantity value of “cri-RI-PMI-CQI” or “cri-RI-LI-PMI-CQI” within CSI-ReportConfig which is higher layer signaling from the BS, and receive a value of “typeI-SP-multi-CRI-r19” or “typell-multi-CRI-r19” for codebookType. This CSI-ReportConfig may be associated with a CSI-ResourceConfig including a CSI-RS resource set including one or more CSI-RS resources. The codebook Type “typeI-SP-multi-CRI-r19” or “typell-multi-CRI-r19” described above may refer to a scheme in which the UE calculates CSI, based on a Type-I single panel or Rel-16 Type-II, for a number (for example, Y) of CSI-RS resources selected by the UE from among a plurality of CSI-RS resources receivable by the UE or Y CSI-RS resources configured for the UE by the BS, and the UE reports Y CSI-RS resource indicators (CRIs) respectively representing the Y CSI-RS resources, and also reports CSI (for example, Y {RI, PMI, CQI} bundles when the reportQuantity value is “cri-RI-PMI-CQI”, or Y {RI, PMI, LI, CQI} bundles when the reportQuantity value is “cri-RI-LI-PMI-CQI”) corresponding to each CRI. That is, the scheme is extended from a scheme in which the UE, among a plurality of received CSI-RS resources, selects the CSI-RS resource that can yield the best channel performance and reports the selected CSI-RS resource as a CRI together with its corresponding CSI, to a scheme in which the UE reports one or more CRIs and the CSI corresponding to each CRI. In this way, CSI for each CSI-RS resource can be provided to the BS, thereby allowing the BS to obtain additional scheduling degrees of freedom.

It is considered that the UE has received, from the BS, a configuration of a reportQuantity value of “cri-RI-PMI-CQI” or “cri-RI-LI-PMI-CQI” within CSI-ReportConfig, which is higher layer signaling and has received a value of “typeI-SP-multi-CRI-r19” or “typeII-multi-CRI-r19” for codebookType, and the corresponding CSI-ReportConfig is associated with a CSI-ResourceConfig including a CSI-RS resource set including one or more CSI-RS resources. In this case, the UE may calculate the number of activated CSI-RS resources as the total number of CSI-RS resources configured in the CSI-RS resource set configured in the CSI-ResourceConfig. Similarly, the UE may calculate the number of activated CSI-RS ports as the total sum of the number of ports configured in all CSI-RS resources included in the CSI-RS resource set configured in the CSI-ResourceConfig.

As described above, the UE may calculate, for a periodic CSI-RS resource, the number of activated CSI-RS resources or the number of ports from the moment when the UE receives the RRC configuration for configuring the periodic CSI-RS resource to the moment when the RRC configuration is released, and may calculate, for a semi-persistent CSI-RS resource, the number of activated CSI-RS resources or the number of ports from the moment when the UE receives an activation indication from the BS and the activation is applied to the moment when the UE receives a deactivation indication and the deactivation is applied. The number of activated CSI-RS resources or ports may have a maximum value reported as a UE capability, and therefore, in the above-described periodic or semi-persistent CSI-RS resources, the activated CSI-RS resources or ports may be continuously occupied for a specific period of time. For example, when the UE has reported, as UE capability, that the maximum number of activated CSI-RS resources and ports per cell are 4 and 32, respectively, and when the UE receives, from the BS through higher layer signaling, a configuration of a periodic CSI-RS resource having 16 ports, one CSI-RS resource and 16 CSI-RS ports are already occupied from the moment the CSI-RS resource is configured until the moment it is released. Accordingly, the UE may additionally perform operations only for three CSI-RS resources and 16 CSI-RS ports in the corresponding cell.

Therefore, in calculating the number of the activated CSI-RS resources and ports, the number of the periodic or semi-persistent CSI-RS resources and ports are conservatively determined. This is because, when the UE calculates CSI based on the corresponding periodic or semi-persistent CSI-RS resource, there is no constraint regarding whether the UE takes into account the CSI-RS reception time corresponding to one or more periods (or receptions), and the UE may use the channel state information estimated at the CSI-RS reception time point corresponding to one or more periods to practically extract the channel information of a specific cell in which the UE is operating. However, since such an operation may be implemented differently according to the UE/chip manufacturer, for example, a processor manufactured by a certain UE/chip manufacturer does not perform a certain processing continuously based on the channel state information estimated at the CSI-RS reception time point corresponding to each cycle of a periodic or semi-persistent CSI-RS resource, but performs the processing only for a specific period of time, the method of calculating the number of activated CSI-RS resources and ports as described above may be inefficient.

Therefore, to more efficiently utilize CSI-RS resources and ports, the UE and the BS may consider at least one combination of the following methods for adjusting the time of calculating the number of activated CSI-RS resources and the number of activated CSI-RS ports for periodic or semi-persistent CSI-RS.

### Method 4-0

The UE may count the number of activated CSI-RS resources and ports for a periodic CSI-RS resource or semi-persistent CSI-RS resource, that is, for the periodic CSI-RS resource from the time when an RRC configuration is received from the BS until the RRC configuration is released, or for the semi-persistent CSI-RS resource from the time when an activation command is received from the BS and applied until a deactivation command is received and applied. The UE may perform such method on a per-CSI-RS-resource basis. In other words, when the UE calculates the number of activated CSI-RS resources or ports for a periodic or semi-persistent CSI-RS resource, the UE may count the number of activated CSI-RS resources or ports for a specific period of time, regardless of the reception position of a periodic or semi-persistent CSI-RS. When one CSI-RS resource is included in the CSI-RS resource set or multiple CSI-RS resources are included in the CSI-RS resource set, the UE may count the number of activated CSI-RS resources and ports for each CSI-RS resource.

### Method 4-1

For a periodic CSI-RS resource, from the time when an RRC configuration is received from the BS until the RRC configuration is released, or, for a semi-persistent CSI-RS resource, from the time when an activation command is received from the BS and applied until a deactivation command is received and applied, the UE may count the number of activated CSI-RS resources and ports during a specific period from the start point of the first symbol of each CSI-RS reception position corresponding to each period to a specific time after the end point of the last symbol of the CSI-RS reception position. In other time periods, the UE may not count the number of activated CSI-RS resources and ports for the periodic CSI-RS resource or the semi-persistent CSI-RS resource, or may employ a specific other method when counting the number of activated CSI-RS resources or ports.

In this case, the specific time may be a predetermined time unit (e.g., the number of symbols, the number of slots, a value related to CSI processing time, or a specific millisecond) and may follow at least one combination of the methods described in Method 5-1 to Method 5-4 below. The UE may apply the corresponding method for each CSI-RS resource. That is, when one CSI-RS resource is included in the CSI-RS resource set or multiple CSI-RS resources are included in the CSI-RS resource set, the UE may count the number of activated CSI-RS resources and ports with regard to each CSI-RS resource.

In this case, when counting the number of activated CSI-RS resources or the number of ports, a specific other method may follow at least one combination of the methods described in Method 6-1, Method 6-2, Method 7-1, and Method 7-2 below.

### Method 4-2

For a periodic CSI-RS resource, from the time when an RRC configuration is received from the BS until the RRC configuration is released, or, for a semi-persistent CSI-RS resource, from the time when an activation command is received from the BS and applied until a deactivation command is received and applied, the UE may count the number of activated CSI-RS resources and ports for the periodic or semi-persistent CSI-RS resource during a specific period from the start point of the first symbol of a slot including each CSI-RS reception position corresponding to each period to a specific time after the end point of the last symbol of the CSI-RS reception position. In other time periods, the UE may not count the number of activated CSI-RS resources and ports for the periodic CSI-RS resource or the semi-persistent CSI-RS resource, or may use a different specific method when counting the number of activated CSI-RS resources or the number of ports.

In this case, the above-described specific time may be a predetermined time unit (e.g., the number of symbols, the number of slots, a value related to CSI processing time, or a specific millisecond) and may follow at least one combination of the methods described in Method 5-1 to Method 5-4 below. The UE may apply the corresponding method for each CSI-RS resource. That is, when one CSI-RS resource is included in the CSI-RS resource set or multiple CSI-RS resources are included in the CSI-RS resource set, the UE may count the number of activated CSI-RS resources and ports with regard to each CSI-RS resource.

In this case, when counting the number of activated CSI-RS resources or the number of ports, a specific other method may follow at least one combination of the methods described in Method 6-1, Method 6-2, Method 7-1, and Method 7-2 below.

### Method 4-3

For a periodic CSI-RS resource, from the time when an RRC configuration is received from the BS until the RRC configuration is released, or, for a semi-persistent CSI-RS resource, from the time when an activation command is received from the BS and applied until a deactivation command is received and applied, the UE may count the number of activated CSI-RS resources and ports for the periodic or semi-persistent CSI-RS resource during a specific period from the start point of the first symbol of a slot including a CSI-RS reception position corresponding to every Xth period to a specific time after the end point of the last symbol of the CSI-RS reception position. In other time periods, the UE may not count the number of activated CSI-RS resources and ports for the periodic CSI-RS resource or the semi-persistent CSI-RS resource, or may use a different specific method when counting the number of activated CSI-RS resources or the number of ports. The UE may apply the corresponding method for each CSI-RS resource. That is, when one CSI-RS resource is included in the CSI-RS resource set or multiple CSI-RS resources are included in the CSI-RS resource set, the UE may count the number of activated CSI-RS resources and ports with regard to each CSI-RS resource.

The above-described specific time may a predetermined time unit (e.g., the number of symbols, the number of slots, a value related to CSI processing time, or a specific millisecond) and may follow at least one combination of the methods described in Method 5-1 to Method 5-4 below.

The X value for determining the CSI-RS reception position corresponding to every X-th period described above may be a value reported by the UE capability and/or configured by the BS through higher layer signaling, or a value fixedly defined in the specification. The X value may be different or the same according to the CSI report configuration with which the corresponding CSI-RS resource is associated.
When the UE receives codebookType, which is higher layer signaling, as “typeII-Doppler-r18” or “typeII-Doppler-PortSelection-r18”, the UE may use the value of Kᵥ, which is reported as a UE capability, as the above-described value X. For example, when the UE reports the Kₚ as 4, the UE may calculate the number of activated CSI-RS resources and ports for the periodic or semi-persistent CSI-RS resources during a specific period of time from the end point of the last symbol of each CSI-RS reception position for every X=4 CSI-RS reception positions, and may not calculate the number of activated CSI-RS resources and ports for other time periods.

When the number of activated CSI-RS resources or ports is counted, a specific other method may follow at least one combination of the methods described in Method 6-1, Method 6-2, Method 7-1, and Method 7-2 below.

### Method 4-4

For a periodic CSI-RS resource, from the time when an RRC configuration is received from the BS until the RRC configuration is released, or, for a semi-persistent CSI-RS resource, from the time when an activation command is received from the BS and applied until a deactivation command is received and applied, the UE may count the number of activated CSI-RS resources and ports for the periodic or semi-persistent CSI-RS resource, except for the most recent CSI-RS reception position prior to the CSI reference resource corresponding to the CSI report configuration to which the CSI-RS resource is linked, during a specific period from the start point of the first symbol of a slot including each CSI-RS reception position corresponding to each period to a specific time after the end point of the last symbol of the CSI-RS reception position. In other time periods, the UE may not count the number of activated CSI-RS resources and ports for the periodic CSI-RS resource or the semi-persistent CSI-RS resource, or may use a different specific method when counting the number of activated CSI-RS resources or the number of ports. The UE may apply the corresponding method for each CSI-RS resource. That is, when one CSI-RS resource is included in the CSI-RS resource set or multiple CSI-RS resources are included in the CSI-RS resource set, the UE may count the number of activated CSI-RS resources and ports with regard to each CSI-RS resource.
the above-described specific time may be a predetermined time unit (e.g., the number of symbols, the number of slots, a value related to CSI processing time, or a specific millisecond) and may follow at least one combination of the methods described in Method 5-1 to Method 5-4 below.
when the number of activated CSI-RS resources or ports is counted, a specific other method may follow at least one combination of the methods described in Method 6-1, Method 6-2, Method 7-1, and Method 7-2 below.

### Method 4-5

The UE may consider different CSI-RS resource and port count calculation methods when the UE is configured to calculate and report a single CSI, based on a single CSI-RS resource, and when the UE is configured to calculate and report a single CSI, based on multiple CSI-RS resources. In particular, when the UE is configured to calculate and report a single CSI, based on multiple CSI-RS resources, the UE may perform channel estimation for multiple CSI-RSs and calculate CSI, based on the channel information obtained from the multiple CSI-RSs, and thus a method other than the above-described method of calculating the number of activated CSI-RS resources and ports for only a predetermined period of time at each reception position for the period of each CSI-RS resource may be considered.

When the UE is configured to calculate and report a single CSI, based on multiple CSI-RS resources, if the multiple CSI-RS resources have the same period and different symbol and slot offsets, the UE may count the number of activated CSI-RS resources and ports for the multiple CSI-RS resources during a specific period from the start point of the first symbol of the CSI-RS resource having the earliest reception position among the multiple CSI-RS resources in a specific period in which the multiple CSI-RS resources are received to a specific time after the end point of the last symbol of the CSI-RS resource having the latest reception position. In other time periods, the UE may not count the number of activated CSI-RS resources and ports for the multiple CSI-RS resources, or may use a specific different method when counting the number of activated CSI-RS resources or ports.

The specific time may be a predetermined time unit (e.g., the number of symbols, the number of slots, a value related to a CSI processing time, a specific millisecond, etc.) and may follow at least one combination of the methods described in Method 5-1 to Method 5-4 below.

When counting the above-described activated CSI-RS resources or the number of ports, a specific other method may follow at least one combination of the methods described in Method 6-1, Method 6-2, Method 7-1, and Method 7-2 below.

When receiving a configuration for calculating and reporting a single CSI, based on the above-described multiple CSI-RS resources, the case may correspond to the following situations.

### Multiple CSI-RS Configuration Scheme 1

When multiple CSI-RS resources are associated with a CSI-ResourceConfig associated with the CSI-ReportConfig configured for the UE by the BS, and the UE is configured to report one or more CRIs therefrom (for example, when one of cri-RI-PMI-CQI, cri-RI-i1, cri-RI-i1-CQI, cri-RI-CQI, cri-RI-LI-PMI-CQI, cri-RSRP, cri-RSRP-Index, cri-SINR, cri-SINR-Index, ssb-Index-RSRP, ssb-Index-RSRP-Index, ssb-Index-SINR, and ssb-Index-SINR-Index is configured for the reportQuantity, and/or when the codebook Type is “typeI-SinglePanel”, “typeI-SP-multi-CRI-r19”, or “typeII-multi-CRI-r19”).

### Multiple CSI-RS Configuration Scheme 2

The UE may receive a CSI-RS resource set including two resource groups for NCJT CSI, and including N resource pairs, and each resource group may include multiple CSI-RS resources, and if one of CSI-RS resources included in each resource group is selected, one resource pair is formed.

### Multiple CSI-RS Configuration Scheme 3

When the UE has been configured with L sub-configurations in CSI-ReportConfig which is higher layer signaling from the BS, and the CSI-RS resource set associated with the CSI-ReportConfig includes multiple CSI-RS resources

### Multiple CSI-RS Configuration Scheme 4

The UE may receive a configuration of up to four CSI-RS resources from the BS for calculating coherent joint transmission (CJT) CSI, and different CSI-RS resources may be considered to be transmitted from different TRPs, and when codebookType within CSI-ReportConfig is “typeII-CJT-r18” or “typeII-CJT-PortSelection-r18”.

### Multiple CSI-RS Configuration Scheme 5

The UE may receive a value of “typeI-SP-extended-r19”, “typeI-MP-extended-r19”, or “typeII-extended-r19” for codebookType in CSI-ReportConfig which is higher layer signaling from the BS, and the corresponding codebook Type may indicate a scheme in which Type-I single panel, Type-I multi-panel, and Type-II codebooks are extended to 48, 64, or 128 CSI-RS ports, respectively. In this case, the UE has been configured to have a CSI-RS resource within the CSI-RS resource set associated with the corresponding CSI-ReportConfig, based on the above-described [CSI-RS combination scheme 48-1, [CSI-RS combination scheme 48-2, [CSI-RS combination scheme 64-1, [CSI-RS combination scheme 64-2, or [CSI-RS combination scheme 128-1.

### Multiple CSI-RS Configuration Scheme 6

The UE may perform CSI reporting to the BS for helping the BS to perform CJT transmission to the UE by utilizing the corresponding TRPs, by calculating time, frequency, and phase differences between the multiple TRPs. In this case, the UE may receive configuration of multiple CSI-RS resources or CSI-RS resource sets from the BS, and a case where different CSI-RS resources or each CSI-RS resource set correspond to different TRPs may correspond to a case where a single CSI is reported based on multiple CSI-RS resources.

When the UE calculates a time difference between multiple TRPs and reports the same to the BS, the UE may receive a reportQuantity which is higher layer signaling configured as “cjtc-Dd”. When the UE calculates a frequency difference between multiple TRPs and reports the same to the BS, the UE may receive a configuration of the higher layer signaling reportQuantity as “cjtc-F”. When the UE to calculates and reports time and frequency differences between multiple TRPs to the BS, the UE may receive reportQuantity which is a higher layer signaling configured as “cjtc-Dd-F”. As such, when the UE calculates time and/or frequency differences between multiple TRPs and reports the same to the BS, the UE may receive configuration of a maximum of four periodic CSI-RS resource sets, in which trs-info is configured as true, as a CSI resource configuration associated with the reporting of the differences. The UE may apply the above-described Method 4-5 with regard to the plurality of periodic CSI-RS resources included in each of the maximum of four periodic CSI-RS resource sets. Alternatively, the UE may apply above-described Method 4-5 for each period corresponding to the least common multiple of the periods of the respective periodic CSI-RS resource sets configured in each of the maximum of four periodic CSI-RS resource sets.

For example, if the UE has been configured with a maximum of four periodic CSI-RS resource sets, and the period of the i-th CSI-RS resource set is Tᵢ, the UE may define the least common multiple of T₁, T₂, T₃, and T₄ as Tₘᵢₙ, and the UE may, from the start point of the first symbol of the reception position (which may be understood as a symbol or a slot) of the earliest CSI-RS resource (in terms of time) among all CSI-RS resources in four CSI-RS resource sets, to the end point of the last symbol of the reception position of the latest CSI-RS resource (in terms of time) among all CSI-RS resources in four CSI-RS resource sets, count the number of activated CSI-RS resources and ports for multiple CSI-RS resources. In other time periods, the UE may not count the number of activated CSI-RS resources and ports, or may use a specific different method when counting the number of activated CSI-RS resources or ports.

When the UE calculates a phase difference between multiple TRPs and reports the same to the BS, the UE may receive a configuration of reportQuantity, which is higher layer signaling, as “cjtc-P”. In such a case, when the UE calculates the phase difference between multiple TRPs and reports the same to the BS, the UE may receive one CSI-RS resource set (i.e., a CSI-RS resource set for CSI calculation) in which repetition and trs-info which are higher layer signaling are not configured, and may receive a configuration of one or more CSI-RS resources included in the set.

### Multiple CSI-RS Configuration Scheme 7

The UE may report the time-domain channel characteristics to the BS by having the reportQuantity in CSI-ReportConfig configured as TDCP. In this case, the UE may receive configuration of a maximum of three periodic CSI-RS resource sets, in which trs-info is configured as true, as a CSI resource configuration associated with the reporting of the differences. In this case, the UE may apply Method 4-5 described above with regard to a plurality of periodic CSI-RS resources included in each of a maximum of three periodic CSI-RS resource sets. Alternatively, the UE may apply the above-described Method 4-5 for each period corresponding to the least common multiple of the periods of the respective periodic CSI-RS resource sets configured in each of the maximum of three periodic CSI-RS resource sets. For example, if the UE has been configured with a maximum of three periodic CSI-RS resource sets, and the period of the i-th CSI-RS resource set is Tᵢ, the UE may define the least common multiple of T₁, T₂, and T₃ as Tₘᵢₙ. The UE may then count the number of activated CSI-RS resources and ports during the period Tₘᵢₙ, from the start point of the first symbol of the reception position of the earliest CSI-RS resource in time among all CSI-RS resources in three CSI-RS resource sets to the end point of the last symbol of the reception position of the latest CSI-RS resource in time among all CSI-RS resources in three CSI-RS resource sets,. In other time periods, the UE may not count the number of activated CSI-RS resources and ports, or may use a specific different method when counting the number of activated CSI-RS resources or ports.

In another scheme, if the UE is configured to perform one of above-described Multiple CSI-RS configuration scheme 1 to [Multiple CSI-RS configuration scheme 7, the UE may use a scheme in which the value of the number of activated CSI-RS resources and ports are maintained without change over time, as in Method 4-0.

### Method 4-6

The UE may receive configuration of a CSI-ReportConfig from the BS, and may receive a CSI resource configuration associated therewith. In this case, the UE may receive a configuration of one or more CSI-RS resources in a specific CSI-RS resource set through the CSI resource configuration.

When the UE has received a configuration of timeRestrictionForChannelMeasurements as “notConfigured” in the CSI-ReportConfig associated with a periodic and semi-persistent CSI-RS resource, the UE may calculate CSI based on reception positions existing before the CSI reference resource for each CSI-RS resource, and there is no standard restriction regarding the number of reception positions on which the CSI calculation is based.

When the UE has received a configuration of timeRestrictionForChannelMeasurements as “configured” in the CSI-ReportConfig associated with the periodic and semi-persistent CSI-RS resource, the UE may calculate CSI, for each CSI-RS resource, based on the most recent reception position among the reception positions existing before the CSI reference resource.

Therefore, when the UE has received a configuration of timeRestrictionForChannelMeasurements as “nonConfigured” as described above, the way in which the UE uses each periodic CSI-RS reception position and the type of calculation performed over the time between reception positions may be freely implemented depending on the UE manufacturer. On the other hand, as described above, when the UE receives timeRestrictionForChannelMeasurements configured as “configured”, the UE calculates CSI based on the CSI-RS reception positions prior to the CSI reference resource for each CSI-RS resource, and thus may calculate CSI based on the CSI-RS of each reception position independently of the CSI-RS of other reception positions. Accordingly, the UE may vary the method of calculating the number of activated CSI-RS resources or ports for periodic or semi-persistent CSI-RS resources in the CSI-RS resource set associated with the CSI-ReportConfig, depending on the value configured for timeRestrictionForChannelMeasurements within the CSI-ReportConfig.

When the UE received a configuration of has timeRestrictionForChannelMeasurements as “notConfigured” in a CSI-ReportConfig associated with a periodic and/or semi-persistent CSI-RS resource, the UE may count the number of activated CSI-RS resources or ports, taking into account the aforementioned Method 4-0]. That is, the UE may, for the periodic CSI-RS resource, count the number of an activated CSI-RS resources and ports from the moment of receiving the RRC configuration from the BS until the RRC configuration is released, and the UE may, for the semi-persistent CSI-RS resource, count the number of activated CSI-RS resources and ports from the time of receiving an activation command from the BS and applying the same to the time of receiving a deactivation command from the BS and applying the same.

When the UE received a configuration of timeRestrictionForChannelMeasurements which is higher layer signaling as “configured” in the CSI-ReportConfig associated with a periodic and/or semi-persistent CSI-RS resource, the UE may count the number of activated CSI-RS resources or ports, considering a method other than Method 4-0] described above. The UE may count the number of activated CSI-RS resources or ports through at least one combination of Method 4-1 to Method 4-5.

The UE may receive one or more CSI-ReportConfig configurations for a specific periodic or semi-persistent CSI-RS resource. In this case, the higher layer signaling timeRestrictionForChannelMeasurements described above may be configured for each CSI-ReportConfig. For example, assume that one or more CSI-RS resources configured in a periodic CSI-RS resource set are associated with a first CSI-ReportConfig and a second CSI-ReportConfig, where the UE receives timeRestrictionForChannelMeasurements configured as “notConfigured” for the first CSI-ReportConfig and configured as “configured” for the second CSI-ReportConfig. When calculating the number of activated CSI-RS resources or ports for the corresponding periodic or semi-persistent CSI-RS resource, the UE may not multiply by two the number of associated CSI-ReportConfigs, but instead, may calculate the number of activated CSI-RS resources and ports by multiplying by two during a specific period from the start point of the first symbol of each CSI-RS reception position corresponding to each period to a specific time after the end point of the last symbol of the CSI-RS reception position. During other time periods, the UE may calculate the number of activated CSI-RS resources or ports as onefold for the first CSI-ReportConfig in which timeRestrictionForChannelMeasurements is configured as “notConfigured,” and as a value less than onefold for the second CSI-ReportConfig in which timeRestrictionForChannelMeasurements is configured as “configured,” depending on which of Method 6-1, Method 6-2, Method 7-1, or Method 7-2 is applied.

To reduce the complexity of CSI calculation and reporting management in the UE and the BS, which may occur due to the increased complexity of counting the number of activated CSI-RS resources and ports resulting from multiple CSI-ReportConfigs associated with one periodic or semi-persistent CSI-RS resource having different timeRestrictionForChannelMeasurements configuration values, the configuration of timeRestrictionForChannelMeasurements may be restricted. That is, when there are multiple CSI-ReportConfig associated with a specific periodic or semi-persistent CSI-RS resource, the UE may expect that the timeRestrictionForChannelMeasurements values in all corresponding CSI-ReportConfig are configured to be the same. That is, when there are multiple CSI-ReportConfig associated with a periodic or semi-persistent CSI-RS resource, the UE may expect that the timeRestrictionForChannelMeasurements values in all of the CSI-ReportConfigs are configured as the same value, either “configured” or “notConfigured”. In this case, when calculating the number of activated CSI-RS resources and ports, the UE may calculate the final number of activated CSI-RS resources and ports by multiplying, based on a specific calculation method, by the number of CSI-ReportConfigs associated with the corresponding periodic or semi-persistent CSI-RS resource.

When the UE wants to use a specific other method for a specific time during the calculation of the number of activated CSI-RS resources and ports by considering Method 4-1 to Method 4-6 above, if a specific periodic or semi-persistent CSI-RS resource is associated with an interference measurement resource (IMR) in a one-to-one manner, the UE may determine the specific time above by considering both the periodic or semi-persistent CSI-RS resource and the interference measurement resource. In this case, the interference measurement reference signal (which may be interchangeably used with the interference measurement resource) may be a CSI-IM resource or a CSI-RS resource. The UE may apply the above-described method for determining a specific time by considering both the periodic or semi-persistent CSI-RS resource and the interference measurement reference signal as described above, only when the periodic or semi-persistent CSI-RS resource and the interference measurement reference signal have the same period, and the slot offset of each reception position of the periodic or semi-persistent CSI-RS resource and the interference measurement reference signal is equal to or less than a specific value. In this case, the reference value of the slot offset for each reception position (or which may be used interchangeably with the term “position”) of the periodic or semi-persistent CSI-RS resource and the interference measurement reference signal may be reported as a UE capability, configured by the BS through higher layer signaling, or fixedly defined in the standard. In this case, the slot offset may have a different value depending on a different subcarrier spacing.

For example, in Method 4-1, when the UE receives a configuration in which a periodic or semi-persistent CSI-RS resource is associated with an interference measurement reference signal in a one-to-one manner, the UE may, for the periodic or semi-persistent CSI-RS resource, count the number of activated CSI-RS resources and ports for each period, from the start point of the first symbol of the reception position existing earlier in time between the reception position of the periodic or semi-persistent CSI-RS resource and the reception position of the interference measurement reference signal associated therewith, to a specific time after the end point of the last symbol of the reception position existing later in time, during the period from the moment of receiving an RRC configuration from the BS until the RRC configuration is released for the periodic CSI-RS resource, or from the moment of receiving an activation command from the BS and applying the same to the moment of receiving a deactivation command from the BS and applying the same for the semi-persistent CSI-RS resource. That is, the UE may apply Method 4-1 above, by considering a reception position in each cycle of the periodic or semi-persistent CSI-RS resource and a reception position in each cycle of the interference measurement reference signal associated with the corresponding periodic or semi-persistent CSI-RS resource as a single reception position.

As another example, in Method 4-6, if both of the parameters timeRestrictionForChannelMeasurements and timeRestrictionForInterferenceMeasurements configured in CSI-ReportConfig which is higher layer signaling are configured as “configured”, the UE may count the number of activated CSI-RS resources or ports by considering a method other than Method 4-0 above. In this case, similar to Method 4-1 described above in consideration of the interference measurement reference signal, the UE may regard the reception position in each cycle of the periodic or semi-persistent CSI-RS resource and the reception position in each cycle of the interference measurement reference signal associated therewith as a single reception position and apply the Method 4-6 described above.

The UE may be expected to be notified by the BS through at least one combination of higher layer signaling, MAC-CE signaling, and L1 signaling, for at least one combination of Method 4-0 to Method 4-6, or may expect that at least one combination of Method 4-0 and Method 4-6 is fixedly defined in the specification. Additionally, when the UE is notified by the BS through at least one combination of higher layer signaling, MAC-CE signaling, and L1 signaling, for a specific combination of one or more methods, it may indicate that the UE does not support one or more other combinations of methods. The UE may expect that the Method 4-0 is fixedly defined in the standard as a calculation method for the number of activated CSI-RS resources and ports. As another example, the UE may be notified by the BS regarding Method 4-6 through at least one combination of higher layer signaling, MAC-CE signaling, and L1 signaling. In this case, the UE may consider that the BS has notified that Method 4-0 is unsupported. Contrary to this, if the UE has not been notified by the BS of at least one combination of Method 4-1 to Method 4-6 through at least one combination of higher layer signaling, MAC-CE signaling, and L1 signaling, the UE may consider that it has been notified by the BS that Method 4-0 is supported.

The UE may report to the BS, as a UE capability, whether at least one combination of Method 4-0 to Method 4-6 is supportable. In this case, when the UE reports, as a UE capability, that a specific combination of one or more methods is supportable, it may be regarded that the UE has reported that one or more other combinations of methods are not supportable. The UE may report to the BS whether Method 4-0] or Method 4-6 is supportable. As another example, the UE may report to the BS that Method 4-0] is supportable, and such a UE capability report may indicate that the UE does not support Method 4-6. The UE capability report may be provided per UE, per cell, per band, per FS, or per FSPC, and the UE may report whether each method is supported through individual UE capability reports, or may report whether at least one combination of multiple methods is supported through a single UE capability report.

The UE may follow at least one combination among the following methods for a specific time applied when calculating the number of activated CSI-RS resources or ports in Method 4-1 to Method 4-6.

### Method 5-1

The UE may determine a specific time applied when calculating the number of activated CSI-RS resources or ports in Method 4-1 to Method 4-6 above as time corresponding to the longest CSI calculation time among the CSI calculation times required by CSI-ReportConfigs configured for the UE by higher layer signaling from the BS in a specific serving cell. I When the longest CSI calculation time among the CSI calculation times required by the CSI-ReportConfigs configured for the UE in a specific serving cell is defined as “C”, C may be used after being converted to a specific time unit (e.g., milliseconds), a number of symbols, or a number of slots. That is, when C is a specific time unit, the UE may convert C to the lowest number of symbols including C or the lowest number of slots including C. In this case, the CSI calculation time may be a value associated with Z and/or Z′ which is the CSI computation time described above.

### Method 5-2

When determining a specific time applied when calculating the number of activated CSI-RS resources or ports in Method 4-1 to Method 4-6 above, the UE may determine the specific time as the CSI calculation time required for the CSI-ReportConfig requiring the longest CSI calculation time among a plurality of CSI-ReportConfigs associated with a periodic or semi-persistent CSI-RS resource. For example, when a first CSI-ReportConfig and a second CSI-ReportConfig are associated with a periodic or semi-persistent CSI-RS resource, the CSI calculation times of the first and second CSI-ReportConfigs are C₁ and C₂, respectively, and C₁≤C₂, the UE may determine C₂ as the specific time applied when calculating the number of activated CSI-RS resources or ports in Method 4-1 to Method 4-6 above. Here, C₂ may be used after being converted into a specific time unit (for example, milliseconds), a number of symbols, or a number of slots. That is, when C₂ is in a specific time unit, the UE may convert C₂ into the lowest number of symbols including C₂ or the lowest number of slots including C₂. In this case, the CSI calculation time may be a value associated with Z and/or Z′, which is the CSI computation time described above.

### Method 5-3

When determining a specific time applied when calculating the number of activated CSI-RS resources or ports in Method 4-1 to Method 4-6 above, the UE may determine the specific time as the time required for CSI calculation for each CSI-ReportConfig associated with a periodic or semi-persistent CSI-RS resource. That is, even for the same periodic or semi-persistent CSI-RS resource, if the resource is associated with multiple CSI-ReportConfigs and the CSI calculation times of the respective CSI-ReportConfigs are different, the UE may, during the shortest CSI calculation time among those of all the CSI-ReportConfigs, calculate the number of activated CSI-RS resources or ports by multiplying it by the number of associated CSI-ReportConfigs, and may calculate the number of activated CSI-RS resources or ports differently for other time periods depending on a CSI-ReportConfig with which the periodic or semi-persistent CSI-RS resource is associated and on a CSI calculation time of each CSI-ReportConfig. For example, when a first CSI-ReportConfig and a second CSI-ReportConfig are associated with a periodic or semi-persistent CSI-RS resource, and the CSI calculation times of the first CSI-ReportConfig and the second CSI-ReportConfig are C₁ and C₂, respectively, and C₁≤C₂, the UE may calculate the number of activated CSI-RS resources or ports by multiplying it by two during a period from the start point of the first symbol of each reception position for each period of the CSI-RS resource to a time point that comes after the end point of the last symbol of the reception position by a specific number of symbols or slots in which C₁ may be included. Thereafter, during a period from a time point that comes after the end point-of the last symbol of each reception position for each period of the CSI-RS resource by a specific number of symbols or slots in which C₁ may be included to a time point that comes after the end point of the last symbol of the reception position by a specific number of symbols or slots in which C₂ may be included, the UE may calculate the number of activated CSI-RS resources or ports as a value between onefold and twofold, depending on which of Method 6-1, Method 6-2, Method 7-1, or Method 7-2 is applied. During other time periods, the UE may calculate the number of activated CSI-RS resources or ports by a value less than one, depending on which method among Method 6-1, Method 6-2, Method 7-1, or Method 7-2 is applied. In this case, the CSI calculation time may be a value associated with the CSI computation time Z and/or Z′ described above.

### Method 5-4

When determining a specific time applied when calculating the number of activated CSI-RS resources or ports in Method 4-1 to Method 4-6, the UE may define the specific time in terms of a specific number of symbols, a specific number of slots, or a specific time interval. In this case, the UE may report the specific time as a UE capability to the BS, and the UE capability may be different or identical per serving cell or per subcarrier spacing. After the UE reports a minimum value to the BS in this manner, the UE may finally receive a notification of the specific time from the BS through a combination of at least one of higher layer signaling, MAC-CE signaling, and L1 signaling. In this case, if the value finally configured by the BS is, for example, “no reduction”, the UE may consider that the BS has determined to use Method 4-0 for the corresponding UE, and in this case, the UE may simply operate without considering the CSI-RS reception position of each period when calculating the number of activated CSI-RS resources and ports, as in Method 4-0.

When the UE does not support one or more combinations of Method 5-1 to Method 5-4 described above, the UE may, differently from the case where a specific time is applied when calculating the number of activated CSI-RS resources or ports as in one of Method 5-1 to Method 5-4, continuously count the number of activated CSI-RS resources and ports regardless of the reception positions per period of the CSI-RS resource, as in Method 4-0.

The UE may be expected to be notified, from the BS, through at least one combination of higher layer signaling, MAC-CE signaling, and L1 signaling, for at least one combination among Method 5-1 to Method 5-4, or may expect that at least one combination among Method 5-1 and Method 5-4 is fixedly defined in the specification. Additionally, if the UE receives notification from the BS, through at least one combination of higher layer signaling, MAC-CE signaling, and L1 signaling, regarding one or more specific combinations of methods, the UE may indicate that the UE does not support one or more other combinations of methods. The UE may expect that Method 5-3 is fixedly defined in the specification as a calculation method for the number of activated CSI-RS resources and ports. As another example, the UE may receive notification regarding Method 5-3 from the BS through at least one combination of higher layer signaling, MAC-CE signaling, and L1 signaling, and in this case, the UE may consider that it has been notified from the BS that Method 4-0] is unsupported. Conversely, if the UE does not receive notification from the BS, through at least one combination of higher layer signaling, MAC-CE signaling, and L1 signaling, for at least one combination among Method 5-1 to Method 5-4, the UE may consider that it has been notified from the BS that Method 4-0] is supported.

The UE may report, to the BS, its support capability for at least one combination among Method 5-1 to Method 5-4 as part of UE capability information. In this case, when the UE reports, as UE capability, that one or more combinations of methods are supported, it may be considered that the UE has reported that it does not support one or more other combinations of methods. The UE may report to the BS its support capability for Method 5-3 or Method 5-4. As another example, the UE may report to the BS that it supports Method 4-0, and such a UE capability report may indicate that the UE does not support one or more combinations among Method 5-1 to Method 5-4. The UE capability report may be provided per UE, per cell, per band, per FS, or per FSPC, and the UE may report whether the individual UE capability supports each method or the UE may report whether a single UE capability supports at least one combination of multiple methods.

The UE may follow at least one combination of the following when calculating the number of activated CSI-RS resources or ports for periodic or semi-persistent CSI-RS resources in Method 4-1 to Method 4-6 above and, during a time other than the times considered in Method 4-1 to Method 4-6 and the specific times considered in Method 5-1 to Method 5-4, with respect to a specific manner of counting the number of activated CSI-RS resources and ports. Method 6 is a method for counting activated CSI-RS resources, and Method 7 is a method for counting activated CSI-RS ports. That is, the UE may determine the number of activated CSI-RS resources and CSI-RS ports by using the methods described below, during a time excluding the times considered in Method 4-1 to Method 4-6 and the specific times considered in Method 5-1 to Method 5-4 from the time period in which the CSI-RS resources or ports were conventionally regarded as activated.

### Method 6-1

The UE may not count the number of activated CSI-RS resources during a time other than the specific times considered in Method 5-1 to Method 5-4 above. That is, by calculating the number of activated CSI-RS resources as 0 during a time other than the specific time, the UE may avoid unnecessary counting of the number of activated CSI-RS resources during a time other than the specific time.

### Method 6-2

The UE may count only a part of the activated CSI-RS resources during a time other than the specific times considered in Method 5-1 to Method 5-4. That is, for the corresponding periodic or semi-persistent CSI-RS resource, the UE may count the number of activated CSI-RS resources for the specific time, and for a time other than the specific time, the UE may follow at least one of the following methods for considering the corresponding periodic or semi-persistent CSI-RS resource as an activated CSI-RS resource.

When one of Multiple CSI-RS configuration scheme 1 to [Multiple CSI-RS configuration scheme 7 is configured for the UE through higher layer signaling, the UE may calculate one CSI through multiple periodic or semi-persistent CSI-RS resources and report the same to the BS. In this case, among the plurality of periodic or semi-persistent CSI-RS resources, the UE may not consider the CSI-RS resources that are not selected for CSI calculation as activated CSI-RS resources. For example, if there are eight CSI-RS resources included in a CSI-RS resource set configured for the UE through higher layer signaling for L1-RSRP reporting, and only four of them are selected and reported to the BS, the UE may consider the selected four CSI-RS resources as activated CSI-RS resources, and may not consider the remaining four unselected CSI-RS resources as activated CSI-RS resources.

In another scheme, when one of Multiple CSI-RS configuration scheme 1 to Multiple CSI-RS configuration scheme 7 is configured for the UE through higher layer signaling, the UE may calculate one CSI through multiple periodic or semi-persistent CSI-RS resources and report the same to the BS. In this case, during a time other than the above-described specific time, the UE may calculate the number of activated CSI-RS resources to be smaller than the number of multiple periodic or semi-persistent CSI-RS resources. For example, during a time other than the specific time described above, the UE may assume multiple periodic or semi-persistent CSI-RS resources as one activated CSI-RS resource. The UE may report, as a UE capability, a value used for counting the number of activated CSI-RS resources for multiple periodic or semi-persistent CSI-RS resources during a time other than the above-described specific time. When the number of periodic or semi-persistent CSI-RS resources used for CSI calculation is smaller than the number reported by the UE, the UE may count the number of periodic or semi-persistent CSI-RS resources used for CSI calculation as the number of activated CSI-RS resources. Otherwise, the UE may count the number of activated CSI-RS resources as the value reported as the UE capability. The UE may consider that the BS uses the value reported as the UE capability without any specific higher layer signaling, or that the BS uses the value reported as the UE capability based on specific higher layer signaling transmitted by the BS, or that the value reported as the UE capability represents a maximum value and the BS performs the above-described operation by configuring, through higher layer signaling, a specific value between 0 and the maximum value. The above-described UE capability value may be reported differently for each reportQuantity value that can be configured for the UE, or may be reported regardless of the reportQuantity. The value may be reported separately for each cell or for the entire set of cells.

Otherwise, the UE may not consider the corresponding periodic or semi-persistent CSI-RS resource as an activated CSI-RS resource during a period other than the specific time (that is, may count it as 0).

### Method 7-1

The UE may not count the number of activated CSI-RS ports during a time other than the specific times considered in the above Method 5-1 to Method 5-4 above. That is, by calculating the number of activated CSI-RS resources as 0 during a time other than the specific time, the UE may avoid unnecessary counting of the number of activated CSI-RS resources during a time other than the specific time.

### Method 7-2

The UE may count only a part of the activated CSI-RS resources during a time other than the specific times considered in Method 5-1 to Method 5-4. That is, for the corresponding periodic or semi-persistent CSI-RS resource, the UE may count the number of activated CSI-RS resources for the specific time, and for a time other than the specific time, the UE may follow at least one of the following methods for counting the number of activated CSI-RS resources for the corresponding periodic or semi-persistent CSI-RS resource.

As an example, a method in which the UE counts only a part of the number of ports configured for the periodic or semi-persistent CSI-RS resource as the number of activated CSI-RS ports during a time other than the aforementioned specific time is as follows. The UE may report, as a UE capability, a specific value between 0 and 1, and may count, as the number of activated CSI-RS ports, a value obtained by multiplying the reported value by the number of ports configured for the corresponding periodic or semi-persistent CSI-RS resource. The UE may report 0.5 as a UE capability. In this case, during a time other than the specific time, the UE may count only half of the number of ports configured for the periodic or semi-persistent CSI-RS resource as the number of activated CSI-RS ports.

For example, a method in which the UE may count only a part of the number of ports configured for the periodic or semi-persistent CSI-RS resource as the number of activated CSI-RS ports during a time other than the specific time described above is as follows. The UE may receive, from the BS, a specific value between 0 and 1, and may count, as the number of activated CSI-RS ports, a value obtained by multiplying the received value by the number of ports configured for the corresponding periodic or semi-persistent CSI-RS resource.

As an example, a method in which the UE counts only a part of the number of ports configured for the periodic or semi-persistent CSI-RS resource as the number of activated CSI-RS ports during a time other than the aforementioned specific time is as follows. The UE may report one value between 0 and 1 as the UE capability, and the UE may receive a predetermined value between the value reported by the UE and 1 from the BS. The UE may then count, as the number of activated CSI-RS ports, a value obtained by multiplying the predetermined value configured by the BS by the number of ports configured for the corresponding periodic or semi-persistent CSI-RS resource. In other words, the value reported by the UE may indicate the minimum value among coefficients that can reduce the number of activated CSI-RS ports, and the BS may consider, during a time other than the specific time, a number of activated CSI-RS ports that is equal to or greater than the minimum value. The UE may report 0.25 as a UE capability, and the BS may configure a specific predetermined value between 0.25 and 1 for the UE. If the configured value is 0.5, the UE may count only half of the number of ports configured for the periodic or semi-persistent CSI-RS resource as the number of activated CSI-RS ports during a time other than the specific time.

As an example, a method in which the UE counts only a part of the number of ports configured for the periodic or semi-persistent CSI-RS resource as the number of activated CSI-RS ports during a time other than the aforementioned specific time is as follows. The UE may report, as a UE capability, a specific number of CSI-RS ports, and the UE may count, as the number of activated CSI-RS ports, a value corresponding to the difference between the reported value and the number of ports configured for the corresponding periodic or semi-persistent CSI-RS resource. In other words, the specific number of CSI-RS ports reported by the UE may represent a number of ports that can be reduced by a specific value relative to the number of ports configured for a specific periodic or semi-persistent CSI-RS resource, when the UE uses a method in which only a part of the CSI-RS port number activated for a specific time is calculated. Since the specific number of CSI-RS ports may vary according to the UE implementation, the specific number of CSI-RS ports may be reported as a UE capability. When the difference value is less than 0, the UE may consider the number of activated CSI-RS ports as 0. The UE may report 16 as a UE capability, and if the number of ports configured for the periodic or semi-persistent CSI-RS resource is 8, the UE may count the number of ports configured for the periodic or semi-persistent CSI-RS resource as 0 during a time other than the specific time. As another example, the UE may report 16 as a UE capability, and if the number of ports configured for the periodic or semi-persistent CSI-RS resource is 32, the UE may count the number of ports configured for the corresponding periodic or semi-persistent CSI-RS resource as 16 during a time other than the specific time.

A method in which the UE counts only a part of the number of ports configured for the periodic or semi-persistent CSI-RS resource as the number of activated CSI-RS ports during a time other than the aforementioned specific time is as follows. The UE may report, as a UE capability, a specific number of CSI-RS ports, and the BS may configure, through higher layer signaling, a specific number of CSI-RS ports between 0 and the value reported by the UE. Thereafter, based on the UE capability information, the UE may count, as the number of activated CSI-RS ports, a value corresponding to the difference between the CSI-RS port number configured by the BS and the number of ports configured for the corresponding periodic or semi-persistent CSI-RS resource. If the difference value is less than 0, the UE may regard the number of activated CSI-RS ports as 0. In other words, the specific CSI-RS port number reported by the UE may represent the maximum number of ports that can be reduced relative to the number of ports configured for a specific periodic or semi-persistent CSI-RS resource when the UE uses a method of partially calculating the number of activated CSI-RS ports during the specific time. The UE may report this value to the BS to provide flexibility in enabling the BS to determine the number of activated CSI-RS ports between 0 and the reported value. The UE may report 16 as a UE capability. If the number of ports configured for the periodic or semi-persistent CSI-RS resource is 8, the UE may count the number of ports configured for the corresponding periodic or semi-persistent CSI-RS resource as 0 during a time other than the specific time. As another example, the UE may report 16 as a UE capability, and if the number of ports configured for the periodic or semi-persistent CSI-RS resource is 32, the UE may count the number of ports configured for the corresponding periodic or semi-persistent CSI-RS resource as 16 during a time other than the specific time.

The UE capability value described above may be reported differently for each reportQuantity value that can be configured for the UE, or may be reported regardless of the reportQuantity. The value may be reported separately for each cell or for the entire cell group. The above-described value configured by the BS may also be reported differently depending on the reportQuantity value that can be configured for the UE, or may be reported regardless of the reportQuantity, and may be reported separately for each cell or for the entire cell group.

The above-described matters may be applied to both cases in which a periodic or semi-persistent CSI-RS resource is associated with CSI-ReportConfig, which is higher layer signaling, the CSI-ReportConfig is configured as a channel measurement reference signal (channel measurement resource) or as an interference measurement reference signal (interference measurement resource). That is, when the resourcesForChannelMeasurement and/or nzp-CSI-RS-ResourcesForInterference configured in the CSI-ReportConfig which is higher layer signaling are periodic or semi-persistent CSI-RS resources, the above-described matters may be applied.

The above-described matters have been described with regard to a periodic or semi-persistent CSI-RS resource, but may be extended and described for an aperiodic CSI-RS resource.

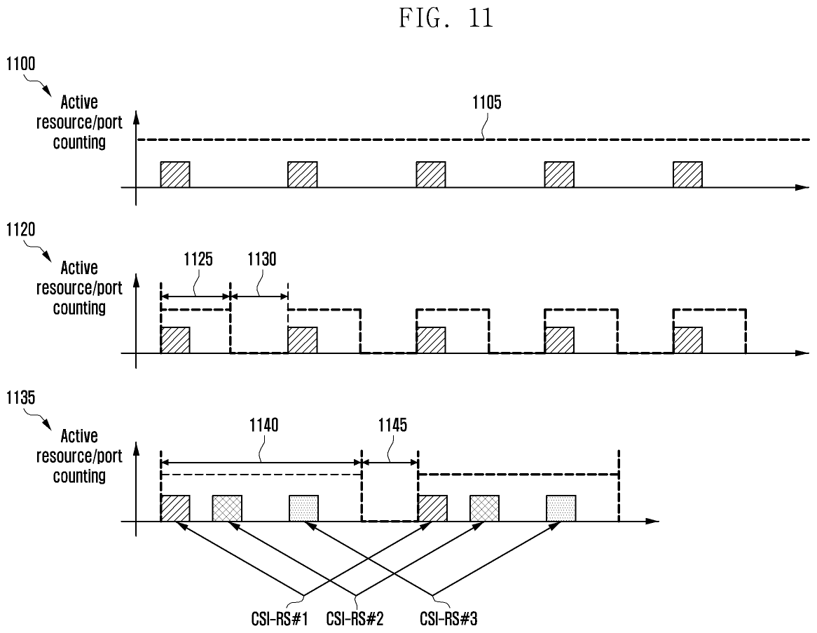

FIG. 11 illustrates an example of calculating the number of activated CSI-RS resources or ports in a UE and a BS according to an embodiment.

Referring to FIG. 11, when the UE operates based on Method 4-0 (1100), the UE may consider the corresponding CSI-RS resource to be continuously activated regardless of the CSI-RS reception position in each period when calculating a periodic or semi-persistent CSI-RS resource or the number of ports, and may regard the number of ports configured for the corresponding CSI-RS resource as the number of activated CSI-RS ports (1105). In this case, the consecutive time interval may be, for a periodic CSI-RS resource, from a time point at which higher layer signaling is configured until to a time point at which the higher layer signaling is released, and for a semi-persistent CSI-RS resource, from a time point at which an activation indication is applied to a time point at which a deactivation indication is applied.

When the UE does not operate based on Method 4-0 above but instead operates according to at least one combination of Method 4-1 to Method 4-6, Method 5-1 to Method 5-4, Method 6-1, Method 6-2, Method 7-1, or Method 7-2 above, the UE may employ a method for reducing the number of activated CSI-RS resources or ports during a certain period of time, without calculating the number of ports and CSI-RS resources continuously activated (1120). The UE may calculate the number of activated CSI-RS resources and ports in a time interval as in Method 4-1 (1125), and may consider the number of activated CSI-RS resources and ports to be zero, as in Method 6-1 and Method 7-1, for other time intervals (1130).

When the UE does not operate based on Method 4-0 above but instead operates corresponding to one of Multiple CSI-RS configuration scheme 1 to Multiple CSI-RS configuration scheme 7 above, the UE may consider multiple CSI-RS resources together when applying a method for reducing the number of activated CSI-RS resources and ports, as described in Method 4-5 (1135). For example, as in Method 4-5, if three CSI-RS resources (e.g., CSI-RS #1, CSI-RS #2, and CSI-RS #3) have the same period and different symbol and slot offsets, the UE may, in a specific period in which the corresponding multiple CSI-RS resources are received, count the number of activated CSI-RS resources and ports for a specific time from the start point of the first symbol of the CSI-RS resource having the earliest reception position in time to the end point of the last symbol of the CSI-RS resource having the latest reception position in time (1140), and may not count the number of activated CSI-RS resources and ports in other periods of time (1145).

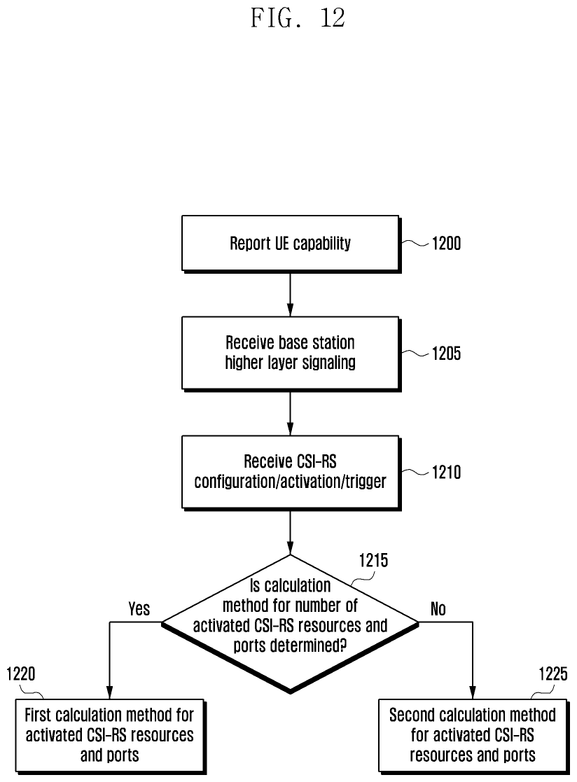

FIG. 12 illustrates a UE operation for calculating the number of activated CSI-RS resources or ports according to an embodiment.

Referring to FIG. 12, in step 1200, the UE may report a UE capability to the BS. The UE capability that the UE may report to the BS may relate to the maximum number of CSI-RS resources and the maximum number of CSI-RS ports per cell or per BWP, the codebook type (e.g., Type-I or Type-II) supported by the UE, and at least one of Method 1-1, Method 1-2, Method 2-1 to Method 2-3, Method 3-1 to Method 3-6, Method 4-0 to Method 4-6, Method 5-1 to Method 5-4, Method 6-1, Method 6-2, Method 7-1, or Method 7-2, or a combination thereof. Step 1200 may be omitted when not required.

In step 1205, the UE may receive BS signaling from the BS. In this case, the BS signaling may refer to at least one combination of higher layer signaling, MAC-CE signaling, and L1 signaling of the BS, and the higher layer signaling, MAC-CE signaling, and L1 signaling may relate to CSI report-related information (for example, CSI-ReportConfig and parameters such as reportQuantity and codebookConfig within the CSI-ReportConfig), and may also relate to at least one combination of Method 1-1, Method 1-2, Method 2-1 to Method 2-3, Method 3-1 to Method 3-6, Method 4-0 to Method 4-6, Method 5-1 to Method 5-4, Method 6-1, Method 6-2, Method 7-1, or Method 7-2.

In step 1210, the UE may receive, from the BS, configuration, activation, and/or triggering of periodic, semi-persistent, and/or aperiodic CSI-RS resources through at least one combination of higher layer signaling, MAC-CE signaling, and L1 signaling. Step 1210 may be omitted when not required.

In step 1215, to determine the number of activated CSI-RS resources and ports for the CSI-RS resource notified by the BS in the previous operation, the UE determines a calculation method for the number of activated CSI-RS resources and ports, based on at least one of the UE capability reported to the BS, and information notified to the UE through higher layer signaling, MAC-CE signaling, and L1 signaling from the BS. Step 1215 may be performed together with operation 1210.

When the UE has been notified of Method 4-0 as the calculation method for the number of activated CSI-RS resources and ports through at least one combination of higher layer signaling, MAC-CE signaling, and L1 signaling from the BS, or when the UE has reported Method 4-0 as a UE capability to the BS, or when the Method 4-0 is fixedly defined in a specification, the UE may use a first calculation method for the number of activated CSI-RS resource and ports (step 1220). In this case, the UE may calculate the number of activated CSI-RS resources and ports according to the first calculation method for the number of activated CSI-RS resource and ports.

Otherwise, the UE may use a second calculation method for the number of activated CSI-RS resources and ports (step 1225). In the second calculation method, when the UE supports at least one combination of Method 4-1 to Method 4-6, supports at least one combination of Method 5-1 to Method 5-4, supports at least one combination of Method 6-1 or Method 6-2, and supports at least one combination of Method 7-1 or Method 7-2, the calculation method for the number of activated CSI-RS resources and ports may be determined according to which method the UE supports, and the UE may calculate the number of activated CSI-RS resources and ports accordingly.

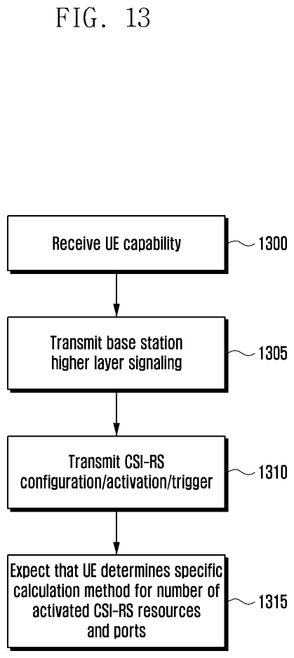

FIG. 13 illustrates a BS operation for calculating the number of activated CSI-RS resources or ports according to an embodiment.

Referring to FIG. 13, in step 1300, the BS may receive a UE capability from the UE. The UE capability that may be received by the BS from the UE may relate to the maximum number of CSI-RS resources and the maximum number of CSI-RS ports per cell or per BWP, a codebook type (e.g., Type-I or Type-II) supported by the UE, and at least one combination of Method 1-1, Method 1-2, Method 2-1 to Method 2-3, Method 3-1 to Method 3-6, Method 4-0 to Method 4-6, Method 5-1 to Method 5-4, Method 6-1, Method 6-2, Method 7-1, or Method 7-2. Operation 1300 may be omitted when not required.

In step 1305, the BS may transmit BS signaling to the UE. The BS signaling may refer to at least one combination of higher layer signaling, MAC-CE signaling, and L1 signaling of the BS, and the higher layer signaling, MAC-CE signaling, and L1 signaling may relate to CSI report-related information (e.g., CSI-ReportConfig and parameters such as reportQuantity and codebookConfig within the CSI-ReportConfig), and may also relate to at least one combination of Method 1-1, Method 1-2, Method 2-1 to Method 2-3, Method 3-1 to Method 3-6, Method 4-0 to Method 4-6, Method 5-1 to Method 5-4, Method 6-1, Method 6-2, Method 7-1, or Method 7-2. The BS may identify a method for calculating the number of activated CSI-RS resources and ports of the UE, and may transmit the BS signaling according to the method for calculating the number of activated CSI-RS resources and ports of the UE.

In step 1310, the BS may transmit, to the UE, configuration, activation, and/or triggering of periodic, semi-persistent, and/or aperiodic CSI-RS resources through at least one combination of higher layer signaling, MAC-CE signaling, and L1 signaling. Step 1310 may also be performed together with step 1305. In this case, the BS may configure a CSI-RS resource for the UE according to a method of calculating the number of activated CSI-RS resources and ports of the UE.

In step 1315, the BS may expect that the UE has calculated number of activated CSI-RS resources and ports according to the method for calculating the activated CSI-RS resources and ports. Step 1315 may also be omitted when not required.

When the UE applies a unified TCI state indicated through DCI format 1_1, 1_2, or 1_3 to an aperiodic CSI-RS resource set, the UE may report, through its UE capability, whether it supports applying the same unified TCI state to the entire aperiodic CSI-RS resource set, or applying identical or different unified TCI states to each CSI-RS resource within the aperiodic CSI-RS resource set. The corresponding UE capability may be reported separately for multi-DCI-based multi-TRP and single-DCI-based multi-TRP.

When reporting the UE capability for multi-DCI-based multi-TRP operation, the UE may report feature group (FG) 40-1-3a to the BS.

When the UE reports the UE capability for the single-DCI-based multi-TRP step, the UE may report FG 40-1-3 to the BS.

For each of FG 40-1-3 and FG 40-1-3a, the UE may report one of per resource, per resource set, and both.

When the UE reports per resource set for the UE capability, the UE may receive, from the BS, a higher layer signaling in which applyIndicatedTCI-State-r18 or applyIndicatedTCI-State2-r18 within CSI-AssociatedReportConfigInfo is configured as perSet-r18.

When the UE reports per resource for the UE capability, the UE may receive, from the BS, a higher layer signaling in which applyIndicatedTCI-State-r18 or applyIndicatedTCI-State2-r18 within CSI-AssociatedReportConfigInfo is configured as perResource-r18. When the UE reports both for the UE capability, the UE may receive, from the BS, a higher layer signaling in which applyIndicatedTCI-State-r18 or applyIndicatedTCI-State2-r18 within CSI-AssociatedReportConfigInfo is configured as either perSet-r18 or perResource-r18.

When the UE reports the UE capability regarding the single-DCI-based multi-TRP step (i.e., when the UE reports FG 40-1-3), if the UE supports NCJT CSI (i.e., when the UE reports FG 23-7-1) or supports CJT CSI (i.e., when the UE reports FG 40-1-4), the UE may be expected to report the above UE capability as per resource. When the CSI-RS that the UE refers to for calculation of NCJT CSI or CJT CSI is an aperiodic CSI-RS, and since both the NCJT CSI and CJT CSI measure a channel, based on a CSI-RS resource transmitted from a different TRP, and calculate and report CSI for one or more TRPs, it may be appropriate for different CSI-RS resources within one CSI-RS resource set to be received in correspondence with different TCI states. Therefore, when the UE supports NCJT CSI or CJT CSI, it may be appropriate for the UE to report per resource when reporting FG 40-1-3.

When the UE reports FG 40-1-3 and/or FG 40-1-3a, if the UE reports a UE capability indicating that the UE is able to report Type-I and/or Type-II CSI corresponding to more than 32 CSI-RS ports (e.g., 48, 64, 128 CSI-RS ports), the UE may be expected to report the above-described UE capability as per resource.

When the UE reports FG 40-1-3 and/or FG 40-1-3a, if the UE reports a UE capability indicating that the UE is able to report Type-I and/or Type-II CSI corresponding to more than 32 CSI-RS ports (e.g., 48, 64, 128 CSI-RS ports), the UE may be expected to report the above-described UE capability as per resource set.

When the UE reports FG 40-1-3 or FG 40-1-3a, if the UE reports a UE capability indicating that the UE is able to report Type-I or Type-II CSI corresponding to 33 or more CSI-RS ports (e.g., 48, 64, 128 CSI-RS ports), the UE may be expected to report the above-described UE capability as both.

When the UE reports FG 40-1-3 and/or FG 40-1-3a, if the UE reports a UE capability indicating that the UE is able to report Type-I and/or Type-II CSI corresponding to more than 32 CSI-RS ports (e.g., 48, 64, or 128 CSI-RS ports), the UE may have no obligation to report the above UE capability or, even if the UE reports the same, the UE may have no constraint to report a specific value.

Since Type-I and/or Type-II CSI corresponding to more than 32 CSI-RS ports is calculated as one CSI by considering the number of all the ports in one or more CSI-RSs transmitted at the same position, it may be appropriate for all CSI-RSs to be received in correspondence with the same TCI state. Therefore, when the UE has reported that it has a capability to report Type-I and/or Type-II CSI corresponding to more than 32 CSI-RS ports (for example, 48, 64, or 128 CSI-RS ports), it may be appropriate for the UE to report per resource set when reporting FG 40-1-3 and/or FG 40-1-3a.

When the UE reports FG 40-1-3 and/or FG 40-1-3a, if the UE has reported to the BS a UE capability indicating that, after performing measurement with respect to multiple CSI-RS resources, multiple CSI-RS resource indicators (CRIs) are included in the CSI calculation, and at least one combination of CQI, PMI, RI, and LI corresponding to each CRI can be reported, the UE may be expected to report the above UE capability as per resource.

When the UE reports FG 40-1-3 and/or FG 40-1-3a, if the UE has reported to the BS a UE capability indicating that, after performing measurement with respect to multiple CSI-RS resources, multiple CRIs (CSI-RS Resource Indicators) are included in the CSI calculation, and at least one combination of CQI, PMI, RI) and LI corresponding to each CRI can be reported, the UE may be expected to report the above UE capability as per resource.

When the UE reports FG 40-1-3 and/or FG 40-1-3a, if the UE has reported to the BS a UE capability indicating that, after performing measurement with respect to multiple CSI-RS resources, multiple CSI-RS resource indicators (CRIs) are included in the CSI calculation, and at least one combination of CQI, PMI, RI, and LI corresponding to each CRI can be reported, the UE may be expected to report the above UE capability as both.

When the UE reports FG 40-1-3 and/or FG 40-1-3a, if the UE has reported to the BS a UE capability indicating that, after performing measurement with respect to multiple CSI-RS resources, multiple CSI-RS resource indicators (CRIs) are included in the CSI calculation, and at least one combination of CQI, PMI, RI, and LI corresponding to each CRI can be reported, the UE may have no obligation to report the above-described UE capability, or, even if the UE reports the UE capability, the UE may not be constrained to report a specific value.

After performing the measurement with respect to multiple CSI-RS resources as described above, when, in the CSI calculation of the UE, multiple CRIs are included and at least one combination of CQI, PMI, RI, and LI corresponding to each CRI is reported, the CSI may be calculated by the UE for each CSI-RS, to which different transmission beams are applied at the BS, as individual CSIs, and CSIs corresponding to one or more specific CSI-RSs may be reported according to the UE implementation or the BS configuration. Therefore, since each CSI-RS may correspond to a different transmission beam, it may be appropriate for the UE to receive each CSI-RS while considering a different TCI state. Accordingly, when the UE reports to the BS, as a UE capability, that the UE can perform measurement with respect to multiple CSI-RS resources and report CSI based on multiple CRIs, the UE may appropriately report per resource when reporting FG 40-1-3 and/or FG 40-1-3a.

When the UE reports FG 40-1-3 and/or FG 40-1-3a, if the UE measures and reports to the BS the time, frequency, and/or phase offset between TRPs, the UE may be expected to report the UE capability described above as per resource.

When the UE reports FG 40-1-3 and/or FG 40-1-3a, if the UE has reported, to the BS, a UE capability capable of measuring and reporting time, frequency, and/or phase offsets between TRPs to the BS, the UE may be expected to report the UE capability described above as per resource set.

When the UE reports FG 40-1-3 and/or FG 40-1-3a, if the UE has reported, to the BS, a UE capability capable of measuring and reporting time, frequency, and/or phase offsets between TRPs to the BS, the UE may be expected to report the UE capability described above as both.

When the UE reports FG 40-1-3 and/or FG 40-1-3a, if the UE has reported, to the BS, a UE capability capable of measuring and reporting time, frequency, and/or phase offsets between TRPs to the BS, the UE may have no obligation to report the above-described UE capability, or, even if the UE reports the UE capability, the UE may not be constrained to report a specific value.

When the UE reports FG 40-1-3 and/or FG 40-1-3a, if the UE has reported to the BS, a UE capability capable of measuring and reporting the phase offset between TRPs to the BS, the UE may be expected to report the above-described UE capability as per resource.

When the UE reports FG 40-1-3 and/or FG 40-1-3a, if the UE measures and reports the phase offset between TRPs to the BS, the UE may be expected to report the above-described UE capability as per resource set.

When the UE reports FG 40-1-3 and/or FG 40-1-3a, if the UE has reported, to the BS, a UE capability capable of measuring and reporting the phase offset between TRPs, the UE may be expected to report the above-described UE capability as both.

When the UE reports FG 40-1-3 and/or FG 40-1-3a, if the UE has reported, to the BS, a UE capability capable of measuring and reporting the phase offset between TRPs, the UE may have no obligation to report the above-described UE capability, or, even if the UE reports the UE capability, the UE may not be constrained to report a specific value.

When the UE reports FG 40-1-3 and/or FG 40-1-3a, if the UE has reported, to the BS, a UE capability capable of measuring and reporting the time and/or frequency offset between TRPs, the UE may have no obligation to report the above-described UE capability, or, even if the UE reports the UE capability, the UE may not be constrained to report a specific value.

When the UE reports FG 40-1-3 and/or FG 40-1-3a, if the UE has reported, to the BS, a UE capability indicating that the UE is able to calculate a time domain feature of a channel and report the same to the BS (i.e., the UE has reported FG 40-3-3-1), the UE may have no obligation to report the above-described UE capability, or, even if the UE reports the UE capability, the UE may not be constrained to report a specific value.

When the UE measures the time, frequency, and/or phase difference between TRPs as described above and reporting the same to the BS in the form of CSI, the UE may extract offset information for each TRP by receiving different CSI-RSs from the different TRPs. Therefore, it may be appropriate for the UE to receive each CSI-RS while considering a different TCI state for each CSI-RS. Meanwhile, since the UE may consider a periodic TRS (where trs-info that is higher layer signaling within a CSI-RS resource set is configured as true) as a CSI-RS used for measuring the time and/or frequency offset between TRPs, the TRS may be irrelevant to the FG 40-1-3 or FG 40-1-3a, which are applicable to an aperiodic CSI-RS. However, the CSI-RS used to measure the phase offset between TRPs is a CSI-RS for CSI measurement using one port (when neither trs-info nor repetition that are higher layer signaling within a CSI-RS resource set is configured), and one or more CSI-RS resources within one CSI-RS resource set may be used for the measurement, and each CSI-RS resource may be considered to be transmitted from a respective TRP. This measurement may be performed through an aperiodic CSI-RS. Therefore, when the UE measures the time and/or frequency offset between TRPs and reports the same to the BS in the form of CSI, the UE may have no obligation to report FG 40-1-3 and/or FG 40-1-3a, or, even if the UE reports the same, the UE may not be constrained to report a specific value. In addition, when the UE measures the phase offset between TRPs and reports the same to the BS in the form of CSI, it may be appropriate for the UE to report per resource when reporting FG 40-1-3 and/or FG 40-1-3a.

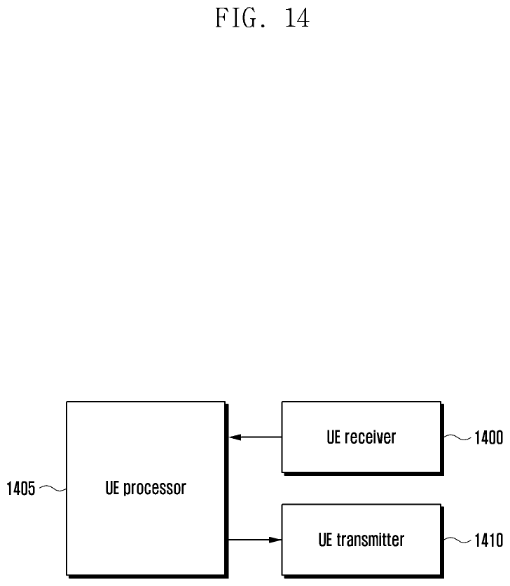

FIG. 14 illustrates a structure of a UE in a wireless communication system according to an embodiment.

Referring to FIG. 14, the UE may include a transceiver, which refers to a UE receiver 14-00 and a UE transmitter 14-10 as a whole, a memory, and a UE processor 14-05 (or UE controller or processor). The UE transceiver 14-00 and 14-10, the memory, and the UE processor 14-05 may operate according to the above-described communication methods of the UE. Components of the UE are not limited to the above-described example. The UE may include a greater than or less than number of components than the above-described components. Furthermore, the transceiver, the memory, and the processor may be implemented in the form of a single chip.

The transceiver may transmit/receive signals with BSs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for steps of the BS. The memory may include storage media such as a read only memory (ROM), a random access memory (RAM), a hard disk, a CD-ROM, and a digital versatile disc (DVD), or a combination of storage media. The memory may include multiple memories.

The processor may control a series of processes so that the UE can operate according to the above-described embodiments. The processor may control components of the UE to receive DCI configured in two layers to simultaneously receive multiple PDSCHs. The processor may include multiple processors, and the processor may perform steps of controlling the components of the UE by executing programs stored in the memory.

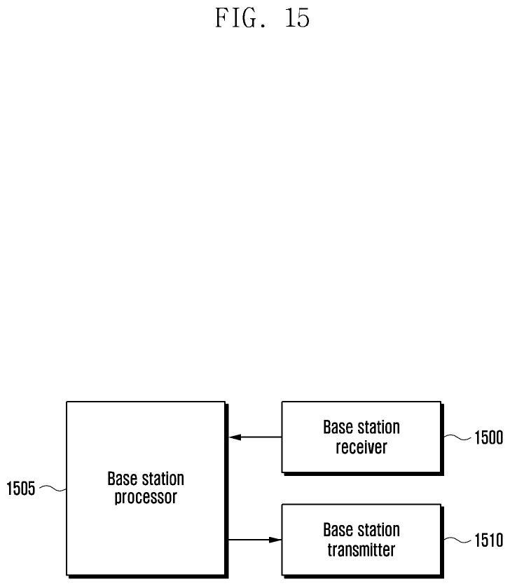

FIG. 15 illustrates a structure of a BS in a wireless communication system according to an embodiment.

Referring to FIG. 15, the BS may include a transceiver, which refers to a BS receiver 1500 and a BS transmitter 1510 as a whole, a memory, and a BS processor 1505 (or BS controller or processor). The BS transceiver 1500 and 1510, the memory, and the BS processor 1505 may operate according to the above-described communication methods of the BS. However, components of the BS are not limited to the above-described example. The BS may include a greater than or less than number of components than the above-described components. Furthermore, the transceiver, the memory, and the processor may be implemented in the form of a single chip.

The transceiver may transmit/receive signals with UEs. The signals may include control information and data. To this end, the transceiver may include an RF transmitter configured to perform amplification and up-conversion of a frequency of a transmitted signal, an RF receiver configured to perform low-noise amplification of a received signal and down-conversion of a frequency, and the like. However, this is only an embodiment of the transceiver, and the components of the transceiver are not limited to the RF transmitter and the RF receiver.

The transceiver may receive signals through a radio channel, output the same to the processor, and transmit signals output from the processor through the radio channel.

The memory may store programs and data necessary for steps of the BS. The memory may store control information or data included in signals transmitted/received by the BS. The memory may include storage media such as a ROM, a RAM, a hard disk, a CD-ROM, and a DVD, or a combination of storage media. The memory may include multiple memories.

The processor may control a series of processes so that the BS can operate according to the above-described embodiments of the disclosure. The processor may control components of the BS to configure DCI configured in two layers including allocation information regarding multiple PDSCHs and to transmit the same. The processor may include multiple processors, and the processor may perform steps of controlling the components of the BS by executing programs stored in the memory.

Methods disclosed in the claims or methods according to the embodiments described in the specification of the disclosure may be implemented by hardware, software, or a combination of hardware and software.

When the methods are implemented by software, a computer-readable storage medium for storing one or more programs (software modules) may be provided. The one or more programs stored in the computer-readable storage medium may be configured for execution by one or more processors within the electronic device. The at least one program includes instructions that cause the electronic device to perform the methods according to various embodiments of the disclosure as defined by the appended claims and/or disclosed herein.

These programs (software modules or software) may be stored in non-volatile memories including a random access memory and a flash memory, a ROM, an electrically erasable programmable read only memory (EEPROM), a magnetic disc storage device, a CD-ROM, DVDs, or other type optical storage devices, or a magnetic cassette. Alternatively, any combination of some or all of them may form a memory in which the program is stored. A plurality of such memories may be included in the electronic device.

The programs may also be stored in an attachable storage device which can access the electronic device through communication networks such as the Internet, Intranet, local area network (LAN), wide LAN (WLAN), and storage area network (SAN) or a combination thereof. Such a storage device may access the electronic device via an external port. Also, a separate storage device on the communication network may access a portable electronic device.

Herein, an element included in the disclosure is expressed in the singular or the plural form which is selected appropriately to the presented situation for the convenience of description, and the disclosure is not limited by elements expressed in the singular or the plural. Therefore, either an element expressed in the plural may also include a single element or an element expressed in the singular may also include multiple elements.

The embodiments of the disclosure described and shown in the specification and the drawings are merely specific examples that have been presented to easily explain the technical contents of the disclosure and help understanding of the disclosure, and are not intended to limit the scope of the disclosure. That is, it will be apparent to those skilled in the art that other variants based on the technical idea of the disclosure may be implemented. The above respective embodiments may be employed in combination, as necessary. For example, a part of one embodiment of the disclosure may be combined with a part of another embodiment to operate a BS and a terminal. Although the above embodiments have been described based on the FDD LTE system, other variants based on the technical idea of the embodiments may also be implemented in other communication systems such as TDD LTE, and 5G, or NR systems.

Herein, each block of the flowchart illustrations, and combinations of blocks in the flowchart illustrations, can be implemented by computer program instructions. These computer program instructions can be provided to a processor of a general-purpose computer, special purpose computer, or other programmable data processing apparatus to produce a machine, such that the instructions, which execute via the processor of the computer or other programmable data processing apparatus, create means for implementing the functions specified in the flowchart block or blocks. These computer program instructions may also be stored in a computer usable or computer-readable memory that can direct a computer or other programmable data processing apparatus to function in a particular manner, such that the instructions stored in the computer usable or computer-readable memory produce an article of manufacture including instruction means that implement the function specified in the flowchart block or blocks. The computer program instructions may also be loaded onto a computer or other programmable data processing apparatus to cause a series of steps to be performed on the computer or other programmable apparatus to produce a computer implemented process such that the instructions that execute on the computer or other programmable apparatus provide steps for implementing the functions specified in the flowchart block or blocks.

Furthermore, each block in the flowchart illustrations may represent a module, segment, or portion of code, which includes one or more executable instructions for implementing the specified logical function(s). It should also be noted that in some alternative implementations, the functions noted in the blocks may occur out of the order. Two blocks shown in succession may in fact be executed substantially concurrently or the blocks may sometimes be executed in the reverse order, depending upon the functionality involved.

As used herein, the term unit refers to a software element or a hardware element, such as a field programmable gate array (FPGA) or an application specific integrated circuit (ASIC), and the unit may perform certain functions. However, the unit does not always have a meaning limited to software or hardware. The unit may be constructed either to be stored in an addressable storage medium or to execute one or more processors. Therefore, the unit includes, for example, software elements, object-oriented software elements, class elements or task elements, processes, functions, properties, procedures, sub-routines, segments of a program code, drivers, firmware, micro-codes, circuits, data, database, data structures, tables, arrays, and parameters. The elements and functions provided by the unit may be either combined into a smaller number of elements, or a unit, or divided into a larger number of elements, or a unit. Moreover, the elements and units may be implemented to reproduce one or more central processing units (CPUs) within a device or a security multimedia card. The unit may include one or more processors.

While the present disclosure has been described with reference to various embodiments, various changes may be made without departing from the spirit and the scope of the present disclosure, which is defined, not by the detailed description and embodiments, but by the appended claims and their equivalents.

What is claimed is:

1. A method performed by a terminal in a communication system, the method comprising:
receiving, from a base station (BS), configuration information on a plurality of channel state information reference signal (CSI-RS) resources for a plurality of CSI-RS ports, wherein the plurality of CSI-RS resources are aperiodic CSI-RS resources for a channel measurement and linked with a channel state information interference measurement resource (CSI-IM) resource;
receiving, from the BS, CSI-RSs corresponding to the plurality of CSI-RS resources in two adjacent slots;
obtaining CSI based on the received CSI-RSs and the CSI-IM resource; and
transmitting, to the BS, the CSI,
wherein the CSI-IM resource is located in a first slot of the two adjacent slots.

2. The method of claim 1,
wherein the plurality of CSI-RS resources is linked with a CSI report configuration with codebook type for release 19.

3. The method of claim 1,
wherein the plurality of CSI-RS resources is included in a CSI-RS resource set.

4. The method of claim 3,
wherein a slot offset for a CSI-RS resource is determined based on a slot offset for the CSI-RS resource set and an additional slot offset for the CSI-RS resource if the additional slot offset is configured.

5. The method of claim 1,
wherein a number of the plurality of CSI-RS port is 48, 64 or 128,
wherein 48 CSI-RS ports are formed by aggregating 2 CSI-RS resource of 24 CSI-RS ports or aggregating 3 CSI-RS resources of 16 CSI-RS ports,
wherein 64 CSI-RS ports are formed by aggregating 2 CSI-RS resources of 32 CSI-RS ports or by aggregating 4 CSI-RS resources of 16 CSI-RS ports, and
wherein 128 CSI-RS ports are formed by aggregating 4 CSI-RS resources of 32 CSI-RS ports.

6. A method performed by a base station (BS) in a communication system, the method comprising:
transmitting, to a terminal, configuration information on a plurality of channel state information reference signal (CSI-RS) resources for a plurality of CSI-RS ports, wherein the plurality of CSI-RS resources are aperiodic CSI-RS resources for a channel measurement and linked with a channel state information interference measurement resource (CSI-IM) resource;
transmitting, to the terminal, CSI-RSs corresponding to the plurality of CSI-RS resources in two adjacent slots; and
receiving, from the terminal, CSI,
wherein the CSI is based on the CSI-RSs and the CSI-IM resource, and
wherein the CSI-IM resource is located in a first slot of the two adjacent slots.

7. The method of claim 6,
wherein the plurality of CSI-RS resources is linked with a CSI report configuration with codebook type for release 19.

8. The method of claim 6,
wherein the plurality of CSI-RS resources is included in a CSI-RS resource set.

9. The method of claim 8,
wherein a slot offset for a CSI-RS resource is determined based on a slot offset for the CSI-RS resource set and an additional slot offset for the CSI-RS resource if the additional slot offset is configured.

10. The method of claim 6,
wherein a number of the plurality of CSI-RS port is 48, 64 or 128,
wherein 48 CSI-RS ports are formed by aggregating 2 CSI-RS resource of 24 CSI-RS ports or aggregating 3 CSI-RS resources of 16 CSI-RS ports,
wherein 64 CSI-RS ports are formed by aggregating 2 CSI-RS resources of 32 CSI-RS ports or by aggregating 4 CSI-RS resources of 16 CSI-RS ports, and
wherein 128 CSI-RS ports are formed by aggregating 4 CSI-RS resources of 32 CSI-RS ports.

11. A terminal in a communication system, the terminal comprising:
at least one transceiver;
at least one processor communicatively coupled to the at least one transceiver; and
at least one memory, communicatively coupled to the at least one processor, storing instructions executable by the at least one processor individually or in any combination to cause the terminal to:
receive, from a base station (BS), configuration information on a plurality of channel state information reference signal (CSI-RS) resources for a plurality of CSI-RS ports, wherein the plurality of CSI-RS resources are aperiodic CSI-RS resources for a channel measurement and linked with a channel state information interference measurement resource (CSI-IM) resource,
receive, from the BS, CSI-RSs corresponding to the plurality of CSI-RS resources in two adjacent slots,
obtain CSI based on the received CSI-RSs and the CSI-IM resource, and
transmit, to the BS, the CSI,
wherein the CSI-IM resource is located in a first slot of the two adjacent slots.

12. The terminal of claim 6,
wherein the plurality of CSI-RS resources are linked with a CSI report configuration with codebook type for release 19.

13. The terminal of claim 11,
wherein the plurality of CSI-RS resources is included in a CSI-RS resource set.

14. The terminal of claim 13,
wherein a slot offset for a CSI-RS resource is determined based on a slot offset for the CSI-RS resource set and an additional slot offset for the CSI-RS resource if the additional slot offset is configured.

15. The terminal of claim 11,
wherein a number of the plurality of CSI-RS port is 48, 64 or 128,
wherein 48 CSI-RS ports are formed by aggregating 2 CSI-RS resource of 24 CSI-RS ports or aggregating 3 CSI-RS resources of 16 CSI-RS ports,
wherein 64 CSI-RS ports are formed by aggregating 2 CSI-RS resources of 32 CSI-RS ports or by aggregating 4 CSI-RS resources of 16 CSI-RS ports, and
wherein 128 CSI-RS ports are formed by aggregating 4 CSI-RS resources of 32 CSI-RS ports.

16. A base station (BS) in a communication system, the BS comprising:
at least one transceiver;
at least one processor communicatively coupled to the at least one transceiver; and
at least one memory, communicatively coupled to the at least one processor, storing instructions executable by the at least one processor individually or in any combination to cause the BS to:
transmit, to a terminal, configuration information on a plurality of channel state information reference signal (CSI-RS) resources for a plurality of CSI-RS ports, wherein the plurality of CSI-RS resources are aperiodic CSI-RS resources for a channel measurement and linked with a channel state information interference measurement resource (CSI-IM) resource,
transmit, to the terminal, CSI-RSs corresponding to the plurality of CSI-RS resources in two adjacent slots, and
receive, from the terminal, CSI,
wherein the CSI is based on the CSI-RSs and the CSI-IM resource, and
wherein the CSI-IM resource is located in a first slot of the two adjacent slots.

17. The BS of claim 16,
wherein the plurality of CSI-RS resources are linked with a CSI report configuration with codebook type for release 19.

18. The BS of claim 16,
wherein the plurality of CSI-RS resources is included in a CSI-RS resource set.

19. The BS of claim 18,
wherein a slot offset for a CSI-RS resource is determined based on a slot offset for the CSI-RS resource set and an additional slot offset for the CSI-RS resource if the additional slot offset is configured.

20. The BS of claim 16,
wherein a number of the plurality of CSI-RS port is 48, 64 or 128,
wherein 48 CSI-RS ports are formed by aggregating 2 CSI-RS resource of 24 CSI-RS ports or aggregating 3 CSI-RS resources of 16 CSI-RS ports,
wherein 64 CSI-RS ports are formed by aggregating 2 CSI-RS resources of 32 CSI-RS ports or by aggregating 4 CSI-RS resources of 16 CSI-RS ports, and
wherein 128 CSI-RS ports are formed by aggregating 4 CSI-RS resources of 32 CSI-RS ports.
